(19) United States
(12) Patent Application Publication
(10) Pub. No.: US 2025/0172660 A1
(43) Pub. Date: May 29, 2025

(54) RADAR APPARATUS, RADAR SIGNAL GENERATING APPARATUS, AND RADAR SIGNAL GENERATING METHOD

(71) Applicant: Panasonic Automotive Systems Co., Ltd., Kanagawa (JP)

(72) Inventor: Takaaki KISHIGAMI, Tokyo (JP)

(21) Appl. No.: 19/038,168

(22) Filed: Jan. 27, 2025

Related U.S. Application Data
(63) Continuation of application No. PCT/JP2023/021805, filed on Jun. 12, 2023.

(30) Foreign Application Priority Data
Aug. 31, 2022 (JP) 2022-138273

(51) Int. Cl. G01S 7/35; G01S 13/42

(52) U.S. Cl. CPC G01S 7/354; G01S 13/424

(57) ABSTRACT

A radar apparatus includes: a plurality of transmission antennas including a first transmission antenna forming a first beam and a second transmission antenna forming a second beam different from the first beam; and transmission circuitry, which, in operation, performs multiplexing transmission of a transmission signal from the plurality of transmission antennas, the transmission signal being a signal to which a phase rotation corresponding to a Doppler shift amount assigned to each of the plurality of transmission antennas has been applied. In the radar apparatus, a Doppler shift interval by the plurality of transmission antennas is uneven on a Doppler frequency axis, and a first pattern of the Doppler shift amount assigned to the first transmission antenna is different from a second pattern of the Doppler shift amount assigned to the second transmission antenna.

### TECHNICAL FIELD

The present disclosure relates to a radar apparatus, a radar signal generating apparatus, and a radar signal generating method.

### BACKGROUND ART

Recently, a study of radar apparatuses using a radar transmission signal of a short wavelength including a microwave or a millimeter wave that can achieve high resolution has been carried out. Further, it has been required to develop a radar apparatus which senses not only vehicles but also small objects such as pedestrians in a wide-angle range (e.g., referred to as “wide-angle radar apparatus”) in order to improve the outdoor safety.

As a configuration of a radar apparatus having a wide sensing range, for example, there is a configuration that uses an array antenna composed of a plurality of antennas (or also called antenna elements) to receive reflected waves from a target, and estimates the direction (or called the Direction of Arrival (DOA)) from which a reflected wave from the target arrive (Direction of Arrival (DOA) estimation), based on a reception phase difference for elements interval (antenna interval). Examples of the DOA estimation include a Fourier method, and, a Capon method, Multiple Signal Classification (MUSIC), and Estimation of Signal Parameters via Rotational Invariance Techniques (ESPRIT) that are methods achieving higher resolution.

Further, there has been a proposed radar apparatus, for example, in which a transmitter in addition to a receiver is provided with a plurality of antennas (array antenna), and which is configured to perform beam scanning through signal processing using the transmission and reception array antennas (which may also be referred to as a Multiple Input Multiple Output (MIMO) radar) (e.g., see Non-Patent Literature (hereinafter referred to as “NPL”) 1).

### CITATION LIST

### Patent Literature

### PTL 1

Japanese Patent Application Laid-Open No. 2019-211388

### PTL 2

U.S. Patent Publication No. 2022/0066012

### PTL 3

Japanese Patent Application Laid-Open No. 2008-304417

### PTL 4

Japanese Unexamined Patent Application Publication (Translation of PCT Application) No. 2011-526371

### PTL 5

Japanese Patent Application Laid-Open No. 2014-119344

### PTL 6

Japanese Patent Application Laid-Open No. 2019-052952

### PTL 7

Japanese Patent Application Laid-Open No. 2020-148754

### Non-Patent Literature

### NPL 1

J. Li, and P. Stoica, “MIMO Radar with Colocated Antennas,” Signal Processing Magazine, IEEE Vol. 24, Issue: 5, pp. 106-114, 2007

### NPL 2

M. Kronauge, H. Rohling, “Fast two-dimensional CFAR procedure,” IEEE Trans. Aerosp. Electron. Syst., 2013, 49, (3), pp. 1817-1823

### NPL 3

Direction-of-arrival estimation using signal subspace modeling Cadzow, J. A.; Aerospace and Electronic Systems, IEEE Transactions on Volume: 28, Issue: 1 Publication Year: 1992, Page(s): 64-79

### SUMMARY OF INVENTION

However, methods for a radar apparatus (e.g., MIMO radar) to sense a target object (or a target) have not been comprehensively studied.

One non-limiting and exemplary embodiment of the present disclosure facilitates providing a radar apparatus, a radar signal generating apparatus, and a radar signal generating method with an enhanced sensing accuracy for sensing a target object.

A radar apparatus according to one exemplary embodiment of the present disclosure includes: a plurality of transmission antennas including a first transmission antenna forming a first beam and a second transmission antenna forming a second beam different from the first beam; and transmission circuitry, which, in operation, performs multiplexing transmission of a transmission signal from the plurality of transmission antennas, the transmission signal being a signal to which a phase rotation corresponding to a Doppler shift amount assigned to each of the plurality of transmission antennas has been applied. In the radar apparatus, a Doppler shift interval by the plurality of transmission antennas is uneven on a Doppler frequency axis, and a first pattern of the Doppler shift amount assigned to the first transmission antenna is different from a second pattern of the Doppler shift amount assigned to the second transmission antenna.

Note that these generic or specific exemplary embodiments may be achieved by a system, an apparatus, a method, an integrated circuit, a computer program, or a recoding medium, and also by any combination of the system, the apparatus, the method, the integrated circuit, the computer program, and the recoding medium.

According to an exemplary embodiment of the present disclosure, the sensing accuracy of a radar apparatus for a target object can be improved.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of Time Division Multiplexing (TDM) transmission;

FIG. 2 illustrates an example of Doppler Division Multiplexing (DDM) transmission;

FIG. 3 illustrates an example of uneven interval Doppler multiplexing transmission;

FIG. 4 illustrates an example of a multi-beam transmission MIMO radar;

FIG. 5 illustrates an example of Doppler multiplexing transmission in the multi-beam transmission MIMO radar;

FIG. 6 illustrates an example of Doppler multiplexing transmission in the multi-beam transmission MIMO radar;

FIG. 7 is a block diagram showing a configuration example of a radar apparatus;

FIG. 8 illustrates an example of a transmission signal in a case where a chirp signal is used;

FIG. 9 illustrates an example of a chirp signal;

FIG. 10 illustrates an example of a transmission signal and a reception signal in a case where a chirp signal is used;

FIG. 11 illustrates an exemplary configuration of the Doppler shift amount;

FIG. 12 illustrates an example of a reception signal in Doppler multiplexing transmission;

FIG. 13 illustrates an example of a multi-beam transmission MIMO radar;

FIG. 14 illustrates an exemplary configuration of the Doppler shift amount;

FIG. 15 illustrates an example of a reception signal in Doppler multiplexing transmission;

FIG. 16 illustrates an exemplary configuration of the Doppler shift amount;

FIG. 17 illustrates an exemplary configuration of the Doppler shift amount;

FIG. 18 is a flowchart showing an exemplary operation for separating Doppler multiplexed signals;

FIG. 19 illustrates a configuration example of a transmission antenna;

FIG. 20 illustrates an example of a multi-beam transmission MIMO radar;

FIG. 21 illustrates an example of a MMO antenna arrangement and a virtual reception antenna arrangement;

FIG. 22 illustrates an example of a MIMO antenna arrangement and a virtual reception antenna arrangement;

FIG. 23 illustrates an example of a MIMO antenna arrangement and a virtual reception antenna arrangement;

FIG. 24 illustrates an example of a multi-beam transmission MIMO radar;

FIG. 25 illustrates an example of a MIMO antenna arrangement;

FIG. 26 illustrates an exemplary configuration of a Doppler shift amount;

FIG. 27 illustrates an exemplary configuration of a Doppler shift amount;

FIG. 28 illustrates an exemplary configuration of a Doppler shift amount;

FIG. 29 illustrates an example of a multi-beam transmission MIMO radar;

FIG. 30 illustrates an example of a multi-beam transmission MIMO radar;

FIG. 31 illustrates an example of a multi-beam transmission MIMO radar;

FIG. 32 illustrates an example of a multi-beam transmission MIMO radar; and

FIG. 33 illustrates an example of a multi-beam transmission MIMO radar.

### DESCRIPTION OF EMBODIMENTS

A MIMO radar transmits, from a plurality of transmission antennas (also referred to as “transmission array antenna”), signals (radar transmission waves) that are time-division, frequency-division, or code-division multiplexed, for example. The MIMO radar then receives signals (radar reflected waves) reflected, for example, by an object around the radar using a plurality of reception antennas (also referred to as “reception array antenna”) to separate and receive multiplexed transmission signals from respective reception signals. With this processing, the MIMO radar can extract propagation path responses indicated by the product of the number of transmission antennas and the number of reception antennas, and perform array signal processing using these reception signals as a virtual reception array. Further, in the MIMO radar, it is possible to enlarge the antenna aperture of the virtual reception array so as to enhance the angular resolution by appropriately arranging element intervals in transmission and reception array antennas.

### [Regarding Multi-Beam Radar]

The directional characteristics (or simply referred to as “directivity”) of the plurality of transmission antennas or reception antennas constituting MIMO radar is desirable to be approximately the same in order to improve the angular measurement performance such as angle measurement accuracy or angular resolution. On the other hand, since the directional characteristics of the transmission antenna or the reception antenna are set according to a sensing distance or a sensing angle range required for the radar, it may be difficult to cover the required specifications with one type of the directional characteristics of the transmission antenna or the reception antenna.

For example, in order to satisfy the sensing angle range of the wide angle while also meeting the required sensing distance, transmission antennas or reception antennas having a plurality of directional characteristics with different main beam directions (hereinafter, also referred to as “beam direction,” “transmission beam direction” or “reception beam direction”) may be used.

Further, for example, when the required sensing distance differs significantly for each detection angle direction, transmission antennas or reception antennas with a plurality of directional characteristics in which at least one of the beam direction or beam width suitable for each angle direction varies may be used.

Further, for example, when the sensing angle range differs significantly for each sensing distance (e.g., for each long-distance range, medium-distance range, and short-distance range), transmission antennas or reception antennas with a plurality of directional characteristics in which the beam directions are roughly the same and the beam widths (e.g., 3 dB beam width or 6 dB beam width) differ depending on the sensing distance.

For example, when the number of transmission antennas or the number of reception antennas is limited due to the size or cost constraints of the radar apparatus, the use of transmission antennas or reception antennas with different directional characteristics is an effective means to meet the required specifications.

In such cases, it is expected to configure a MIMO radar using a plurality of transmission antennas or reception antennas with different directional characteristics.

Examples of the different directional characteristics of transmission antennas or reception antennas include directional characteristics with approximately the same beam width but different beam directions, directional characteristics with both different beam directions and beam widths, and directional characteristics with approximately the same beam direction but different beam widths.

In the following, a MIMO radar using a plurality of transmission antennas (e.g., transmission antennas forming different beams) having different directional characteristics as described above is referred to as a “multi-beam transmission MIMO radar.” Here, the multi-beam transmission MIMO radar includes a plurality of transmission antennas having different directional characteristics. The multi-beam transmission MIMO radar may be configured to include one or more transmission antennas of the same directivity.

In addition, in the following, a MIMO radar using a plurality of reception antennas (for example, reception antennas forming different beams) having different directional characteristics as described above is referred to as a “multi-beam reception MIMO radar.” Here, the multi-beam reception MIMO radar includes a plurality of reception antennas having different directional characteristics. The multi-beam reception MIMO radar may be configured to include one or more reception antennas of the same directivity.

Similarly, in the following, a MIMO radar using a plurality of transmission antennas and reception antennas having different directional characteristics as described above is referred to as “multi-beam transmission and reception MIMO radar” (or multi-beam MIMO radar).

For example, PTL 1 discloses a three-transmission MIMO radar configuration for switching between two transmission antennas with a certain directivity and one transmission antenna with a different directivity in time division. Further, PTL 1 discloses a configuration for switching between a time period in which two transmission antennas with a certain directivity are code-multiplexed and transmitted and a time period in which two transmission antennas with different directivities are code-multiplexed and transmitted.

Further, for example, PTL 2 discloses a MIMO radar configuration for switching between a long-distance directional transmission antenna and a short- or mid-range directional transmission antenna by combining time division and Doppler multiplexing.

In the following, attention will be focused on a multiplexing transmission method in a multi-beam transmission MIMO radar that uses a plurality of transmission antennas having different directional characteristics (for example, a plurality of transmission antennas that form different beams).

### [Regarding Time-Division Multiplexing Transmission]

For example, as a multiplexing transmission method of a MIMO radar using a plurality of transmission antennas, there is Time Division Multiplexing (TDM), which shifts the transmission time for each transmission antenna to transmit signals. Time-division multiplexing, compared to Frequency Division Multiplexing (FDM) and Code Division Multiplexing (CDM), can be realized with a simple configuration, and by sufficiently widening the transmission time intervals, it is possible to maintain good orthogonality between transmission signals.

For example, the MIMO radar using time-division multiplexing transmission disclosed in PTL 3 outputs a transmission pulse, which is an example of a transmission signal (for example, a transmission pulse or radar transmission wave), while sequentially switching transmission antennas that transmit transmission signals at a specified period. The MIMO radar which uses time-division multiplexing transmission receives, at a plurality of reception antennas, signals that are the transmission pulses reflected by an object, performs processing of correlating the reception signals with the transmission pulses, and then performs, for example, spatial Fast Fourier transform (FFT) processing (direction-of-arrival estimation processing on the reflected waves).

A MIMO radar using time-division multiplexing transmission has a specified transmission time (or transmission interval) pre-assigned for each of the plurality of transmission antennas. Therefore, a multi-beam transmission MIMO radar using time-division multiplexing transmission receives reflections from a target object for each transmission time assigned to transmission antennas of a plurality of different polarizations, thereby separating and receiving the reflected waves from the target object corresponding to the transmission signals of the transmission antennas of a plurality of different polarizations.

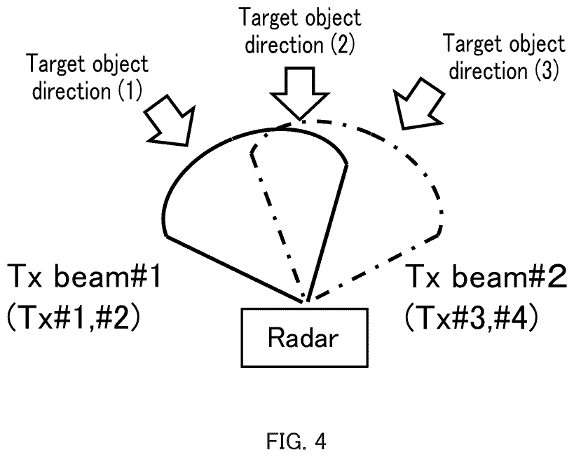

Since a MIMO radar using time-division multiplexing transmission sequentially switches the transmission antennas that transmit the radar transmission waves at specified intervals, the time until the transmission from all transmission antennas is completed is likely to be longer compared to when using frequency division multiplexing transmission or code division multiplexing transmission. Therefore, in a MIMO radar using time-division multiplexing transmission, when transmitting a plurality of radar transmission waves for each transmission antenna and detecting Doppler frequency (for example, relative speed detection) from their reception phase changes (for example, as illustrated in FIG. 4 of PTL 4), the time interval for observing the reception phase changes in application of Fourier frequency analysis for Doppler frequency detection (for example, relative speed detection) becomes longer. When the time interval for observing the reception phase changes during Fourier frequency analysis becomes longer, the maximum detectable Doppler frequency based on the sampling theorem decreases, and the detectable Doppler frequency range (for example, the range of relative speeds) is likely to narrow.

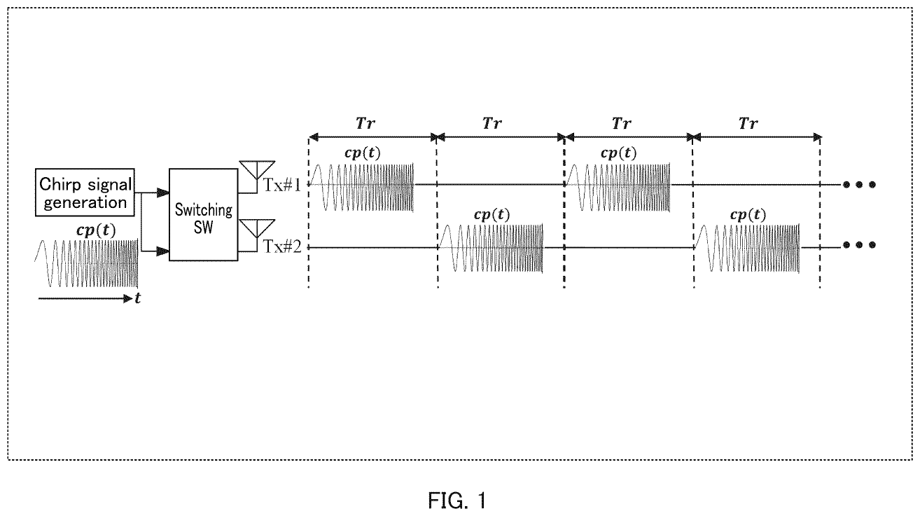

For example, as illustrated in FIG. 1, a MIMO radar using time-division multiplexing transmission that outputs transmission pulses while sequentially switching between transmission antennas (for example, Tx #1 and Tx #2) that emit chirp signals as radar transmission waves at transmission period Tr is described.

For example, in the case of Nt transmission antennas (in the case of FIG. 1, Nt=2), the transmission time until the transmission of radar transmission waves from Nt transmission antennas is completed is Tr×Nt (in the case of FIG. 1, 2Tr). In a MIMO radar using time-division multiplexing transmission, when such time-division multiplexing transmission is repeated Nc times and Fourier frequency analysis is applied for Doppler frequency detection (for example, relative speed detection), the range of Doppler frequencies that can be detected without aliasing becomes ±1/(2Tr×Nt) according to the sampling theorem. Therefore, the range of Doppler frequencies that can be detected without aliasing narrows as number Nt of transmission antennas increases. Further, in a MIMO radar using time-division multiplexing transmission, when receiving Doppler frequencies beyond the range in which detection without aliasing is possible, it becomes difficult to uniquely determine the Doppler frequency (for example, relative speed), and ambiguity is likely to arise.

For example, in the multi-beam transmission MIMO radar using the time-division multiplexing transmission as in PTL 1, similar to the MIMO radar using the time-division multiplexing transmission described above, as the number Nt of transmission antennas increases, the Doppler frequency range in which the Doppler frequency can be detected without aliasing tends to become narrower.

The example of time-division multiplexing transmission has been described above.

Next, by way of example, attention will be focused to a method of multiplexing and transmitting transmission signals simultaneously from a plurality of transmission antennas.

### [Regarding Doppler Multiplexing]

An example of the method for simultaneously multiplexing and transmitting transmission signals from a plurality of transmission antennas is a method (hereinafter referred to as Doppler Division Multiplexing (DDM) transmission) for transmitting signals such that a plurality of transmission signals in the Doppler frequency domain can be separated at the receiver (e.g., see PTL 5).

In Doppler multiplexing transmission, for example, at the transmitter, a phase rotation that gives a different Doppler shift amount to the transmission signal is applied for each transmission antenna, and transmission signals are simultaneously transmitted from a plurality of transmission antennas. In the Doppler multiplexing transmission, the signals (e.g., reflected waves from the target object) received using a plurality of reception antennas are each filtered in the Doppler frequency domain, so that the transmission signals transmitted from the transmission antennas are separated and received.

In a MIMO radar using Doppler multiplexing transmission, for example, a specified Doppler frequency domain (or Doppler shift amount) is pre-assigned for each of the plurality of transmission antennas. For example, a multi-beam transmission MIMO radar using Doppler multiplexing transmission receives reflections from a target object for Doppler frequency ranges assigned to transmission antennas with a plurality of different beam directions, and thereby separates and receives reflected waves from the target object corresponding to the transmission signals of transmission antennas with the plurality of different beam directions, respectively.

Ina MIMO radar using Doppler multiplexing transmission, as compared with time-division multiplexing transmission, simultaneous transmission of transmission signals from a plurality of transmission antennas can reduce the time interval for observing the reception phase changes for application of Fourier frequency analysis for Doppler frequency detection (e.g., relative speed detection). Meanwhile, since filtering is performed on the Doppler frequency axis to separate the transmission signals of the respective transmission antennas in the MIMO radar which uses Doppler multiplexing transmission, the effective Doppler frequency bandwidth per transmission signal is restricted.

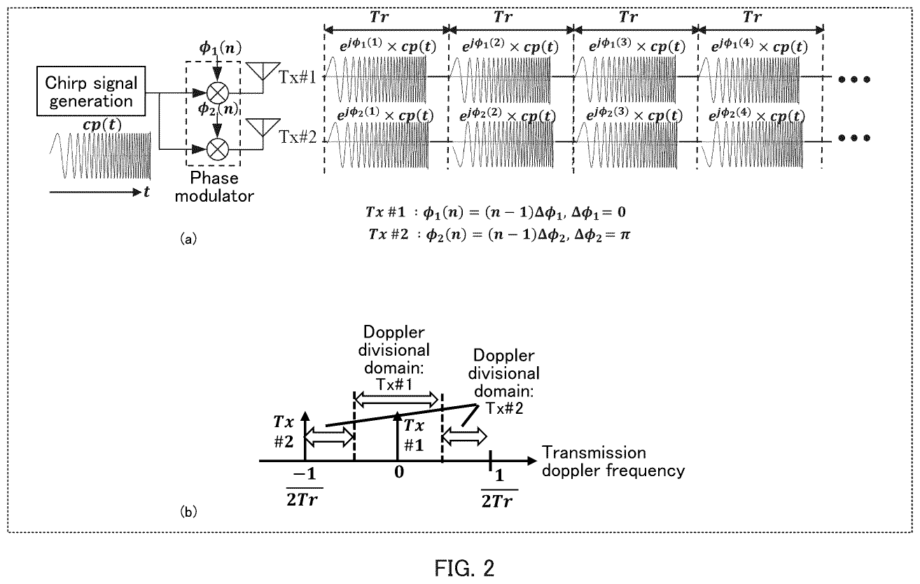

For example, as illustrated at part (a) in FIG. 2, a MIMO radar using Doppler multiplexing transmission, which repeats, Nc times, the transmission of a chirp signal as the transmission radar wave output at transmission period Tr and applies Fourier frequency analysis for Doppler frequency detection (for example, relative speed detection), is described.

For example, at part (b) in FIG. 2, on the Doppler frequency axis, the Doppler frequency range in which a Doppler frequency is detectable without aliasing becomes ±1/(2Tr) according to the sampling theorem, and compared to when performing time-division multiplexing transmission, it is expanded by Nt times (in the case of FIG. 2, Nt=2). On the other hand, in the MIMO radar using Doppler multiplexing transmission, because the transmission signals are separated by filtering on the Doppler frequency axis, the effective Doppler frequency range per transmission signal becomes narrower than the Doppler frequency range of ±1/(2Tr). For example, when the Doppler frequency range ±1/(2Tr) is divided equally into Nt parts (in the case of FIG. 2, Nt=2), and the Doppler shifts (which are also referred to as “Doppler shift amount” or “transmission Doppler shift amount”) of 0 [Hz] and −1/(2Tr)[Hz] are respectively applied to Tx #1 and Tx #2, a MIMO radar using Doppler multiplexing transmission multiplies the chirp signal (which is the transmission signal (cp(t)) by phase rotations Φ₁(n)=(n−1)ΔΦ₁, Φ₂(n)=(n−1)ΔΦ₂ (where, ΔΦ₁=0, ΔΦ₂=π) every transmission period Tr. Here, n=1, 2, 3, 4, . . . , which is an index representing the number of chirp signal transmissions.

In this case, as illustrated at part (b) in FIG. 2, a Doppler frequency domain is pre-assigned to each of the plurality of transmission antennas Tx #1 and Tx #2. For example, −1/(4Tr)≤fd1<1/(4Tr) is assigned to the domain of the Doppler frequency fd1 of Tx #1 (e.g., also referred to as “Doppler division domain”), and −1/(2Tr)≤fd2<−1/(4Tr) and 1/(4Tr)≤fd2<1/(2Tr) are assigned to the domain of Doppler frequency fd2 for Tx #2.

A MIMO radar using Doppler multiplexing transmission, for example, receives signals reflected by a target object respectively from transmission antennas and separates and receives the transmission signals by filtering processing on the Doppler frequency axis. For example, at part (b) in FIG. 2, the MIMO radar using Doppler multiplexing transmission separates and receives the signals being the transmission signals reflected by a target object from transmission antenna Tx #1 by filtering and extracting the range of −1/(4Tr)≤fd1<1/(4Tr) on the Doppler frequency axis. Similarly, the MIMO radar using Doppler multiplexing transmission separates and receives the signals resulted from the transmission signals (from transmission antenna Tx #2) reflected by a target object by filtering and extracting the ranges of 1/(2Tr)≤fd2<−1/(4Tr) and 1/(4Tr)≤fd2<1/(2Tr) on the Doppler frequency axis.

Thus, in the MIMO radar using Doppler multiplexing transmission, reception processing is performed on the reflected wave signals corresponding to the transmission signals from respective transmission antennas based on an assumption that the signals are included within the Doppler frequency range of ±1/(2Tr×Nt), resulting in a Doppler frequency range similar to that of time-division multiplexing transmission. For example, in the MIMO radar using Doppler multiplexing transmission, as the number Nt of transmission antennas increases, the Doppler frequency range in which the Doppler frequency can be detected without aliasing tends to become narrower.

Similarly, in a multi-beam transmission MIMO radar using Doppler multiplexing transmission, as with the MIMO radar using the Doppler multiplexing transmission described above, as the number Nt of transmission antennas increases, the Doppler frequency range in which the Doppler frequency can be detected without aliasing tends to become narrower.

### [Regarding Uneven Interval Doppler Multiplexing Transmission]

The aforementioned time-division multiplexing transmission or Doppler multiplexing transmission can separate the reflected waves corresponding to the transmission signals from a plurality of transmission antennas using the assigned transmission time or Doppler frequency domain. On the other hand, with time-division multiplexing transmission and Doppler multiplexing transmission, as the number of transmission antennas increases, the detection range of Doppler frequencies is likely to narrow. For example, in time-division multiplexing and Doppler multiplexing, the detectable Doppler frequency range is −1/(2Nt×Tr)≤fd<1/(2Nt×Tr), and the detection range of Doppler frequencies narrows inversely proportional to the number of transmission antennas. Here, Nt is the number of transmission antennas.

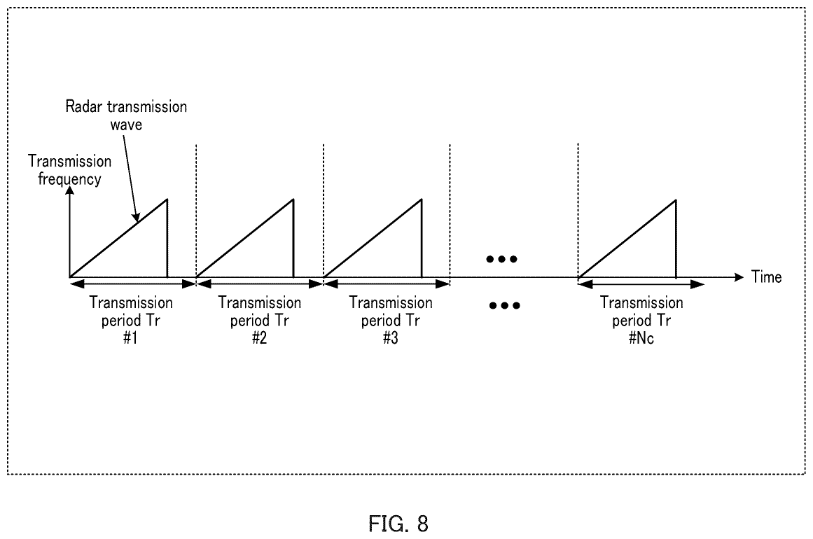

For example, PTL 6 discloses a method for expanding the detection range of a Doppler frequency in Doppler multiplexing transmission. PTL 6 (e.g., FIG. 8) discloses the following method. For example, the detectable Doppler frequency range in which a Doppler frequency is detectable without aliasing, ±1/(2Tr), is divided equally into (Nt+1) Doppler shift amounts (or Doppler frequency domains), of which Nt Doppler shift amounts are assigned to Nt transmission signals, and transmission signals from Nt transmission antennas are transmitted simultaneously.

In such Doppler multiplexing transmission, some (herein “some” includes one”) of the (Nt+1) equally divided Doppler shift amounts are not assigned to transmission signals. Therefore, in the Doppler frequency domain, Doppler shift amount intervals applied to the Doppler-multiplexed transmission signals (hereinafter, also referred to as “Doppler multiplexing intervals” or “Doppler shift intervals”) become uneven. Hereinafter, such Doppler multiplexing transmission is referred to as “uneven interval Doppler multiplexing transmission (uneven interval DDM transmission).”

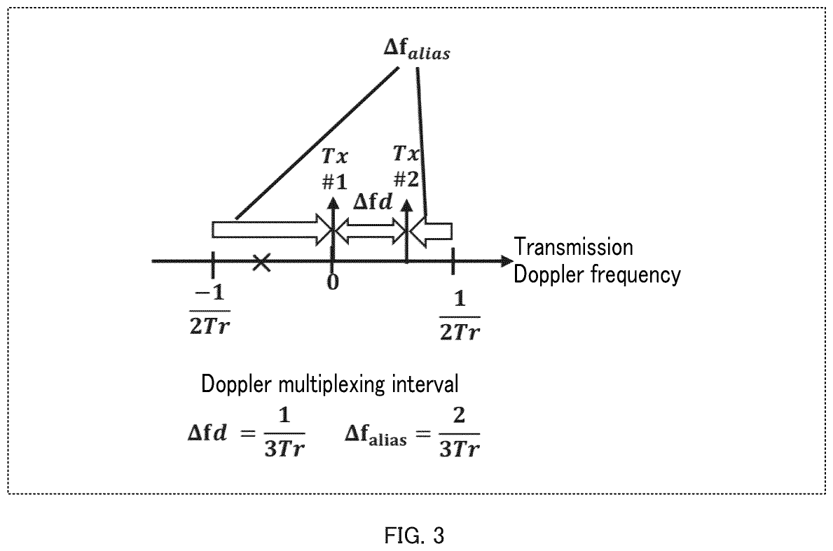

FIG. 3 shows an example of assigning of Doppler multiplexed signals using uneven interval Doppler multiplexing transmission in the case where radar transmission waves (for example, chirp signals) are sent out every transmission period Tr, Nt transmission antennas (Nt=2) are used, and the unit of Doppler shift interval is set as Δfd=1/(3Tr).

In FIG. 3, the transmission Doppler shift amounts assigned to transmission antennas Tx #1 and Tx #2 are Δfd1=0 and Δfd2=1/(3Tr)[Hz], respectively. For example, to give transmission Doppler shift amount Δfd1 to transmission antenna Tx #1 in every nth transmission period, phase rotation Φ₁(n)=ΔΦ₁×(n−1) is applied to the radar transmission wave (chirp signal). Similarly, for example, to give transmission Doppler shift amount Δfd2 to transmission antenna Tx #2 in every nth transmission period, phase rotation Φ₂(n)=ΔΦ₂×(n−1) is applied to the radar transmission wave (chirp signal). Note that there is no transmission antenna assignment for Doppler shift amount Δfd3 corresponding to phase rotation Φ₃(n)=ΔΦ₃×(n−1).

Here, FIG. 3 shows the transmission Doppler frequencies assigned to transmission antennas Tx #1 and Tx #2 when Δfd1=0, Δfd2=1/(3Tr), ΔΦ₁=0, and ΔΦ₂=2π×Δfd×Tr=2π/3. In FIG. 3, the transmission Doppler frequency when Δfd3=2/(3Tr) and ΔΦ₃=2π×2Δfd×Tr=4π/3 (or, −2π/3) is represented by an “×” mark. As illustrated in FIG. 3, there is no transmission antenna assignment for Doppler shift amount Δfd3.

Note that phase rotation (n may be expressed as −π≤ΔΦₙ<π. For example, ΔΦ₃=−2π/3 may be expressed. The same applies hereinafter.

For example, the following case is considered as illustrated in FIG. 3: the Doppler shift interval for Tx #1 and Tx #2 is Δfd=1/(3Tr), the observable range (domain) of Doppler frequencies is 1/(2Tr)≤fd<1/(2Tr), and Doppler frequencies outside this range are included. For example, when the reception Doppler frequency of the Doppler multiplexed signal of Tx #1 or Tx #2 exceeds 1/(2Tr), or is less than −1/(2Tr), the Doppler shift interval for Tx #1 and Tx #2 becomes Δfₐₗᵢₐₛ=1/Tr−Δfd=⅔Tr, as illustrated in FIG. 3. In the following, when the “Doppler multiplexing interval” or “Doppler shift interval” is used as a term, not only Δfd, but also Δfₐₗᵢₐₛ is included.

Next, examples of demultiplexing reception processing of Doppler multiplexed signals using uneven interval Doppler multiplexing transmission will be described.

In the demultiplexing reception processing of Doppler multiplexed signals using uneven interval Doppler multiplexing transmission, for example, the following properties is utilized for Doppler frequency detection (e.g., relative speed detection) of reception signals of the radar reflected waves.

For example, in an output resulting from application of Fourier frequency analysis, among the equally divided Nt+1 Doppler shift amounts, the reception power level of the Doppler frequency corresponding to the Doppler shift amount not assigned to the transmission signal is sufficiently lower (e.g., about the noise level) than the reception power level of the Doppler frequency corresponding to the Doppler shift amount assigned to the transmission signal.

The MIMO radar using uneven interval Doppler multiplexing transmission utilizes the properties to estimate the reception Doppler frequency of the reflected wave from the target object and to perform separation processing of the transmission antennas.

For example, the reception Doppler frequency of the reflection from the target object is denoted as “fd_{target}.” In this case, in the output resulting from application of Fourier frequency analysis to Doppler frequency detection (e.g., relative speed detection) of the radar reflected wave reception signal, the reception levels of Doppler frequencies fd_{target}+Δfd1 and fd_{target}+Δfd2 are observed to be high (e.g., above a threshold). On the other hand, in the output resulting from application of Fourier frequency analysis to Doppler frequency detection (e.g., relative speed detection), the reception level of Doppler frequency fd_{target}+Δfd3 is observed to be sufficiently low, as about the noise level, compared to the reception levels of Doppler frequencies fd_{target}+Δfd1 and fd_{target}+Δfd2.

Note that the output resulting from application of Fourier frequency analysis to Doppler frequency detection (e.g., relative speed detection) is observed in the range of −1/(2Tr)≤fd<1/(2Tr), and thus, when this range is exceeded, the output resulting from application of Fourier frequency analysis is observed as an aliasing signal within −1/(2Tr)≤fd<1/(2Tr).

When the reception Doppler frequency fd_{target} of a reflected wave from the target object is within the range of −1/(2Tr)≤fd_{target}<1/(2Tr), the reception Doppler frequencies that satisfy the aforementioned relationship become unique within the range of −1/(2Tr)≤fd_{target}<1/(2Tr), thus, the MIMO radar using uneven interval Doppler multiplexing transmission can unambiguously determine Doppler frequency fd_{target} of the target object within this range. For example, when determining Doppler frequency fd_{target} corresponding to a target object, the MIMO radar using uneven interval Doppler multiplexing transmission can determine the reception Doppler frequency for each transmission antenna, enabling the demultiplexing reception of Doppler multiplexed signals.

Such demultiplexing reception processing of Doppler multiplexed signals enables the MIMO radar using uneven interval Doppler multiplexing transmission, for example, to estimate the Doppler frequencies of reflected waves within the Doppler frequency range of ±1/(2Tr). Uneven interval Doppler multiplexing transmission expands the detectable Doppler frequency range to ±1/(2Tr). For example, compared to the method in PTL 3, uneven interval Doppler multiplexing transmission expands the detectable Doppler frequency range by Nt times.

### [Regarding Application of Uneven Interval Doppler Multiplexing Transmission to Multi-Beam Transmission MIMO Radar]

As mentioned above, in uneven interval Doppler multiplexing, unlike even interval Doppler multiplexing, some Doppler frequency domains are not assigned to the transmission signal, and the MIMO radar performs separation processing on Doppler multiplexed signals to estimate the target-object Doppler frequency based on the reception power of the reception Doppler frequency of reflected waves from the target object.

Therefore, when uneven interval Doppler multiplexing is applied to a multi-beam transmission MIMO radar, the following may be assumed.

In a multi-beam transmission MIMO radar, for example, the reception level of a reflected wave may significantly vary depending on the beam direction (or transmission beam direction) and the target object direction. In a multi-beam transmission MIMO radar, the reflected wave reception level from the transmission antennas may vary significantly between when the beam direction and target object direction coincide with each other and when the beam direction and target object direction do not coincide. Therefore, in a case of performing multiplexing transmission using uneven interval Doppler multiplexing in a multi-beam transmission MIMO radar, when there is a large difference in the reflected wave reception level between the multi-beams in different beam directions, Doppler demultiplexing using uneven interval Doppler multiplexing may become difficult. When Doppler demultiplexing becomes difficult, it may lead to degradation in the detection performance of target objects in the MIMO radar, or errors in Doppler demultiplexing, resulting in incorrect Doppler estimation or degradation of angle measurement performance.

Hereinafter, examples will be described in which Doppler demultiplexing becomes difficult in a multi-beam transmission MIMO radar employing uneven interval Doppler multiplexing.

For example, a 4Tx MIMO radar including two transmission antennas in each of two beam directions will be described. For example, the number of transmission antennas respectively corresponding to the two beam directions are denoted as “N_{TxBeam #1}” and “N_{TxBeam #2}” (N_{TxBeam #1}=N_{TxBeam #2}=2).

For example, as illustrated in FIG. 4, the configuration of a multi-beam transmission MIMO radar that forms respective transmission beams (TxBeam #1, TxBeam #2) in two different directions each using two transmission antennas out of four transmission antennas Tx #1 to #4 will be described. In FIG. 4, the transmission beam (beam direction) of Tx #1 and Tx #2 is TxBeam #1, and the transmission beam (beam direction) of Tx #3 and Tx #4 is TxBeam #2. Further, for example, the directional characteristics of the reception antenna may be omnidirectional, or may have substantially uniform directional characteristics within the viewing angle (field of view: FOV) covered by a plurality of transmission antennas with different directivities.

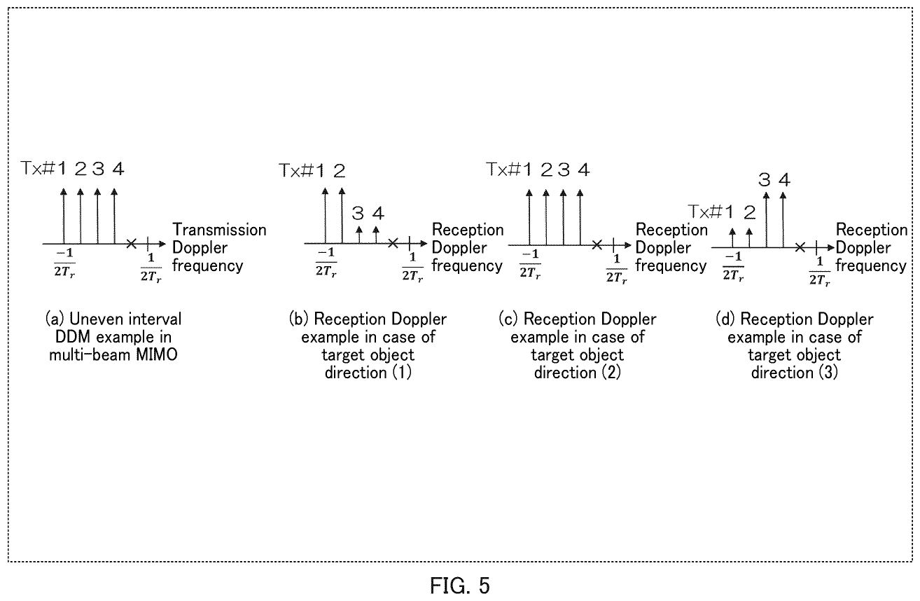

For example, a case will be described in which Doppler multiplexed signals are assigned at uneven intervals to four transmission antennas Tx #1 to #4 as illustrated at part (a) in FIG. 5. In FIG. 5, the unit of the Doppler shift interval is Δfd=1/(5Tr), the transmission Doppler frequencies (Hz) assigned to transmission antennas Tx #1 to Tx #4 are Doppler shift amounts Δfd1=−1/(2Tr), Δfd2=−3/(10Tr), Δfd3=−1/(10Tr), and Δfd4=1/(10Tr), respectively. The transmission Doppler frequency represented by “×” mark is Doppler shift amount Δfd5=3/(10Tr), indicating the case where no transmission antenna is assigned.

For example, when the target object direction is target object direction (1) illustrated in FIG. 4, the direction of the reflected waves corresponding to the radar transmission waves transmitted from Tx #1 and Tx #2 forming TxBeam #1 coincides with target object direction (1), and thus the reception level (for example, the reflected wave reception level) of the reception signals corresponding to Tx #1 and Tx #2 forming TxBeam #1 becomes relatively high, as illustrated at part (b) in FIG. 5. On the other hand, when the target object direction is target object direction (1) illustrated in FIG. 4, the direction of the reflected waves corresponding to the radar transmission waves transmitted from Tx #3 and Tx #4 forming TxBeam #2 do not coincide with target object direction (1), and target object direction (1) corresponds to the directional null direction of TxBeam #2 (hereinafter also referred to as the null direction). Therefore, for example, as illustrated at part (b) in FIG. 5, the reception level of the reception signal corresponding to Tx #3 and Tx #4 forming TxBeam #2 becomes low compared to the reception level of the reception signal corresponding to TxBeam #1 (Tx #1 and Tx #2). For example, the reception level corresponding to TxBeam #2 may significantly differ from the reception level corresponding to TxBeam #1, and may become 10 dB or more lower depending on the beam directional characteristic in the null direction of TxBeam #2.

Further, for example, when the target object direction is an intermediate direction between the beam direction of TxBeam #1 and the beam direction of TxBeam #2, and the beam widths of both beams (each of which is about 3 dB or 6 dB of the beam) are in the direction of the overlapping area (for example, in the case of target object direction (2) illustrated in FIG. 4), the reflected waves corresponding to the radar transmission waves transmitted from Tx #1 and Tx #2 forming TxBeam #1 and the reflected waves corresponding to the radar transmission waves transmitted from Tx #3 and Tx #4 forming TxBeam #2 are received at substantially the same level as illustrated at part (c) in FIG. 5.

Further, for example, when the target object direction is target object direction (3) illustrated in FIG. 4, the direction of the reflected waves corresponding to the radar transmission waves transmitted from Tx #3 and Tx #4 forming TxBeam #2 coincides with target object direction (3), and thus the reception level (for example, the reflected wave reception level) of the reception signals corresponding to Tx #3 and Tx #4 forming TxBeam #2 becomes relatively high as illustrated at part (d) in FIG. 5. On the other hand, when the target object direction is target object direction (3) illustrated in FIG. 4, the direction of the reflected waves corresponding to the radar transmission waves transmitted from Tx #1 and Tx #2 forming TxBeam #1 does not coincide with target object direction (3), and target object direction (3) corresponds to the directional null direction of TxBeam #1. Therefore, for example, as illustrated at part (d) in FIG. 5, the reception levels of the reception signals corresponding to Tx #1 and Tx #2 forming TxBeam #1 become low compared to the reception levels of the reception signals corresponding to TxBeam #2 (Tx #3 and Tx #4). For example, the reception level corresponding to TxBeam #1 may significantly differ from the reception level corresponding to TxBeam #2, and may become 10 dB or more lower depending on the beam directional characteristic in the null direction of TxBeam #1.

For example, in the case such as part (c) in FIG. 5, the reception levels of the reflected waves corresponding to the radar transmission waves transmitted from Tx #1 and Tx #2 forming TxBeam #1 is approximately the same as the reception levels of the reflected waves corresponding to the radar transmission waves transmitted from Tx #3 and Tx #4 forming TxBeam #2. Based on the reception levels of these reception signals, the multi-beam transmission MIMO radar can determine which transmission antenna used for uneven interval Doppler multiplexing transmission the detected Doppler frequency peak corresponds to. In addition, at part (c) in FIG. 5, Doppler frequency fd of the target object reflected wave can be determined within the range of −1/(2Tr)≤fd<1/(2Tr).

On the other hand, in the case such as part (b) in FIG. 5 or part (d) in FIG. 5, the Doppler frequency of the target object is unknown for the multi-beam transmission MIMO radar, and thus it is difficult to determine, based on the reception levels of the reception signals, whether the reception levels of the reflected waves corresponding to the radar transmission waves transmitted from Tx #1 and Tx #2 forming TxBeam #1 has decreased (for example, the case of part (d) in FIG. 5) or whether the reception levels of the reflected waves corresponding to the radar transmission waves transmitted from Tx #3 and Tx #4 forming TxBeam #2 has decreased (for example, the case of part (b) in FIG. 5). Therefore, it is difficult for the multi-beam transmission MIMO radar to determine, based on the reception level of a received signal, which transmission antenna used for uneven interval Doppler multiplexing transmission the detected Doppler frequency peak corresponds to. Therefore, it becomes difficult for the multi-beam transmission MIMO radar to separate the Doppler multiplexed signals, and it becomes difficult to determine Doppler frequency fd of the reflected wave (for example, referred to as “target object reflected wave”) from the target object within the range of −1/(2Tr)≤fd<1/(2Tr).

Thus, in uneven interval Doppler multiplexing, Doppler demultiplexing processing is performed on the assumption that the reception levels of the reflected waves corresponding to respective transmission antennas are approximately the same and that the reception level of a Doppler shift interval (marked with x) that is not Doppler multiplexed is sufficiently low, namely approximately at the noise level. In a multi-beam transmission MIMO radar using uneven interval Doppler multiplexing, the assumptions for the separation processing of uneven interval Doppler multiplexing may collapse as shown at (b) and part (d) in FIG. 5, potentially leading to errors in Doppler demultiplexing processing.

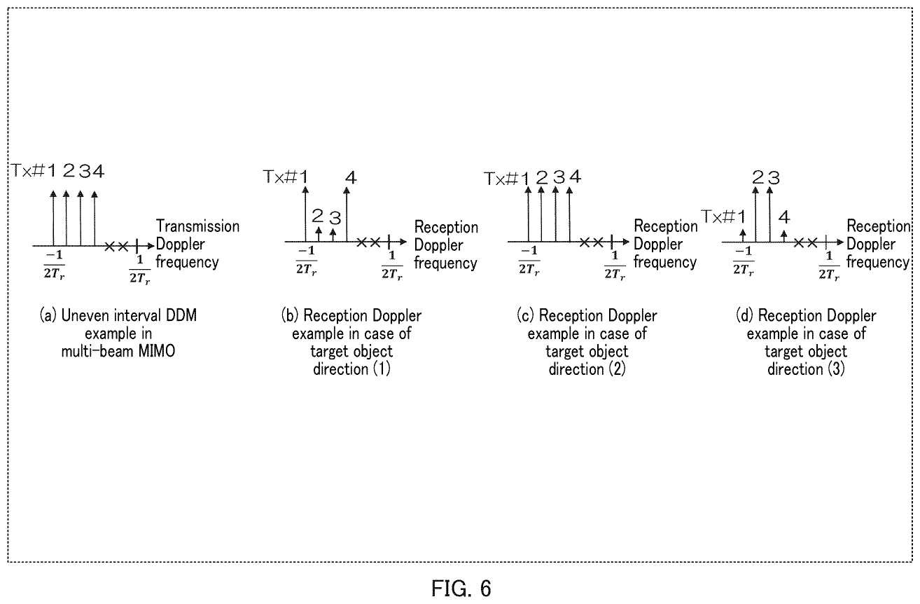

As another example, a case will be described in which Doppler multiplexed signals are assigned at uneven intervals to four transmission antennas Tx #1 to Tx #4 as illustrated at part (a) in FIG. 6. At part (a) in FIG. 6, the unit of the Doppler shift interval is Δfd=1/(6Tr), the transmission Doppler frequencies (Hz) assigned to the transmission antennas Tx #1 to Tx #4 are the Doppler shift amounts Δfd1=−1/(2Tr), Δfd2=−1/(3Tr), Δfd3=−1/(6Tr), and Δfd4=0, respectively, and the transmission Doppler frequencies represented by two “x” marks are the Doppler shift amounts Δfd5=1/(6Tr) and Δfd6=1/(3Tr), respectively, indicating the case where no transmission antenna is assigned.

For example, the transmission beams (beam directions) of Tx #1 and Tx #4 are TxBeam #1 illustrated in FIG. 4, and the transmission beams (beam directions) of Tx #2 and Tx #3 are TxBeam #2 illustrated in FIG. 4. When the target object direction is target object direction (1) illustrated in FIG. 4, the reception levels are the reception signals illustrated at part (b) in FIG. 6, when the target object direction is target object direction (2) illustrated in FIG. 4, the reception levels are the reception signals illustrated at part (c) in FIG. 6, and when the target object direction is target object direction (3) illustrated in FIG. 4, the reception levels are the reception signals illustrated at part (d) in FIG. 6.

For example, in the case such as part (c) in FIG. 6, the reception levels of the reflected waves corresponding to the radar transmission waves transmitted from Tx #1 and Tx #4 of TxBeam #1 is approximately the same as the reception levels of the reflected waves corresponding to the radar transmission waves transmitted from Tx #2 and Tx #3 of TxBeam #2. Based on the reception levels of these reception signals, the multi-beam transmission MIMO radar can determine which transmission antenna used for uneven interval Doppler multiplexing transmission the detected Doppler frequency peak corresponds to. In addition, at part (c) in FIG. 6, Doppler frequency fd of the target object reflected wave can be determined within the range of −1/(2Tr)≤fd<1/(2Tr).

On the other hand, in the case such as part (b) in FIG. 6 or part (d) in FIG. 6, the Doppler frequency of the target object is unknown for the multi-beam transmission MIMO radar, and thus it is difficult to determine, based on the reception level of the reception signal, whether the reception levels of the reflected waves corresponding to the radar transmission waves transmitted from Tx #1 and Tx #4 of TxBeam #1 has decreased or whether the reception levels of the reflected waves corresponding to the radar transmission waves transmitted from Tx #2 and Tx #3 of TxBeam #2 has decreased. Therefore, it is difficult for the multi-beam transmission MIMO radar to determine, based on the reception level of a received signal, which transmission antenna used for uneven interval Doppler multiplexing transmission the detected Doppler frequency peak corresponds to. Therefore, it becomes difficult for the multi-beam transmission MIMO radar to separate the Doppler multiplexed signals, and it becomes difficult to determine Doppler frequency fd of the target object reflected wave within the range of −1/(2Tr)≤fd<1/(2Tr).

In a non-limiting example of the present disclosure, a method for improving the detection performance of the multi-beam transmission MIMO radar using uneven interval Doppler multiplexing transmission is described.

Embodiments according to exemplary embodiments of the present disclosure will be described below in detail with reference to the accompanying drawings. In the embodiments, the same constituent elements are identified with the same numerals, and a description thereof is omitted because of redundancy.

The following describes a configuration of a radar apparatus (for example, MIMO radar configuration) having a transmission branch in which multiplexed different transmission signals are simultaneously sent from a plurality of transmission antennas, and a reception branch in which the transmission signals are separated and subjected to reception processing.

Further, by way of example, a description will be given below of a configuration of a radar system using a frequency-modulated pulse wave such as a chirp pulse (e.g., also referred to as chirp pulse transmission (fast chirp modulation)). However, the modulation scheme is not limited to frequency modulation. For example, an exemplary embodiment of the present disclosure is also applicable to a radar system that uses a pulse compression radar configured to perform phase modulation or amplitude modulation on a pulse train to transmit a pulse train.

Further, the radar apparatus may perform Doppler multiplexing transmission (for example, uneven interval Doppler multiplexing transmission). In addition, the radar apparatus may be equipped with a plurality of transmission antennas with different directional characteristics.

### [Configuration of Radar Apparatus]

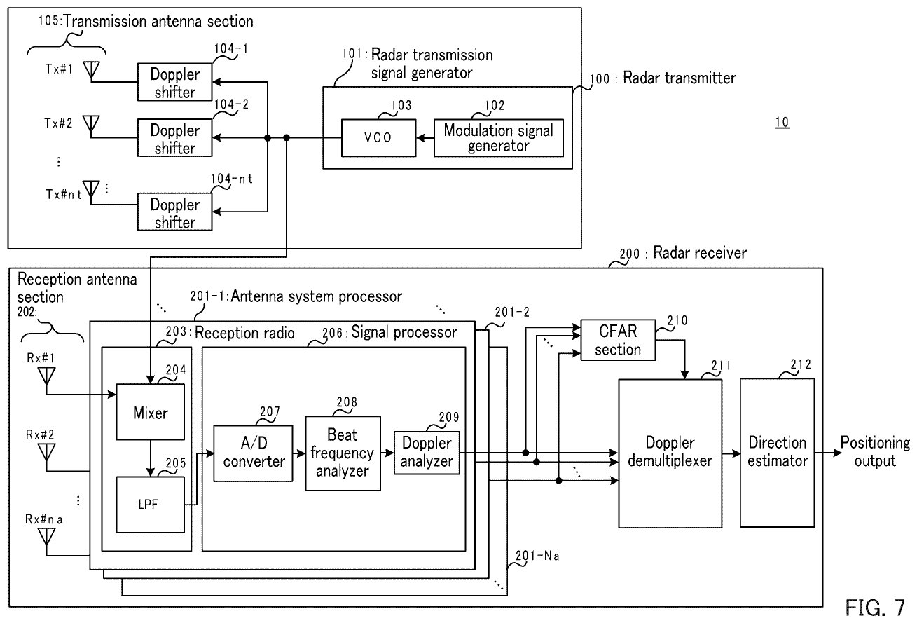

Radar apparatus 10 illustrated in FIG. 7 includes radar transmitter (transmission branch) 100 and radar receiver (reception branch) 200.

Radar transmitter 100 generates radar signals (radar transmission signals) and transmits the radar transmission signals in a specified transmission period (e.g., referred to as “radar transmission period”) using transmission antenna section 105 composed of a plurality of transmission antennas (for example, Nt transmission antennas).

Radar receiver 200 receives the reflected wave signal, which is the radar transmission signal reflected by a target object (target; not illustrated), using reception antenna section 202 that includes a plurality of reception antennas. Radar receiver 200 performs signal processing on the reflected wave signals received by respective reception antennas of reception antenna section 202 to, for example, detect the presence or absence of the target object, or estimate the distances through which the reflected wave signals arrive, the Doppler frequencies (for example, the relative speed), and the directions of arrival, and outputs information on an estimation result (for example, positioning information).

Note that, radar apparatus 10 may be mounted, for example, on a mobile body such as a vehicle, and a positioning output from positioning output section 300 (e.g., information on the estimation result) may, for example, be connected to an Electronic Control Unit (ECU) (not illustrated) of a control apparatus such as an Advanced Driver Assistance System (ADAS) or an autonomous driving system for enhancing the collision safety and utilized for a vehicle drive control or alarm call control.

Radar apparatus 10 may also be mounted on a relatively high structure (not illustrated), such as, for example, a roadside utility pole or traffic lights. Radar apparatus 10 may also be utilized, for example, as a sensor of a support system for enhancing the safety of passing vehicles or pedestrians, or as a sensor of a suspicious intrusion prevention system (not illustrated). The positioning output of radar receiver 200 may also be connected, for example, to a control device (not illustrated) in the support system or the suspicious intrusion prevention system for enhancing safety and may be utilized for an alarm call control or an abnormality detection control. The use of radar apparatus 10 is not limited to the above, and may also be used for other uses.

In addition, the target object is an object to be detected by radar apparatus 10. Examples of the target object include vehicles (including four-wheel and two-wheel vehicles), people, blocks, and curbs.

### [Configuration of Radar Transmitter 100]

Radar transmitter 100 includes radar transmission signal generator 101, Doppler shifters 104, and transmission antenna section 105. Radar transmission signal generator 101 and Doppler shifters 104 may be collectively referred to as transmission circuitry.

Radar transmission signal generator 101 generates a radar transmission signal. Radar transmission signal generator 101 includes, for example, modulation signal generator 102 and Voltage Controlled Oscillator (VCO) 103. Hereinafter, the components of radar transmission signal generator 101 will be described.

Modulation signal generator 102 periodically generates, for example, saw-toothed modulation signals.

VCO103 outputs, based on the modulation signal input from modulation signal generator 102, for example, frequency modulated signals (hereinafter, for example, referred to as a frequency chirp signals or chirp signals) to Doppler shifters 104 and radar receiver 200 (mixer 204 to be described below) as the radar transmission signals (radar transmission waves) as illustrated in FIG. 8.

In the following, modulation signal generator 102 generates a modulation signal to transmit the chirp signal Nc times for each transmission period Tr per radar positioning. VCO103 outputs the chirp signal Nc times for each transmission period Tr based on the operation of modulation signal generator 102.

Radar apparatus 10 may detect temporal variations in the position of a target object by performing multiple radar positionings, for example.

Further, in the following description, each transmission period among Nc transmission periods Tr is represented by index “m.” Here, m is an integer of 1 to Nc.

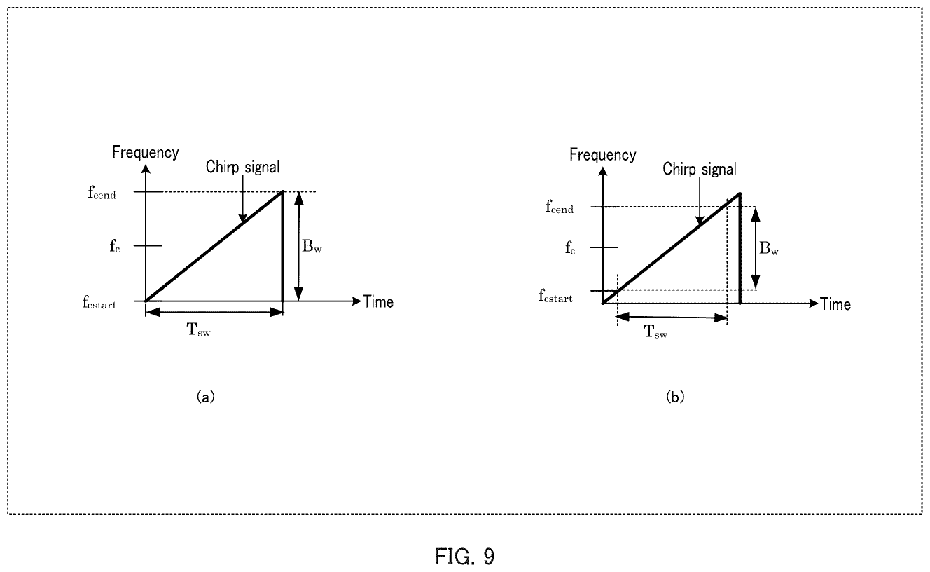

FIG. 9 illustrates an example of the chirp signal output from radar transmission signal generator 101.

As illustrated in FIG. 9, the modulation parameters for the chirp signal may include, for example, center frequency f_{c}, frequency sweep bandwidth B_{w}, sweep start frequency f_{cstart}, sweep end frequency f_{cend}, frequency sweep time T_{sw}, and frequency sweep change rate Dₘ. Note that Dₘ=B_{w}/T_{sw}. In addition, B_{w}=f_{cend}−f_{cstart}, and f_{c}=(f_{cstart}+f_{cend})/2.

Frequency sweep time T_{sw} corresponds to, for example, a time range (also called a range gate) in which A/D sampled data is taken by A/D converter 207 of radar receiver 200, which will be described below. Frequency sweep time T_{sw}, for example, may be set to the entire section of the chirp signal as illustrated at part (a) in FIG. 9, or may be set to a partial time section of the chirp signal as illustrated at part (b) in FIG. 9.

Note that FIGS. 8 and 9 illustrate examples of up-chirp waveforms in which the modulation frequency gradually increases with time, but the present disclosure is not limited thereto, and down-chirp in which the modulation frequency gradually decreases with time may be applied. Similar effects can be obtained regardless of whether the modulation frequency is of up-chirp or down-chirp.

The chirp signal output from radar transmission signal generator 101 is input to each of Nt Doppler shifters 104. Also, the chirp signal is input to each mixer 204 of radar receiver 200.

The nth Doppler shifter 104, for example, applies phase rotation Φₙ(m) for each transmission period Tr of the chirp signal to apply specified Doppler shift amount DOPₙ to the chirp signal input from radar transmission signal generator 101. The nth Doppler shifter 104 outputs the chirp signal, to which phase rotation Φₙ(m) has been applied, to the nth transmission antenna (for example, Tx #n) of transmission antenna section 105. Here, n=1 to Nt.

Transmission antenna section 105 may include Nt transmission antennas Tx #1 to Tx #Nt. Transmission antennas Tx #1 to Tx #Nt may constitute a multi-beam transmission radar that includes transmission antennas with at least two different types of main beam directions (or beam directions). For example, Doppler shifters 104 may apply phase rotation Φn(m) that provides different Doppler shift amounts for respective transmission antennas of transmission antenna section 105, based on the configuration of the transmission antennas corresponding to beam directions in transmission antenna section 105 to the chirp signal and output it to transmission antenna section 105. Thus, even when there is a significant difference in the reception level (for example, reception power level of reception signal) between reception signals corresponding to transmission antennas with different beam directions (for example, when the difference in or ratio between reception levels exceeds a threshold), radar apparatus 10 can separate Doppler multiplexed signals, reducing degradation in positioning performance and radar detection capability (exemplary operations will be described below).

The output from each of Nt Doppler shifters 104 is amplified to a specified transmission power and then radiated into space from corresponding one of transmission antennas Tx #1 to Tx #Nt of transmission antenna section 105.

### [Configuration of Radar Receiver 200]

In FIG. 7, radar receiver 200 includes reception antenna section 202 including Na reception antennas Rx #1 to Rx #Na. Radar receiver 200 further includes Na antenna system processors 201-1 to 201-Na, Constant False Alarm Rate (CFAR) section 210, coded Doppler demultiplexer 211, and direction estimator 212. Na antenna system processors 201-1 to 201-Na, CFAR section 210, Doppler demultiplexer 211, and direction estimator 212 may be collectively referred to as reception circuitry. The reception circuitry performs direction estimation of a target (target object) by using a reflected wave signals resulted from the transmission signal being reflected by the target.

Reception antennas Rx #1 to Rx #Na of reception antenna section 202 each receive a reflected wave signal resulted from a radar transmission signal being reflected by a target object (target), and output the received reflected wave signal to the corresponding one of antenna system processors 201 as a reception signal.

Each of antenna system processors 201 includes reception radio 203 and signal processor 206.

Signals received by Na reception antennas Rx #1 to Rx #Na are output respectively to Na reception radios 203. Further, the output signals from Na reception radios 203 are output respectively to Na signal processors 206.

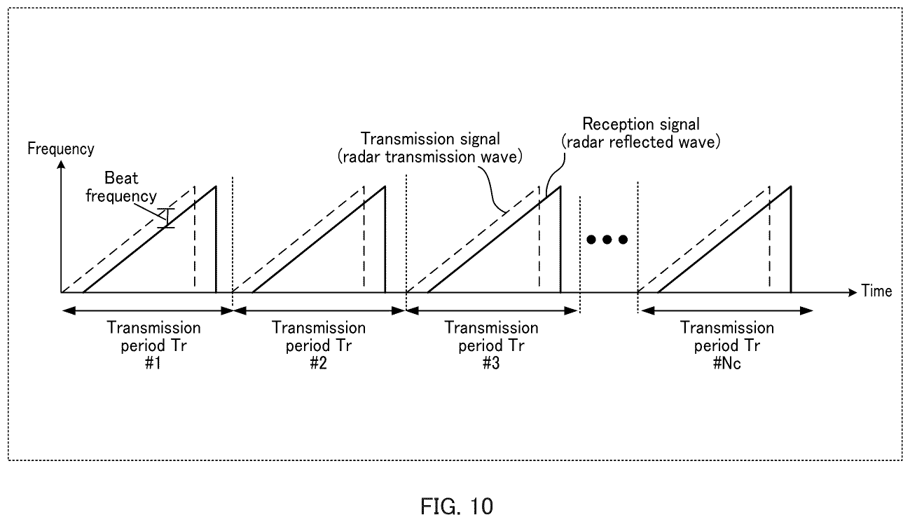

Each of reception radios 203 includes mixer 204 and low pass filter (LPF) 205. Mixer 204 mixes the received reflected wave signal with a chirp signal (which is a transmission signal) input from radar transmission signal generator 101. Reception radio 203, for example, cause the output of mixer 204 to pass through LPF 205. As a result, a beat signal, which has a frequency depending on a delay time of the reflected wave signal, is output. For example, as illustrated in FIG. 10, the difference in frequency between the transmission chirp signal (transmission frequency modulated wave), which is the transmission signal (radar transmission wave), and the reception chirp signal (reception frequency modulated wave), which is the reception signal (radar reflected wave), is obtained as the beat frequency.

Signal processor 206 of each antenna system processor 201-z (where z=any one of 1 to Na) includes AD converter 207, beat frequency analyzer 208, and Doppler analyzer 209.

The signal (for example, beat signal) output from LPF 205 is converted into discretely sampled data by AD converter 207 in signal processor 206.

Beat frequency analyzer 208 performs frequency analysis processing (for example, FFT processing) on the N_{data} pieces of discrete sample data obtained within a specified time range (range gate) for each transmission period Tr. Signal processor 206 thus outputs a frequency spectrum in which a peak appears at a beat frequency dependent on the delay time of the reflected wave signal (radar reflected wave). In the FFT processing, for example, beat frequency analyzer 208 may perform multiplication by a window function coefficient such as the Han window or the Hamming window. The application of a window function coefficient can suppress sidelobes around the beat frequency peak.

When N_{data} is not a power of 2, FFT processing can be performed with a data size (FFT size) that is a power of 2 by including zero-padded data, for example. In such cases, it is acceptable to treat the data size including the zero-padded data as N_{data}, in the same manner as above.

Here, the beat frequency response output from beat frequency analyzer 208 in zth signal processor 206 obtained by the mth chirp pulse transmission is denoted as “RFT_{z}(f_{b}, m).” Here, f_{b} denotes the beat frequency index and corresponds to an FFT index (bin number). For example, f_{b}=0, . . . , (N_{data}/2)−1, z=1 to Na, and m=1 to N_{C}. A beat frequency having smaller beat frequency index f_{b} indicates a shorter delay time of the reflected wave signal (for example, a shorter distance to the target object).

Further, beat frequency index f_{b} can be converted into distance information R(f_{b}) using following Expression 1. Thus, in the following, beat frequency index f_{b} is also referred to as “distance index f_{b}.”

$$\begin{matrix}[ 1 ] & \\ R ( {f}_{b} ) = \frac{{C}_{0} {f}_{b}}{2 {B}_{w}} & ( Expression 1 )\end{matrix}$$

Here, B_{w} denotes a frequency-modulation bandwidth within the range gate for a chirp signal, and C₀ denotes the speed of light. Also, in Expression 1, C₀/(2B_{w}) represents the distance resolution.

Doppler analyzer 209 in zth signal processor 206 performs Doppler analysis for each distance index f_{b} using data from Nc transmission periods of the chirp signal (for example, beat frequency responses RFT_{z}(f_{b}, 1), RFT_{z}(f_{b}, 2), . . . , RFT_{z}(f_{b}, Nc) input from beat frequency analyzers 208).

For example, when Nc is a power of 2, Doppler analyzer 209 can apply FFT processing in Doppler analysis as in following Expression 2:

$$\begin{matrix}[ 2 ] & \\ {VFT}_{z} ( {f}_{b} , {f}_{s} ) = {\sum }_{m = 1}^{{N}_{c}} {RFT}_{z} ( {f}_{b} , m ) exp [ - \frac{j 2 π ( m - 1 ) {f}_{s}}{{N}_{c}} ] & ( Expression 2 )\end{matrix}$$

Here, the FFT size is Nc, and the maximum Doppler frequency without aliasing derived from the sampling theorem is ±1/(2Tr). Also, the Doppler frequency interval of Doppler frequency index fₛ is 1/(Nc×Tr), and the range of Doppler frequency index fₛ is fₛ=−N_{c}/2, . . . , 0, . . . , (Nc/2)−1. Further, j is the imaginary unit, and z=1 to Na.

By way of example, a description will be given of a case where Nc is a power of 2. When Nc is not a power of 2, FFT processing can be performed with a data size (FFT size) that is a power of 2 by including zero-padded data, for example. In the FFT processing, Doppler analyzer 209 may perform multiplication by a window function coefficient such as the Han window or the Hamming window. The application of a window function can suppress sidelobes around the Doppler frequency peak.

The processing in each component of signal processor 206 has been described above.

In FIG. 7, CFAR section 210 performs CFAR processing (for example, adaptive threshold determination) using the output of Doppler analyzer 209 of each of first to Nath signal processors 206. For example, in CFAR processing, the local peak of a reception signal of a reflected radar transmission signal sent from transmission antenna section 105 may be selectively extracted and adaptive threshold determination may be performed. CFAR section 210, for example, extracts distance index f_{b_cfar} and Doppler frequency index f_{s_cfar} that provide the local peak signal, and outputs them to Doppler demultiplexer 211.

Doppler demultiplexer 211, for example, uses the outputs of Doppler analyzers 209 of first to Nath signal processors 206, and the output of CFAR section 210, to separate (hereinafter referred to as “Doppler demultiplexing”) the radar reflected-wave reception signals for respective radar transmission signals sent from a plurality of transmission antennas using Doppler multiplexing.

The operation of Doppler demultiplexer 211, for example, is related to the operation of Doppler shifters 104 of radar transmitter 100. Similarly, the operation of CFAR section 210, for example, is related to the operation of Doppler shifters 104. Hereinafter, an exemplary operation of Doppler shifters 104 will be described, followed by exemplary operations of CFAR section 210 and Doppler demultiplexer 211.

### [Exemplary Operation of Doppler Shifter 104 in Radar Transmitter 100]

First to Ntth Doppler shifters 104, for example, perform Doppler multiplexing transmission by applying different Doppler shift amounts DOPₙ to the radar transmission signals input respectively to them. Radar apparatus 10 transmits (Doppler multiplexing transmission), from the Nt transmission antennas, the radar transmission signals to which phase rotation corresponding to the Doppler shift amounts assigned to the Nt transmission antennas by Doppler shifters 104 has been applied.

Hereinafter, an example using a chirp signal as the radar transmission signal will be described.

For example, in order to apply specified Doppler shift amount DOPₙ to nth transmission antenna Tx #n, nth Doppler shifter 104 applies phase rotation Φₙ(m) for each transmission period Tr for the input chirp signal and outputs the chirp signal. Here, Doppler shifter 104 may apply and output phase rotation Φₙ(m) that provides a different Doppler shift for each transmission antenna through which the chirp signal is transmitted. Here, n=1 to Nt. For example, phase rotation Φₙ(m) applied for each transmission period Tr of the chirp signal may be set using Φₙ(m)=2πDOPₙ×Tr.

For example, transmission antennas Tx #1 to Tx #Nt of transmission antenna section 105 include a multi-beam transmitting radar including transmission antennas corresponding to at least two different beam directions (for example, transmission antennas forming beams in at least two different beams directions). For example, Doppler shifter 104 may apply phase rotations Φn(m) to the chirp signals, which apply different Doppler shifts to respective transmission antennas from which the chirp signals are transmitted, taking into account the configurations of transmission antennas Tx #1 to Tx #Nt having different beam directions, and output the chirp signals. Thus, even when the reception power levels of the reflected waves differ significantly between the reception signals corresponding to the chirp signals transmitted from the transmission antennas with different beam directions, radar apparatus 10 allows separation of the Doppler multiplexed signals, thereby improving the positioning performance and the radar detection performance of radar apparatus 10.

Transmission antennas Tx #1 to Tx #Nt may include a plurality of transmission antennas corresponding to different beam directions. Further, the transmission antennas Tx #1 to Tx #Nt may include a plurality of transmission antennas corresponding to the same beam direction.

Radar apparatus 10 may, for example, be a multi-beam transmission MIMO radar using Nt transmission antennas Tx #1 to Tx #Nt including transmission antennas with different beam directions, and may perform uneven interval Doppler multiplexing transmission using Nt transmission antennas Tx #1 to Tx #Nt.

In addition, radar apparatus 10 may simultaneously perform multiplexing transmission of the radar transmission signals from Nt transmission antennas Tx #1 to Tx #Nt, for example, using Doppler multiplexing transmission that satisfies the following Condition 1.

In the following description, among the plurality of beam directions (or the plurality of beams) used in the multi-beam transmission MIMO radar, the first beam direction (or the beam) will be described as “B1” and the second beam direction (or the beam) will be described as “B2.” Further, for example, the qth beam direction (or, beam) is described as “Bq.” Here, q is an integer value within a number of different beam directions (e.g., a multi-beam number NB). For example, when the multi-beam number NB is 2, q=1 or 2.

Further, number Nt of transmission antennas is set to be 3 or more. For example, Doppler multiplexing number N_{DDM} is set to be 3 or more. The number of transmission antennas is not limited to Nt≥3 and may be, for example, Nt=2. The case where Nt=2 will be described below in Variation 1.

Further, in transmission antenna section 105, the number of transmission antennas corresponding to beam direction B1 is N_{B1}, the number of transmission antennas corresponding to beam direction B2 is N_{B2}. This results in an N_{B1}+N_{B2}=Nt. Radar apparatus 10 may also assign one Doppler multiplexed signal, for example, to one transmission antenna.

### <Condition 1>

Between the Doppler multiplexed signals assigned to transmission antennas with beam direction B1 and transmission antennas with beam direction B2, one of the following conditions is satisfied:
(1) The Doppler multiplexing numbers corresponding to respective beam directions are the same (e.g., N_{B1}=N_{B2}. This item is considered when N_{B1}≥2, N_{B2}≥2, and does not need to be considered when N_{NB1}=N_{NB2}=1), and different Doppler shift intervals are included in each beam direction;
(2) The Doppler multiplexing numbers (or the number of transmission antennas) are different for respective beam directions (N_{B1}≠N_{B2}); and
(3) When N_{B1}≥3, N_{B2}≥3, the order of Doppler shift intervals differs when the Doppler multiplexing numbers corresponding to respective beam directions are the same (N_{B1}=N_{B2}) and the Doppler shift intervals for each beam direction include the same Doppler shift interval.

In addition, radar apparatus 10 may simultaneously perform multiplexing transmission of the radar transmission signals from Nt transmission antennas Tx #1 to Tx #Nt, for example, using Doppler multiplexing transmission that satisfies the following Condition 2.

### <Condition 2>

A Doppler multiplexed signal is assigned in each of beam directions B1 and B2 so as to achieve:
uneven interval Doppler multiplexing by transmission antennas with beam direction B1 (considered when N_{B1}≥2, and does not need to be considered when N_{NB1}=1); and uneven interval Doppler multiplexing by transmission antennas with beam direction B2 (considered when N_{B2}≥2, and does not need to be considered when N_{NB2}=1).

For example, in item (1) of Condition 1, when Doppler multiplexing number N_{B1} by transmission antennas with beam direction B2 is the same as Doppler multiplexing number N_{B2} by transmission antennas with beam direction B1, at least one of Doppler shift amount intervals (also referred to as “Doppler shift amount intervals” or “Doppler shift intervals”) assigned to the transmission antennas with beam direction B1 may be different from the intervals of the Doppler shift amount intervals assigned to transmission antennas with beam direction B2. Examples of item (1) of Condition 1 include, between the Doppler multiplexed signals assigned to transmission antennas with beam direction B1 and transmission antennas with beam direction B2, cases where the maximum Doppler shift intervals are different, cases where the minimum Doppler shift intervals are different, or cases where Doppler shift intervals that are not the maximum or the minimum are different.

Further, for example, in item (2) of Condition 1, Doppler multiplexing number N_{B1} by the transmission antennas with beam direction B1 (e.g., the number of transmission antennas) may be different from Doppler multiplexing number N_{B2} by the transmission antenna with beam direction B2 (e.g., the number of transmission antennas).

Further, for example, in (3) of Condition 1, when Doppler multiplexing number N_{B1} by the transmission antennas with beam direction B1 and Doppler multiplexing number N_{B2} by the transmission antennas with beam direction B2 are the same, and when the respective values of the plurality of intervals of the assigned Doppler shift amounts (e.g., the combination of Doppler shift intervals) are the same for the transmission antennas with beam direction B1 and the transmission antennas with beam direction B2, the order of the plurality of Doppler shift intervals corresponding to the transmission antennas with beam direction B1 on the Doppler frequency axis may be different from the order of the plurality of Doppler shift intervals corresponding to the transmission antennas with beam direction B2 on the Doppler frequency axis.

The above case is such that, for example, a combination of intervals included in an array (for example, a first array) in which the Doppler shift amount intervals assigned to the transmission antennas with beam direction B1 are arranged in ascending order on the Doppler frequency axis coincide with the combination of intervals included in an array (for example, a second array) in which Doppler shift amount intervals assigned to the transmission antennas with beam direction B2 are arranged in ascending order on the Doppler frequency axis, and the first and second arrays differ from each other in their circular permutations.

When item (3) of Condition 1 is satisfied, the Doppler shift intervals of the transmission antennas with beam direction B1 do not coincide with the Doppler shift intervals of the transmission antennas with beam direction B2 even when one of them is cyclically shifted in the Doppler frequency domain.

Further, in Condition 2 for example, on the Doppler frequency axis, the respective intervals of the Doppler shift amounts assigned to the transmission antennas with beam direction B1 may be set at uneven intervals. Similarly, in Condition 2, on the Doppler frequency axis, the respective intervals of the Doppler shift amounts assigned to the transmission antennas with beam direction B2 may be set at uneven intervals. In Condition 2, uneven interval Doppler multiplexing transmission may be applied in either or both of beam direction B1 and beam direction B2.

Thus, in the uneven interval Doppler multiplexing transmission by radar apparatus 10, which is a multi-beam transmission MIMO radar, the respective intervals of the Doppler shift amounts assigned to the plurality of transmission antennas included in transmission antenna section 105 are uneven interval on the Doppler frequency axis. Further, for example, the pattern of the Doppler shift amounts assigned to the transmission antennas with beam direction B1 (e.g., a pattern related to Doppler shift interval or the number of transmission antennas (Doppler multiplexing number), and/or the order of the Doppler shift amount intervals on the Doppler frequency axis) differs from the pattern of the Doppler shift amounts assigned to the transmission antennas with beam direction B2 (corresponding to Condition 1).

As a result, even when the reception power levels of the reflected waves differ significantly between the reception signals from the transmission antennas with different beam directions, radar apparatus 10 can separate the Doppler multiplexed signals and can suppress deterioration of the positioning performance and the radar detection performance.

Further, for example, among the plurality of transmission antennas included in transmission antenna sections 105, intervals of the Doppler shift amounts assigned to the transmission antennas respectively corresponding to the plurality of different beam directions may be uneven (corresponding to Condition 2). By satisfying Condition 2, the detectable Doppler frequency range in radar apparatus 10 is in the range of −1/(2Tr)≤fd<1/(2Tr) and can be expanded beyond the Doppler detection range −1/(2 Nₜ Tr)≤fd<1/(2 Nt Tr), namely in the case of even interval Doppler multiplexing transmission.

For example, in Doppler multiplexing transmission by radar apparatus 10, both Condition 1 and Condition 2 may be satisfied, or Condition 1 may be satisfied but Condition 2 does not have to be satisfied. The following three cases are given as cases in which Condition 1 is satisfied but Condition 2 is not satisfied.

### (Case 1)

Case 1 is a case of even interval Doppler multiplexing in the transmission antennas with beam direction B1 and in the transmission antennas with beam direction B2 (considered when N_{B1}≥2 and N_{B2}≥2, and does not need to be considered when N_{NB1}=N_{NB2}=1). In Case 1, the detectable Doppler frequency range fd in radar apparatus 10 is in the range of −1/(2Tr)≤fd<1/(2Tr), in the range of −1/(2 N_{B1}Tr)≤fd<1/(2 N_{B1}Tr) or in the range of −1/(2 N_{B2}Tr)≤fd<1/(2 N_{B2}Tr), depending on the target object direction.

### (Case 2)

Case 2 is the case where the transmission antennas with beam direction B1 are in uneven interval Doppler multiplexing and the transmission antennas with beam direction B2 are in even interval Doppler multiplexing (considered when N_{B1}≥2 and N_{B2}≥2, and does not need to be considered when N_{NB1}=N_{NB2}=1). In Case 2, the detectable Doppler frequency range fd in radar apparatus 10 is in the range of −1/(2Tr)≤fd<1/(2Tr) or −1/(2 N_{B2}Tr)≤fd<1/(2 N_{B2}Tr), depending on the target object direction.

### (Case 3)

Case 3 is the case where the transmission antennas with beam direction B1 are in even interval Doppler multiplexing and the transmission antennas with beam direction B2 are in uneven interval Doppler multiplexing (considered when N_{B1}≥2 and N_{B2}≥2, and does not need to be considered when N_{NB1}=N_{NB2}=1). In Case 3, the detectable Doppler frequency range fd in radar apparatus 10 is in the range of −1/(2Tr)≤fd<1/(2Tr) or −1/(2 N_{B1}Tr)≤fd<1/(2 N_{B1}Tr), depending on the target object direction.

In all the cases 1 to 3, the detectable Doppler frequency range can be expanded beyond the Doppler detection range of −1/(2 Nₜ Tr)≤fd<1/(2 Nₜ Tr), namely in the case of even interval Doppler multiplexing.

Since Doppler analyzer 209 analyzes the Doppler frequency of the output from beat frequency analyzer 208 for each distance index with at transmission period Tr, the range of Doppler frequency fd derived according to the sampling theorem where aliasing does not occur is −1/(2Tr)≤fd<1/(2Tr), and even for Doppler frequencies beyond this range, the range of Doppler frequency fd observed is −1/(2Tr)≤fd<1/(2Tr).

For example, when Doppler shifter 104 applies a Doppler shift amount within the range of −1/(2Tr)≤fd<1/(2Tr), the largest Doppler shift interval for Nt transmission antennas (=Doppler multiplexing number) becomes Δfdmax=1/(TrNt)=1/(TrN_{DM}). Doppler shifter 104 may set the Doppler shift interval to a smaller interval than Δfdmax, for example. Phase rotation φ that provides such a Doppler shift amount can be configured within the range of −π≤φ<π, for example.

In the following description of the operation of Doppler shifter 104, when phase rotation φ₀ exceeding the range of −π≤φ<π is applied, phase rotation φ₀+2πα, which is in phase within the range from −π to π, may be applied. Here, a is an integer value such that −π≤φ₀+2πα<π.

Further, the Doppler shift interval applied to the Doppler multiplexed signal configured by Doppler shifter 104 may be configured in units of Δfd as shown in following Expression 3, for example. Here, δ>0, and δ can be a positive integer or a positive real number. By setting δ as a positive integer, the processing in CFAR section 210 described below can be simplified. It should be noted that the following shows the case where δ is a positive integer, but δ is not limited thereto, and a positive real number may also be used.

$$\begin{matrix}[ 3 ] & \\ Δ fd = 1 / ( Tr \times ( {N}_{DM} + δ ) ) & ( Expression 3 )\end{matrix}$$

Further, in Expression 3, when δ is set as a positive integer such that δ>1, there are a plurality of Doppler shift amounts which are not assigned to the Doppler multiplexed signals (for example, the Doppler shift amounts indicated by the “×” mark in the drawings used in the following exemplary configuration of Doppler shift amounts). In this case, for example, by assigning the Doppler multiplexed signals such that these Doppler shift amounts are not at even intervals, radar apparatus 10 can set detectable Doppler frequency range fd within the range of −1/(2Tr)≤fd<1/(2Tr).

Hereinafter, an exemplary configuration of the Doppler shift amount in Doppler shifter 104 will be described. The assignment of the Doppler shift amounts for the respective transmission antennas may be in ascending order, descending order, or randomly with respect to the transmission Doppler frequency, and each exemplary configuration is merely an example.

### <Exemplary Configuration 1 of Doppler Shift Amount>

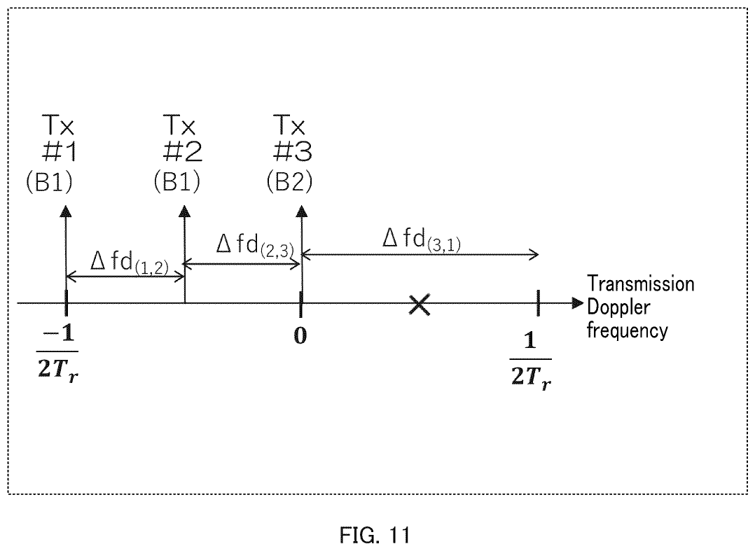

FIG. 11 shows an exemplary configuration of Doppler shift amounts for the transmission Doppler frequency in the case of the number of transmission antennas being Nt=3, N_{B1}=2, and N_{B2}=1. In FIG. 11, Tx #1 and Tx #2 are each a transmission antenna with beam direction B1 (e.g., a transmission antenna forming transmission beam B1), and Tx #3 is a transmission antenna with beam direction B2 (e.g., a transmission antenna forming transmission beam B2).

In exemplary configuration 1 of the Doppler shift amounts, as illustrated in FIG. 11, the basic unit of the Doppler shift intervals in Doppler shifters 104 is set as Δfd=1/(Tr×(N_{DM}+δ))=1/(4Tr), and δ=1. However, the value of δ is not limited thereto, and may be a positive integer or a positive real number.

In the example illustrated in FIG. 11, the first to third Doppler shifters 104 (or Doppler shifters 104-1, 104-2, and 104-3) may perform the following operations.

To apply Doppler shift amount DOP₁=−1/(2Tr) to first transmission antenna Tx #1, first Doppler shifter 104, for example, applies phase rotation Φ₁(m)=2πDOP₁×(m−1) Tr=−π(m−1) for each transmission period Tr of the chirp signal and outputs the chirp signal.

To apply Doppler shift amount DOP₂=−1/(4Tr) to second transmission antenna Tx #2, second Doppler shifter 104, for example, applies phase rotation Φ₂(m)=2πDOP₂×(m−1) Tr=−π(m−1)/2 for each transmission period Tr of the chirp signal and outputs the chirp signal.

To apply Doppler shift amount DOP₃=0 to third transmission antenna Tx #3, third Doppler shifter 104, for example, applies phase rotation Φ₃(m)=2πDOP₃×(m−1) Tr=0 for each transmission period Tr of the chirp signal and outputs the chirp signal.

Hereinafter, the Doppler shift amount intervals applied to Tx #n1 and Tx #n2 are denoted as the Doppler shift interval “Δfd_{(n1, n2)}.” Here, Δfd_{(n1, n2)} represents the interval (Δfd₁₂−Δfdₙ₁) of Doppler shift amount Δfd₁₂ applied to Tx #n2 based on Doppler shift amount Δfdₙ₁ applied to Tx #n1. When Doppler shift interval Δfd_{(n1, n2)} is a negative value (e.g., (Δfdₙ₂−Δfdₙ₁)<0), the Doppler shift interval Δfd_{(n1, n2)} is calculated using Δfd_{(n1, n2)}−1/Tr−Δfd_{(n1, n2)} in consideration of aliasing in the range of the observation range of Doppler analyzer 209, which is equal to or greater than −1/(2Tr) and less than 1/(2Tr), and is expressed as a positive value. Descriptions of the subsequent Doppler shift interval Δfd_{(n1, n2)} use similar notation.

In FIG. 11, the patterns of Doppler shift amount intervals (Doppler shift intervals) applied to transmission antennas Tx #1, Tx #2 and Tx #3 are Δfd_{(1, 2)}=Δfd, Δfd_{(2, 3)}=Δfd and Δfd_{(3, 1)}=2Δfd. Therefore, Doppler shift amount intervals applied to the respective transmission antennas (number thereof being Nt=3) in FIG. 11 are not all the same but include uneven intervals (e.g., Δfd_{(1, 2)}=Δfd_{(2, 3)}≠Δfd_{(3, 1)}), resulting in uneven interval Doppler multiplexing transmission (uneven interval DDM transmission).

Further, among the transmission antennas in FIG. 11, the Doppler shift intervals between transmission antennas Tx #1 and Tx #2 with beam direction B1 is Δfd_{(1, 2)}=Δfd, and Δfd_{(2, 1)}=3Δfd. Therefore, Doppler shift amount intervals applied respectively to transmission antennas (number thereof being N_{B1}=2) with beam direction B1 are not all the same but include uneven intervals (Δfd_{(1, 2)}≠Δfd_{(2, 1)}), resulting in uneven interval Doppler multiplexing transmission (uneven interval DDM transmission) by the transmission antennas with beam direction B1.

Further, in FIG. 11, the number N_{B2} of transmission antennas with beam direction B2 among the transmission antennas is 1, and therefore, the transmission antenna with beam direction B2 is not in a relationship that allows Doppler multiplexing transmission.

From the above, the example illustrated in FIG. 11 is an exemplary configuration of a pattern of Doppler shift amounts satisfying Condition 2.

Further, N_{B1} (=2)≠N_{B2} (=1) in FIG. 11. For example, the example illustrated in FIG. 11, the pattern of the Doppler shift amounts assigned to the transmission antennas with beam direction B1 differs from the pattern of the Doppler shift amounts assigned to the transmission antennas with beam direction B2.

Therefore, the example illustrated in FIG. 11 is an exemplary configuration of a pattern of Doppler shift amounts satisfying item (2) of Condition 1.

The following describes an example of a reception signal at the output from Doppler analyzer 209, in which transmission antenna section 105 includes transmission antennas in beam directions B1 and B2, based on the Configuration for Doppler shift amounts illustrated in FIG. 11, and reception antenna section 202 is an omnidirectional antenna (or an antenna having substantially uniform directional characteristics within the viewing angle covered by both the transmission antenna with beam direction B1 and the transmission antenna beam direction B2).

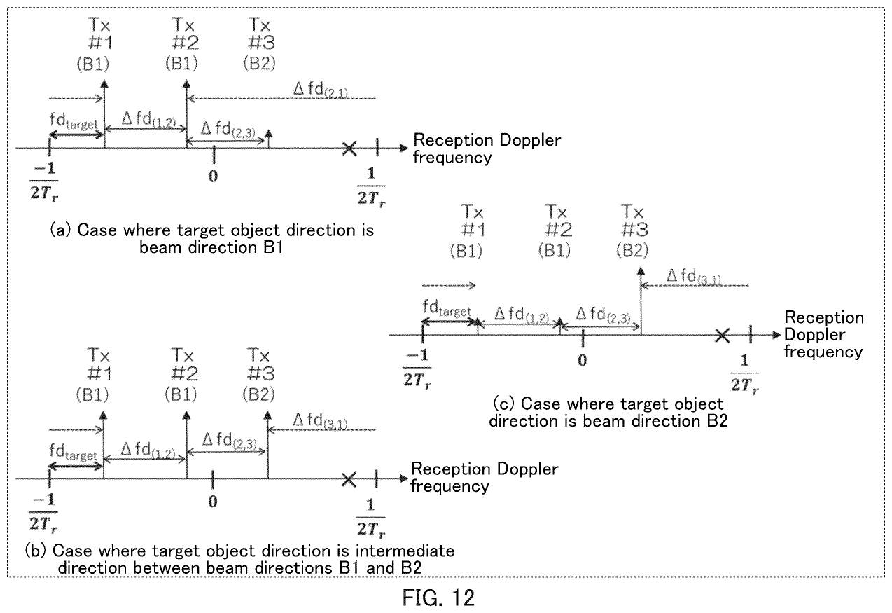

FIG. 12 shows an output example of Doppler analyzers 209 for target object reflected waves at certain distance indices. For example, the target object reflected waves include Doppler frequency fd_{target}. Therefore, as illustrated in FIG. 12, radar apparatus 10 receives a signal that has undergone a Doppler shift of fd_{target} from the Doppler shift amount illustrated in FIG. 11.

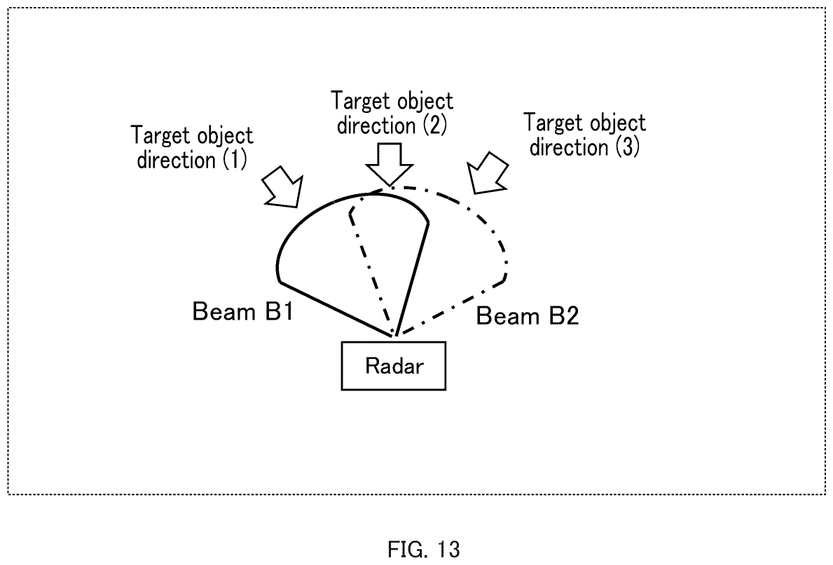

FIG. 13 also shows an exemplary multi-beam transmission MIMO radar (e.g., radar apparatus 10) forming transmission beams in beam direction B1 (Tx Beam #1) and beam direction B2 (Tx Beam #2).

For example, when the target object direction is target object direction (1) illustrated in FIG. 13 (for example, when there is a target object in the periphery of beam direction B1), the radiation direction of the radar transmission waves transmitted from Tx #1 and Tx #2 with beam direction B1 coincides with the target object direction. Therefore, as illustrated at part (a) in FIG. 12, the reception levels of the reception signals of the reflected waves from the target object corresponding to Tx #1 and Tx #2 in radar apparatus 10 become relatively high. On the other hand, when the target object direction is target object direction (1) illustrated in FIG. 13, the radiation direction of the radar transmission wave transmitted from Tx #3 with beam direction B2 does not coincide with the target object direction, and the target object direction corresponds to the null direction of the transmission beam B2. Therefore, as illustrated at part (a) in FIG. 12, the reception level of the reception signal of the reflected wave from the target object corresponding to Tx #3 in radar apparatus 10 is lower than the reception levels of the reception signals corresponding to Tx #1 and Tx #2. For example, as illustrated at part (a) in FIG. 12, the reception level of the reception signal corresponding to Tx #3 may differ greatly from the reception levels of the reception signals corresponding to Tx #1 and Tx #2, and depending on the beam directional characteristic in the null direction of Tx #3, the reception level may become 10 dB or more lower.

Further, for example, when the target object direction is an intermediate direction between beam direction B1 and beam direction B2, and the target object direction is in the direction of an overlapping area (for example, in the case of target object direction (2) illustrated in FIG. 13) where the beam widths of both beams (each of which is about 3 dB or 6 dB of the beam) overlap with each other, the reception levels of the reception signals corresponding to Tx #1 and Tx #2 with beam direction B1 are approximately the same as the reception level of the reception signal corresponding to Tx #3 with beam direction B2, as illustrated at part (b) in FIG. 12.

In addition, for example, when the target object direction is target object direction (3) illustrated in FIG. 13 (for example, when there is a target object in the periphery of beam direction B2), the radiation direction of the radar transmission wave transmitted from Tx #3 with beam direction B1 coincides with the target object direction. Therefore, as shown in at part (c) in FIG. 12, the reception level of the reception signal of the reflected wave from the target object corresponding to Tx #3 in radar apparatus 10 becomes relatively high. On the other hand, when the target object direction is target object direction (3) illustrated in FIG. 13, the radiation direction of the radar transmission waves transmitted from Tx #1 and Tx #2 with beam direction B1 does not coincide with the target object direction, and the target object direction corresponds to the null direction of transmission beam B2. Therefore, as illustrated at part (c) in FIG. 12, the reception levels of the reception signals of the reflected waves from the target object corresponding to Tx #1 and Tx #2 in radar apparatus 10 is lower than the reception level of the reception signal corresponding to Tx #3. For example, as illustrated at part (c) in FIG. 12, the reception levels of the reception signals corresponding to Tx #1 and Tx #2 may differ greatly from the reception level of the reception signal corresponding to Tx #3, and depending on the beam directional characteristic in the null direction of Tx #1 and Tx #2, the reception level may become 10 dB or more lower.

For example, when the target object direction is an intermediate direction between beam direction B1 and beam direction B2 (target object direction (2) illustrated in FIG. 13) as illustrated at part (b) in FIG. 12, radar apparatus 10 receives the reception signals corresponding to the transmission antennas in the respective beam directions at approximately the same level of reception. Therefore, the signals transmitted from transmitted from Nt transmission antennas including the respective transmission antennas with beam direction B1 and beam direction B2 are subjected to Doppler multiplexing transmission using Doppler shift intervals resulting in uneven interval Doppler multiplexing. Therefore, radar apparatus 10 can separate the Doppler multiplexed signals on the basis of a known separation operation of Doppler multiplexed signals (the known separation operation of Doppler multiplexed signals, for example, is disclosed in PTL 6 and 7, the same applies to the following embodiments).

In addition, when the target object direction is beam direction B1 as illustrated at part (a) in FIG. 12 (target object direction (1) illustrated in FIG. 13) and when the target object direction is beam direction B2 as illustrated at part (c) in FIG. 12 (target object direction (3) illustrated in FIG. 13), radar apparatus 10 receives different Doppler multiplexed signals (for example, Doppler multiplexed signals satisfying item (2) of Condition 1) depending on the target object direction. For example, radar apparatus 10 receives signals of two Doppler frequency components with Doppler shift interval Δfd_{(1, 2)} and Δfd_{(2, 1)} in the case of part (a) in FIG. 12 (the case of target object direction (1) illustrated in FIG. 13). On the other hand, for example, radar apparatus 10 receives signal of one Doppler frequency component in the case of part (c) in FIG. 12 (the case of target object direction (3) illustrated in FIG. 13).

In this way, when the target object direction is beam direction B1 or B2, radar apparatus 10 receives reflected wave signals including Doppler frequency components with a varying pattern depending on a case where the reception level of the reception signal corresponding to the transmission antenna with beam direction B1 decreases or a case where the reception level of the reception signal corresponding to the transmission antenna with beam direction B2 decreases.

As a result, for example, radar apparatus 10 can determine whether a decrease in the reception level of the reception signal corresponding to the transmission antenna with beam direction B1 has occurred (for example, the state of part (c) in FIG. 12) or whether a decrease in the reception level of the reception signal corresponding to the transmission antenna with beam direction B2 has occurred (for example, the state of part (a) in FIG. 12), based on the detected peak of the Doppler frequency (for example, the number of peaks), in Doppler demultiplexer 211 described below.

Further, for example, Doppler multiplexed signals transmitted from transmission antennas Tx #1 and Tx #2 with beam direction B1 is subjected to Doppler multiplexing transmission using the Doppler shift intervals resulting in uneven interval Doppler multiplexing. Therefore, for example, when the reception signals are determined to be corresponding to transmission antennas Tx #1 and Tx #2 with beam direction B1 from the discrimination result of Doppler demultiplexer 211, radar apparatus 10 can separate the Doppler multiplexed signals using the known separation operation of Doppler multiplexed signals.

Further, for example, transmission antenna Tx #3 with beam direction B2 is one antenna transmission. Therefore, for example, when it is determined from the discrimination result of Doppler demultiplexer 211 that the reception signal is a reception signal corresponding to transmission antenna Tx #3 with beam direction B2, radar apparatus 10 does not have to perform the separation processing of the Doppler multiplexed signal for the reception signal in beam direction B2.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

### <Exemplary Configuration 2 of Doppler Shift Amount>

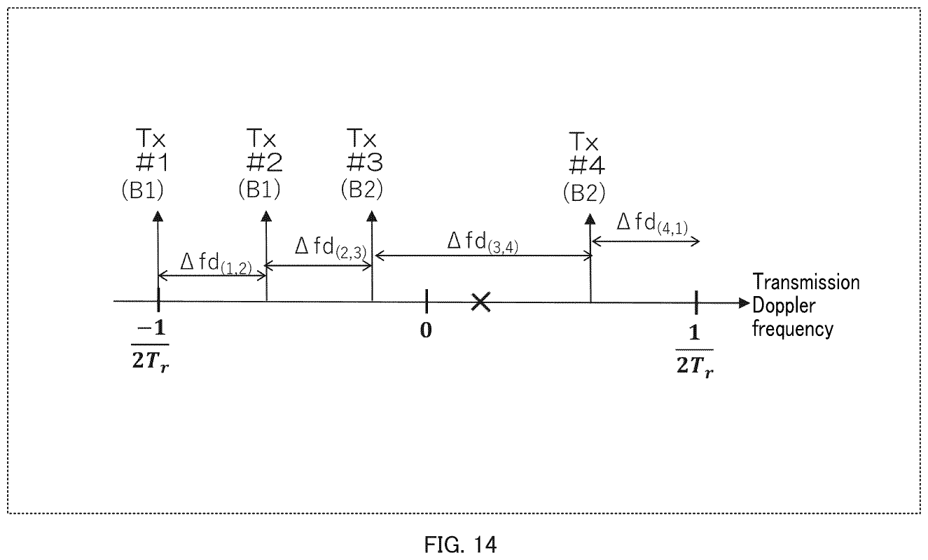

FIG. 14 shows an exemplary configuration of Doppler shift amounts for the transmission Doppler frequency in the case of the number of transmission antennas being Nt=4, N_{B1}=2, and N_{B2}=2. In FIG. 14, Tx #1 and Tx #2 are each a transmission antenna with beam direction B1 (e.g., a transmission antenna forming transmission beam B1), and Tx #3 and Tx #4 are each a transmission antenna with beam direction B2 (e.g., a transmission antenna forming transmission beam B2).

In exemplary configuration 2 of the Doppler shift amounts, as illustrated in FIG. 14, the basic unit of the Doppler shift intervals in Doppler shifters 104 is set as Δfd=1/(Tr×(N_{DM}+δ))=1/(5Tr), and δ=1. However, the value of δ is not limited thereto, and may be a positive integer or a positive real number.

In the example illustrated in FIG. 14, the first to fourth Doppler shifters 104 (or Doppler shifters 104-1 to 104-4) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−3/(10Tr) to second transmission antenna Tx #2, second Doppler shifter 104, for example, applies phase rotation Φ₂(m)=−3π(m−1)/5 for each transmission period Tr of the chirp signal and outputs the chirp signal.

To apply Doppler shift amount DOP₃=−1/(10Tr) to third transmission antenna Tx #3, third Doppler shifter 104, for example, applies phase rotation Φ₃(m)=−π(m−1)/5 for each transmission period Tr of the chirp signal and outputs the chirp signal.

To apply Doppler shift amount DOP₄=3/(10Tr) to the fourth transmission antenna Tx #4, fourth Doppler shifter 104, for example, applies phase rotation Φ₄(m)=3π(m−1)/5 for each transmission period Tr of the chirp signal and outputs the chirp signal.

Hereinafter, Doppler shift amount intervals applied to Tx #n1 and Tx #n2 are denoted as the Doppler shift intervals “Δfd_{(n1, n2)}.”

In FIG. 14, the Doppler shift amount intervals (Doppler shift intervals) applied to transmission antennas Tx #1 to Tx #4 are Δfd_{(1, 2)}=Δfd, Δfd_{(2, 3)}=Δfd, Δfd_{(3, 4)}=2Δfd, and Δfd_{(4, 1)}=Δfd. Therefore, Doppler shift amount intervals applied to the respective transmission antennas (number thereof being Nt=4) in FIG. 14 are not all the same but include uneven intervals (e.g., Δfd_{(1, 2)}=Δfd_{(2, 3)}=Δfd_{(4, 1)}≠Δfd_{(3, 4)}), resulting in uneven interval Doppler multiplexing transmission (uneven interval DDM transmission).

Further, among the transmission antennas in FIG. 14, Doppler shift amount intervals between transmission antennas Tx #1 and Tx #2 with beam direction B1 are Δfd_{(1, 2)}=Δfd, and Δfd_{(2, 1)}=4Δfd. Therefore, Doppler shift amount intervals applied respectively to the transmission antennas (number thereof being N_{B1}=2) with beam direction B1 are not all the same but include uneven intervals (Δfd_{(1, 2)}≠Δfd_{(2, 1)}), resulting in uneven interval Doppler multiplexing transmission (uneven interval DDM transmission) by the transmission antennas with beam direction B1.

Further, among the transmission antennas in FIG. 14, Doppler shift amount intervals between the transmission antennas Tx #3 and Tx #4 with beam direction B2 is Δfd_{(3, 4)}=2Δfd, and Δfd_{(4, 3)}=3Δfd. Therefore, Doppler shift amount intervals applied respectively to transmission antennas (number thereof being N_{B2}=2) with beam direction B2 are not all the same but include uneven intervals (Δfd_{(3, 4)}≠Δfd_{(4, 3)}), resulting in uneven interval Doppler multiplexing transmission (uneven interval DDM transmission) by the transmission antennas with beam direction B2.

From the above, the example illustrated in FIG. 14 is an exemplary configuration of a pattern of Doppler shift amounts satisfying Condition 2.

Further, in FIG. 14, the Doppler shift amount intervals between the transmission antennas Tx #1 and Tx #2 with beam direction B1 are Δfd_{(1, 2)}=Δfd and Δfd_{(2, 1)}=4Δfd, the Doppler shift amount intervals between the transmission antennas Tx #3 and Tx #4 with beam direction B2 are Δfd_{(3, 4)}=2Δfd and Δfd_{(4, 3)}=3Δfd. Thus, the Doppler shift amounts between transmission antennas Tx #1 and Tx #2 with beam direction B1 and the Doppler shift amounts between transmission antennas Tx #3 and Tx #4 with beam direction B2 include different Doppler shift intervals.

For example, the maximum DDM Doppler shift amount interval between transmission antennas Tx #1 and Tx #2 with beam direction B1 is Δfd_{(2, 1)}=4Δfd, and the maximum DDM Doppler shift amount interval between transmission antenna Tx #3 and Tx #4 with beam direction B2 is Δfd_{(4, 3)}=3Δfd, and they are different from each other. Similarly, for example, the minimum DDM Doppler shift amount interval between transmission antennas Tx #1 and Tx #2 with beam direction B1 is Δfd_{(1, 2)}=Δfd, and the minimum DDM Doppler shift amount interval between transmission antenna Tx #3 and Tx #4 with beam direction B2 is Δfd_{(3, 4)}=2Δfd, and they are different from each other.

Thus, in the example illustrated in FIG. 14, Doppler multiplexing number N_{B1} by transmission antennas Tx #1 and Tx #2 with beam direction B1 is the same as Doppler multiplexing number N_{B2} by transmission antenna Tx #3 and Tx #4 with beam direction B2, and also the pattern (e.g., Doppler shift interval) of Doppler shift amounts assigned to transmission antennas Tx #1 and Tx #2 with beam direction B1 is different from the pattern of Doppler shift amounts assigned to transmission antenna Tx #3 and Tx #4 with beam direction B2.

From the above, the example illustrated in FIG. 14 is an exemplary configuration of a pattern of Doppler shift amounts satisfying item (1) of Condition 1.

The following describes an example of a reception signal at the output from Doppler analyzer 209, in which transmission antenna section 105 includes transmission antennas with beam directions B1 and B2, namely different beam directions, based on the Configuration for Doppler shift amounts illustrated in FIG. 14, and reception antenna section 202 is an omnidirectional antenna (or an antenna having substantially uniform directional characteristics within the viewing angle covered by both the transmission antenna with beam direction B1 and the transmission antenna beam direction B2).

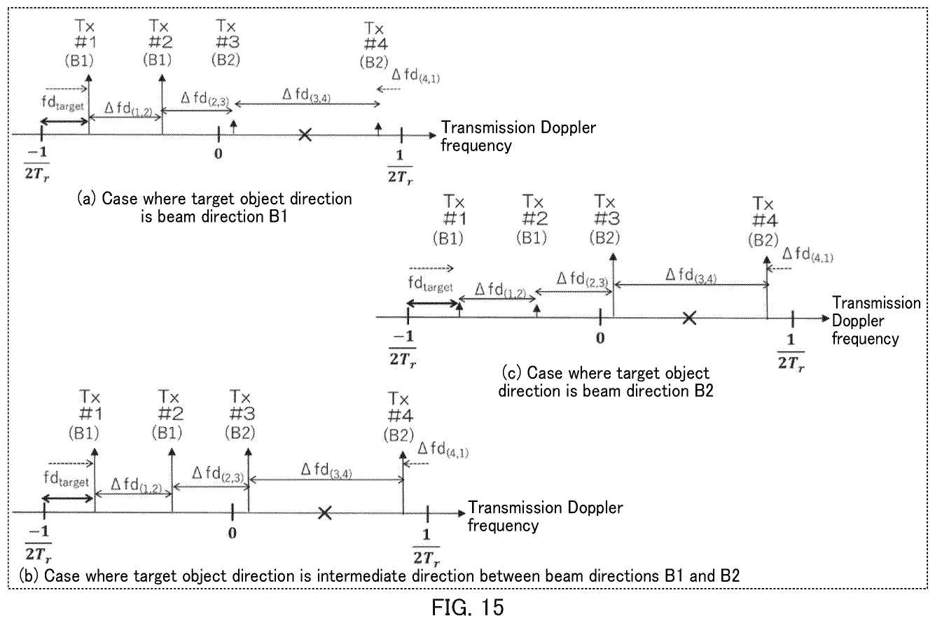

FIG. 15 shows an output example of Doppler analyzers 209 for target object reflected waves at certain distance indices. For example, the target object reflected waves include Doppler frequency fd_{target}. Therefore, as illustrated in FIG. 15, radar apparatus 10 receives a signal that has undergone a Doppler shift of fd_{target} from the Doppler shift amount illustrated in FIG. 14.

Further, in exemplary configuration 2, an exemplary multi-beam transmission MIMO radar (e.g., radar apparatus 10) forming transmission beams in beam direction B1 (Tx Beam #1) and beam direction B2 (Tx Beam #2) the same as in FIG. 13 will be described.

For example, when the target object direction is target object direction (1) illustrated in FIG. 13 (for example, when there is a target object in the periphery of beam direction B1), the radiation direction of the radar transmission waves transmitted from Tx #1 and Tx #2 with beam direction B1 coincides with the target object direction. Therefore, as illustrated at part (a) in FIG. 15, the reception levels of the reception signals of the reflected waves from the target object corresponding to Tx #1 and Tx #2 in radar apparatus 10 become relatively high. On the other hand, when the target object direction is target object direction (1) illustrated in FIG. 13, the radiation direction of the radar transmission waves transmitted from Tx #3 and Tx #4 with beam direction B2 does not coincide with the target object direction, and the target object direction corresponds to the null direction of transmission beam B2. Therefore, as illustrated at part (a) in FIG. 15, the reception levels of the reception signals of the reflected waves from the target object corresponding to Tx #3 and Tx #4 in radar apparatus 10 is lower than the reception levels of the reception signals corresponding to Tx #1 and Tx #2. For example, as illustrated at part (a) in FIG. 15, the reception levels of the reception signals corresponding to Tx #3 and Tx #4 may differ greatly from the reception levels of the reception signals corresponding to Tx #1 and Tx #2, and depending on the beam directional characteristic in the null direction of Tx #3 and Tx #4, the reception level may become, for example, 10 dB or more lower.

Further, for example, when the target object direction is an intermediate direction between beam direction B1 and beam direction B2, and the target object direction is in the direction of an overlapping area (for example, in the case of target object direction (2) illustrated in FIG. 13) where the beam widths of both beams (each of which is about 3 dB or 6 dB of the beam) overlap with each other, the reception levels of the reception signals corresponding to Tx #1 and Tx #2 with beam direction B1 are approximately the same as the reception levels of the reception signals corresponding to Tx #3 and Tx #4 with beam direction B2, as illustrated at part (b) in FIG. 15.

For example, when the target object direction is target object direction (3) illustrated in FIG. 13, the radiation direction of the radar transmission waves transmitted from Tx #3 and Tx #4 with beam direction B2 coincides with the target object direction. Therefore, as illustrated at part (c) in FIG. 15, the reception levels of the reception signals of the reflected waves from the target object corresponding to Tx #3 and Tx #4 in radar apparatus 10 become relatively high. On the other hand, when the target object direction is target object direction (3) illustrated in FIG. 13, the radiation direction of the radar transmission waves transmitted from Tx #1 and Tx #2 with beam direction B1 does not coincide with the target object direction, and the target object direction corresponds to the null direction of transmission beam B1. Therefore, as illustrated at part (c) in FIG. 15, the reception levels of the reception signals of the reflected waves from the target object corresponding to Tx #1 and Tx #2 in radar apparatus 10 is lower than the reception levels of the reception signals corresponding to Tx #3 and Tx #4. For example, as illustrated at part (a) in FIG. 15, the reception levels of the reception signals corresponding to Tx #1 and Tx #2 may differ greatly from the reception levels of the reception signals corresponding to Tx #3 and Tx #4, and depending on the beam directional characteristic in the null direction of Tx #1 and Tx #2, the reception level may become, for example, 10 dB or more lower.

For example, when the target object direction is an intermediate direction between beam direction B1 and beam direction B2 (target object direction (2) illustrated in FIG. 13) as illustrated at part (b) in FIG. 15, radar apparatus 10 receives the reception signals corresponding to the transmission antennas with the respective beam directions at approximately the same level of reception. Therefore, the signals transmitted from Nt transmission antennas including the transmission antennas with respective beam direction B1 and beam direction B2 are subjected to Doppler multiplexing transmission using Doppler shift intervals resulting in uneven interval Doppler multiplexing. Therefore, radar apparatus 10 can separate the Doppler multiplexed signals on the basis of the known separation operation of Doppler multiplexed signals.

In addition, when the target object direction is beam direction B1 as illustrated at part (a) in FIG. 15 (target object direction (1) illustrated in FIG. 13) and when the target object direction is beam direction B2 as illustrated at part (c) in FIG. 15 (target object direction (3) illustrated in FIG. 13), radar apparatus 10 receives different Doppler multiplexed signals (for example, Doppler multiplexed signals satisfying item (1) of Condition 1) depending on the target object direction. For example, radar apparatus 10 receives signals of two Doppler frequency components with Doppler shift interval Δfd_{(1, 2)} and Δfd_{(2, 1)} in the case of part (a) in FIG. 15 (the case of target object direction (1) illustrated in FIG. 13). On the other hand, for example, radar apparatus 10 receives signal of two Doppler frequency components with Doppler shift intervals Δfd_{(3, 4)} and Δfd_{(4, 3)} in the case of part (c) in FIG. 15 (the case of target object direction (3) illustrated in FIG. 13).

In this way, when the target object direction is beam direction B1 or B2, radar apparatus 10 receives reflected wave signals including Doppler frequency components with a varying pattern depending on a case where the reception level of the reception signal corresponding to the transmission antenna with beam direction B1 decreases or a case where the reception level of the reception signal corresponding to the transmission antenna with beam direction B2 decreases.

As a result, for example, radar apparatus 10 can determine whether a decrease in the reception level of the reception signal corresponding to the transmission antenna with beam direction B1 has occurred (for example, the state of part (c) in FIG. 15) or whether a decrease in the reception level of the reception signal corresponding to the transmission antenna with beam direction B2 has occurred (for example, the state of part (a) in FIG. 15), based on the detected peak of the Doppler frequency (for example, the intervals of peaks), in Doppler demultiplexer 211 described below.

Further, for example, Doppler multiplexed signals transmitted from transmission antennas Tx #1 and Tx #2 with beam direction B1 are subjected to Doppler multiplexing transmission using the Doppler shift intervals resulting in uneven interval Doppler multiplexing. Therefore, for example, when the reception signals have been determined to be corresponding to transmission antennas Tx #1 and Tx #2 with beam direction B1 from the discrimination result of Doppler demultiplexer 211, radar apparatus 10 can separate the Doppler multiplexed signals using the known separation operation of Doppler multiplexed signals.

Similarly, for example, Doppler multiplexed signals transmitted from transmission antennas Tx #3 and Tx #4 with beam direction B2 are subjected to Doppler multiplexing transmission using the Doppler shift intervals resulting in uneven interval Doppler multiplexing. Therefore, for example, when the reception signals have been determined to be corresponding to transmission antennas Tx #3 and Tx #4 with beam direction B2 from the discrimination result of Doppler demultiplexer 211, radar apparatus 10 can separate the Doppler multiplexed signals using the known separation operation of Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

Above, exemplary configuration 1 and exemplary configuration 2 of the Doppler shift amounts has been described. A different Doppler exemplary configuration will be described below.

### <Exemplary Configuration 3 of Doppler Shift Amount>

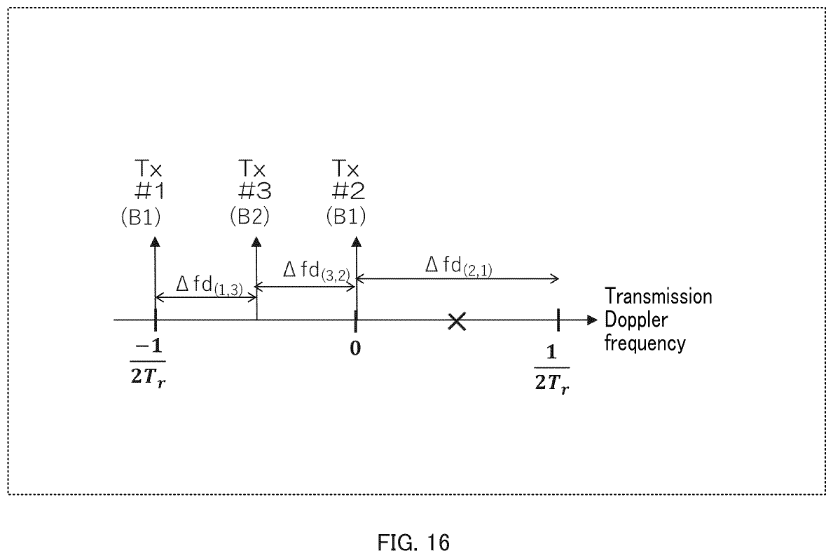

FIG. 16 shows an exemplary configuration of Doppler shift amounts for the transmission Doppler frequency in the case of the number of transmission antennas being Nt=3, N_{B1}=2, and N_{B2}=1. In FIG. 16, Tx #1 and Tx #2 are each a transmission antenna with beam direction B1 (e.g., a transmission antenna forming transmission beam B1), and Tx #3 is a transmission antenna with beam direction B2 (e.g., a transmission antenna forming transmission beam B2).

In exemplary configuration 3 of the Doppler shift amounts, as illustrated in FIG. 16, the basic unit of the Doppler shift intervals in Doppler shifters 104 is set as Δfd=1/(Tr×(N_{DM}+δ))=1/(4Tr), and δ=1. However, the value of δ is not limited thereto, and may be a positive integer or a positive real number.

In the example illustrated in FIG. 16, the first to third Doppler shifters 104 (or Doppler shifters 104-1 to 104-3) may perform the following operations.

To apply Doppler shift amount DOP₁=−1/(2Tr) to first transmission antenna Tx #1, first Doppler shifter 104, for example, applies phase rotation Φ₁(m)=2πDOP₁×(m−1) Tr=−π(m−1) for each transmission period Tr of the chirp signal and outputs the chirp signal.

To apply Doppler shift amount DOP₂=0 to second transmission antenna Tx #2, second Doppler shifter 104, for example, applies phase rotation Φ₂(m)=2πDOP₂×(m−1) Tr=0 for each transmission period Tr of the chirped signal and outputs the chirp signal.

To apply Doppler shift amount DOP₃=−1/(4Tr) to third transmission antenna Tx #3, third Doppler shifter 104, for example, applies phase rotation Φ₃(m)=2πDOP₃×(m−1) Tr=−π(m−1)/2 for each transmission period Tr of the chirped signal and outputs the chirp signal.

Hereinafter, Doppler shift amount intervals applied to Tx #n1 and Tx #n2 are denoted as the Doppler shift intervals “Δfd_{(n1, n2)}.”

In FIG. 16, the patterns of Doppler shift amount intervals (Doppler shift intervals) applied to transmission antennas Tx #1 to Tx #3 are respectively Δfd_{(1, 3)}=Δfd, Δfd_{(3, 2)}=Δfd and Δfd_{(2, 1)}=2Δfd. Therefore, Doppler shift amount intervals applied to the respective transmission antennas (number thereof being Nt=3) in FIG. 16 are not all the same but include uneven intervals (e.g., Δfd_{(1, 3)}=Δfd_{(3, 2)}≠Δfd_{(2, 1)}), resulting in uneven interval Doppler multiplexing transmission (uneven interval DDM transmission).

Further, among the transmission antennas in FIG. 16, Doppler shift amount intervals between transmission antennas Tx #1 and Tx #2 with beam direction B1 are Δfd_{(1, 2)}=2Δfd, and Δfd_{(2, 1)}=2Δfd. Therefore, Doppler shift amount intervals applied respectively to the transmission antennas (number thereof being N_{B1}=2) with beam direction B1 are all the same, resulting in even interval Doppler multiplexing transmission (even interval DDM transmission).

Further, in FIG. 16, the number N_{B2} of transmission antennas with beam direction B2 among the transmission antennas is 1, and therefore, the transmission antenna with beam direction B2 is not in a relationship that allows Doppler multiplexing transmission.

Further, FIG. 16 shows N_{B1} (=2) N_{B2} (=1). For example, the example illustrated in FIG. 16, the pattern of the Doppler shift amounts assigned to the transmission antennas with beam direction B1 differs from the pattern of the Doppler shift amounts assigned to the transmission antennas with beam direction B2.

Therefore, the example illustrated in FIG. 16 is an exemplary configuration of a pattern of Doppler shift amounts satisfying item (2) of Condition 1 but not satisfying Condition 2.

For example, when the target object direction is beam direction B1 (for example, in the case of target object direction (1) illustrated in FIG. 13) and when the target object direction is beam direction B2 (for example, in the case of target object direction (3) illustrated in FIG. 13), radar apparatus 10 receives different Doppler multiplexed signals (for example, Doppler multiplexed signals satisfying item (2) of Condition 1) depending on the target object direction in the same manner as in exemplary configuration 1. Therefore, radar apparatus 10 can determine whether a decrease in the reception level of the reception signal corresponding to the transmission antenna with beam direction B1 has occurred or whether a decrease in the reception level of the reception signal corresponding to the transmission antenna with beam direction B2 has occurred, based on the detected peak of the Doppler frequency (for example, the number of peaks), in Doppler demultiplexer 211 described below.

Further, for example, Doppler multiplexed signals transmitted from transmission antennas Tx #1 and Tx #2 with beam direction B1 do not satisfy Condition 2 and are subjected to Doppler multiplexing transmission using the Doppler shift intervals resulting in even interval Doppler multiplexing. Therefore, for example, when the reception signals are determined to be corresponding to transmission antennas with beam direction B1 from the discrimination result of Doppler demultiplexer 211, radar apparatus 10 can separate the Doppler multiplexed signals using the known separation operation of Doppler multiplexed signals. In this case, radar apparatus 10 can determine Doppler frequency fd of the target object within the range of −1/(4Tr)≤fd<1/(4Tr), and obtain an output in which each Doppler multiplexed signal is associated with its corresponding transmission antenna.

Further, for example, transmission antenna Tx #3 with beam direction B2 is one antenna transmission. Therefore, for example, when it is determined from the discrimination result of Doppler demultiplexer 211 that the reception signal is a reception signal corresponding to transmission antenna Tx #3 with beam direction B2, radar apparatus 10 does not have to perform the separation processing of the Doppler multiplexed signal for the reception signal in beam direction B2. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

### <Exemplary Configuration 4 of Doppler Shift Amount>

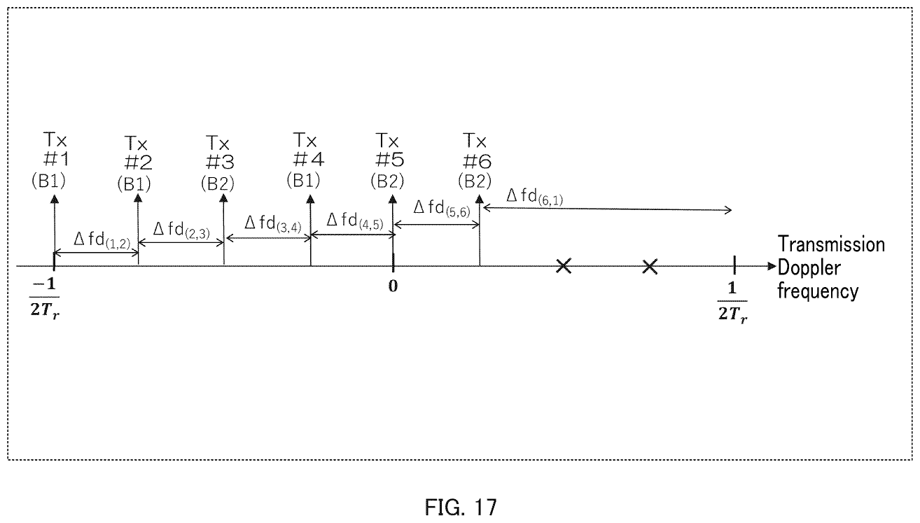

FIG. 17 shows an exemplary configuration of a pattern of Doppler shift amounts for the transmission Doppler frequency in the case of the number of transmission antennas being Nt=6, N_{B1}=3, and N_{B2}=3. In FIG. 17, Tx #1, Tx #2, and Tx #4 are each a transmission antenna with beam direction B1 (e.g., a transmission antenna forming transmission beam B1), and Tx #3, Tx #5, and Tx #6 are each a transmission antenna with beam direction B2 (e.g., a transmission antenna forming transmission beam B2).

In exemplary configuration 4 of the Doppler shift amounts, as illustrated in FIG. 17, the basic unit of the Doppler shift intervals in Doppler shifters 104 is set as Δfd=1/(Tr×(N_{DM}+δ))=1/(8Tr), and δ=2. However, the value of δ is not limited thereto, and may be a positive integer or a positive real number.

In the example illustrated in FIG. 17, the first to sixth Doppler shifters 104 (or Doppler shifters 104-1 to 104-6) may perform the following operations.

To apply Doppler shift amount DOP₁=−1/(2Tr) to first transmission antenna Tx #1, first Doppler shifter 104, for example, applies phase rotation Φ₁(m)=−π(m−1) for each transmission period Tr of the chirp signal and outputs the chirp signal.

To apply Doppler shift amount DOP₂=−3/(8Tr) to second transmission antenna Tx #2, second Doppler shifter 104, for example, applies phase rotation Φ₂(m)=−3π(m−1)/4 for each transmission period Tr of the chirp signal and outputs the chirp signal.

To apply Doppler shift amount DOP₃=−1/(4Tr) to third transmission antenna Tx #3, third Doppler shifter 104, for example, applies phase rotation Φ₃(m)=−π(m−1)/2 for each transmission period Tr of the chirp signal and outputs the chirp signal.

To apply Doppler shift amount DOP₄=−1/(8Tr) to fourth transmission antenna Tx #4, fourth Doppler shifter 104, for example, applies phase rotation Φ₄(m)=−π(m−1)/4 for each transmission period Tr of the chirp signal and outputs the chirp signal.

To apply Doppler shift amount DOP₅=0 to fifth transmission antenna Tx #5, fifth Doppler shifter 104, for example, applies phase rotation Φ₅(m)=0 for each transmission period Tr of the chirp signal and outputs the chirp signal.

To apply Doppler shift amount DOP₆=1/(8Tr) to sixth transmission antenna Tx #6, sixth Doppler shifter 104, for example, applies phase rotation Φ₆(m)=π(m−1)/4 for each transmission period Tr of the chirp signal and outputs the chirp signal.

Hereinafter, Doppler shift amount intervals applied to Tx #n1 and Tx #n2 are denoted as the Doppler shift intervals “Δfd_{(n1, n2)}.”

In FIG. 17, the Doppler shift amount intervals (Doppler shift intervals) applied to transmission antennas Tx #1 to Tx #6 are Δfd_{(1, 2)}=Δfd_{(2, 3)}=Δfd_{(3, 4)}=Δfd_{(4, 5)}=Δfd_{(5, 6)}=Δfd, and Δfd_{(6, 1)}=3Δfd. Therefore, in FIG. 17, the intervals of the Doppler shift amounts applied to transmission antennas (number thereof being Nt=6) are not all the same but include uneven intervals (for example, Δfd_{(1, 2)}=Δfd_{(2, 3)}=Δfd_{(3, 4)}=Δfd_{(4, 5)}=Δfd_{(5, 6)}≠Δfd_{(6, 1)}), resulting in uneven interval Doppler multiplexing transmission (uneven interval DDM transmission).

Further, in FIG. 17, among the transmission antennas, the Doppler shift amount intervals between transmission antennas Tx #1, Tx #2 and Tx #4 with beam direction B1 are Δfd_{(1, 2)}=Δfd, Δfd_{(2, 4)}=2Δfd, Δfd_{(4, 1)}=5Δfd. Therefore, Doppler shift amount intervals applied respectively to the transmission antennas (number thereof being N_{B1}=3) with beam direction B1 are not all the same but include uneven intervals (Δfd_{(1, 2)}≠Δfd_{(2, 4)}=Δfd_{(4, 1)}), resulting in uneven interval Doppler multiplexing transmission (uneven interval DDM transmission) by the transmission antennas with beam direction B1.

Further, in FIG. 17, among the transmission antennas, the Doppler shift amount intervals between transmission antenna Tx #3, Tx #5 and Tx #6 with beam direction B2 are Δfd_{(3, s)}=2Δfd, Δfd_{(5, 6)}=Δfd, and Δfd_{(6, 3)}=5Δfd. Therefore, Doppler shift amount intervals applied respectively to the transmission antennas (number thereof being N_{B2}=3) with beam direction B2 are not all the same but include uneven intervals (Δfd_{(3, 5)}≠Δfd_{(5, 6)} Δfd_{(6, 3)}), resulting in uneven interval Doppler multiplexing transmission (uneven interval DDM transmission) by the transmission antennas with beam direction B2.

From the above, the example illustrated in FIG. 17 is an exemplary configuration of a pattern of Doppler shift amounts satisfying Condition 2.

Further, in FIG. 17, the Doppler shift amounts between transmission antennas Tx #1, Tx #2 and Tx #4 with beam direction B1 are Δfd_{(1, 2)}=Δfd, Δfd_{(2, 4)}=2Δfd, and Δfd_{(4, 1)}=5Δfd, the Doppler shift amounts between the transmission antennas Tx #3, Tx #5 and Tx #6 with beam direction B2 are Δfd_{(3, 5)}=2Δfd, Δfd_{(5, 6)}=Δfd, and Δfd_{(6, 3)}=5Δfd. Thus, in FIG. 17, Doppler multiplexing number N_{B1} by transmission antennas Tx #1, Tx #2 and Tx #4 with beam direction B1 is the same as Doppler multiplexing number N_{B2} by transmission antennas Tx #3, Tx #5 and Tx #6 with beam direction B2. Further, in FIG. 17, the Doppler shift amounts between transmission antennas Tx #1, Tx #2, and Tx #4 in beam direction B1, and the Doppler shift amounts between transmission antennas Tx #3, Tx #5, and Tx #6 with beam direction B2 include combinations of the same Doppler shift intervals, but the order of the Doppler shift intervals between beam direction B1 and beam direction B2 on the Doppler frequency axis is different.

For example, in FIG. 17, the order of intervals of the Doppler shift amounts assigned to transmission antennas Tx #1, Tx #2, and Tx #4 with beam direction B1 is in the order of Δfd, 2Δfd, and 5Δfd. Further, in FIG. 17, the order of intervals of the Doppler shift amounts assigned to transmission antennas Tx #3, Tx #5 and Tx #6 with beam direction B2 is in the order of 2Δfd, Δfd, and 5Δfd. Thus, in FIG. 17, the same combinations of Doppler shift intervals (e.g., Δfd, 2Δfd, 5Δfd) are included for transmission antennas with beam direction B1 and transmission antennas with beam direction B2, but the order of the intervals differs between the beam directions. For example, in FIG. 17, even when the Doppler shift intervals between the transmission antennas with beam direction B1 or the Doppler shift intervals between the transmission antennas with beam direction B2 is cyclically shifted on the Doppler frequency axis, the Doppler shift amounts do not match between different beam directions.

Thus, in the example illustrated in FIG. 17, the pattern of the Doppler shift amounts assigned to the transmission antennas Tx #1, Tx #2 and Tx #4 with beam direction B1, and the pattern of the Doppler shift amount assigned to transmission antennas Tx #3, Tx #5 and Tx #6 with beam direction B2 are different from each other.

From the above, the example illustrated in FIG. 17 is an exemplary configuration of a pattern of Doppler shift amounts satisfying item (3) of Condition 1.

The following describes an example of a reception signal at the output from Doppler analyzer 209, in which transmission antenna section 105 includes transmission antennas with beam directions B1 and B2, namely different beam directions, based on the Configuration for Doppler shift amounts illustrated in FIG. 17, and reception antenna section 202 is an omnidirectional antenna (or an antenna having substantially uniform directional characteristics within the viewing angle covered by both the transmission antenna with beam direction B1 and the transmission antenna beam direction B2).

Further, in exemplary configuration 4, an exemplary multi-beam transmission MIMO radar (e.g., radar apparatus 10) forming transmission beams in beam direction B1 (Tx Beam #1) and beam direction B2 (Tx Beam #2) the same as in FIG. 13 will be described.

For example, when the target object direction is target object direction (1) illustrated in FIG. 13 (for example, when there is a target object in the periphery of beam direction B1), the radiation direction of the radar transmission waves transmitted from Tx #1, Tx #2, and Tx #4 with beam direction B1 coincides with the target object direction. Therefore, the reception levels of the reception signals of the reflected waves from the target object corresponding to Tx #1, Tx #2, and Tx #4 in radar apparatus 10 become relatively high. On the other hand, when the target object direction is target object direction (1) illustrated in FIG. 13, the radiation direction of the radar transmission waves transmitted from Tx #3, Tx #5, and Tx #6 with beam direction B2 does not coincide with the target object direction, and the target object direction corresponds to the null direction of transmission beam B2. Therefore, the reception levels of the reception signals of the reflected waves from the target object corresponding to Tx #3, Tx #5, and Tx #6 in radar apparatus 10 is lower than the reception levels of the reception signals corresponding to Tx #1, Tx #2, and Tx #4. For example, the reception levels of the reception signals corresponding to Tx #3, Tx #5, and Tx #6 may differ greatly from the reception levels of the reception signals corresponding to Tx #1, Tx #2, and Tx #4, and depending on the beam directional characteristic in the null direction of Tx #3, Tx #5, and Tx #6, the reception level may become, for example, 10 dB or more lower.

In addition, for example, when the target object direction is target object direction (3) illustrated in FIG. 13 (for example, when there is a target object in the periphery of beam direction B2), the radiation direction of the radar transmission waves transmitted from Tx #3, Tx #5, and Tx #6 with beam direction B2 coincides with the target object direction. Therefore, the reception levels of the reception signals of the reflected waves from the target object corresponding to Tx #3, Tx #5, and Tx #6 in radar apparatus 10 become relatively high. On the other hand, when the target object direction is target object direction (3) illustrated in FIG. 13, the radiation direction of the radar transmission waves transmitted from Tx #1, Tx #2, and Tx #4 with beam direction B1 does not coincide with the target object direction, and the target object direction corresponds to the null direction of transmission beam B1. Therefore, the reception levels of the reception signals of the reflected waves from the target object corresponding to Tx #1, Tx #2, and Tx #4 in radar apparatus 10 is lower than the reception levels of the reception signals corresponding to Tx #3, Tx #5, and Tx #6. For example, the reception levels of the reception signals corresponding to Tx #1, Tx #2, and Tx #4 may differ greatly from the reception levels of the reception signals corresponding to Tx #3, Tx #5, and Tx #6, and depending on the beam directional characteristic in the null direction of Tx #1, Tx #2, and Tx #4, the reception level may become, for example, 10 dB or more lower.

Thus, when the target object direction is beam direction B1 (target object direction (1) illustrated in FIG. 13) and when the target object direction is beam direction B2 (target object direction (3) illustrated in FIG. 13), radar apparatus 10 receives different Doppler multiplexed signals (for example, Doppler multiplexed signals satisfying item (3) of Condition 1) depending on the target object direction. Therefore, when the target object direction is beam direction B1 or B2, radar apparatus 10 receives reflected wave signals including Doppler frequency components with a varying pattern depending on a case where the reception level of the reception signal corresponding to the transmission antenna with beam direction B1 decreases or a case where the reception level of the reception signal corresponding to the transmission antenna with beam direction B2 decreases.

As a result, for example, radar apparatus 10 can determine whether a decrease in the reception level of the reception signal corresponding to the transmission antenna with beam direction B1 has occurred or whether a decrease in the reception level of the reception signal corresponding to the transmission antenna with beam direction B2 has occurred, based on the detected peak of the Doppler frequency (for example, the order of the intervals between peaks), in Doppler demultiplexer 211 described below.

Further, for example, Doppler multiplexed signals transmitted from transmission antennas Tx #1, Tx #2, and Tx #4 with beam direction B1 are subjected to Doppler multiplexing transmission using the Doppler shift intervals resulting in uneven interval Doppler multiplexing. Therefore, for example, when the reception signals have been determined to be corresponding to transmission antennas Tx #1, Tx #2, and Tx #4 with beam direction B1 from the discrimination result of Doppler demultiplexer 211, radar apparatus 10 can separate the Doppler multiplexed signals using the known separation operation of Doppler multiplexed signals.

Similarly, for example, Doppler multiplexed signals transmitted from transmission antennas Tx #3, Tx #5 and Tx #6 with beam direction B2 are subjected to Doppler multiplexing transmission using the Doppler shift intervals resulting in uneven interval Doppler multiplexing. Therefore, for example, when the reception signals have been determined to be corresponding to transmission antennas Tx #3, Tx #5 and Tx #6 with beam direction B2 from the discrimination result of Doppler demultiplexer 211, radar apparatus 10 can separate the Doppler multiplexed signals using the known separation operation of Doppler multiplexed signals.

On the other hand, for example, when the target object direction is an intermediate direction between beam direction B1 and beam direction B2, and the target object direction is in the direction of an overlapping area (for example, in the case of target object direction (2) illustrated in FIG. 13) where the beam widths of both beams (each of which is about 3 dB or 6 dB of the beam) overlap with each other, the reception levels of the reception signals corresponding to Tx #1, Tx #2 and Tx #4 with beam direction B1 are approximately the same as the reception levels of the reception signals corresponding to Tx #3, Tx #5 and Tx #6 with beam direction B2. Therefore, when the target object direction is an intermediate direction between beam direction B1 and beam direction B2 (target object direction (2) illustrated in FIG. 13), radar apparatus 10 receives the reception signals corresponding to the transmission antennas with the respective beam directions at approximately the same level of reception. Therefore, the signals transmitted from Nt transmission antennas including the transmission antennas with respective beam direction B1 and beam direction B2 are subjected to Doppler multiplexing transmission using Doppler shift intervals resulting in uneven interval Doppler multiplexing. Therefore, radar apparatus 10 can separate the Doppler multiplexed signals on the basis of the known separation operation of Doppler multiplexed signals.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

The exemplary configuration for Doppler shift amounts has been described above.

It should be noted that the configuration for Doppler shift amounts is not limited to exemplary configurations 1 to 4 described above. For example, at least one of number Nt of transmission antennas (or, Doppler multiplexing number), number N_{B1} of transmission antennas with beam direction B1, number N_{B2} of transmission antennas with beam direction B2, and the Doppler shift intervals may be other values.

Further, in Doppler shifters 104, phase rotations Φₙ(m) that apply Doppler shift amounts DOPₙ to radar transmission signals transmitted from Nt transmission antennas may be represented as follows in Expression 4:

$$\begin{matrix}[ 4 ] & \\ {ϕ}_{n} ( m ) = ( 2 π {T}_{r} \times {DOP}_{n} + {Δϕ}_{0} ) ( m - 1 ) + {ϕ}_{0} . & ( Expression 4 )\end{matrix}$$

Here, Φ₀ is the initial phase, and ΔΦ₀ is the reference Doppler shift phase.

For example, when Doppler multiplexing transmission is performed using transmission antennas (number thereof being Nt=3), first Doppler shifter 104 applies phase rotation (1(m) to the radar transmission signal (for example, a chirp signal) input from radar transmission signal generator 101 for each transmission period Tr, as shown in following Expression 5. The output of first Doppler shifter 104 is, for example, output from the first transmission antenna (Tx #1). Here, cp(t) denotes the chirp signal for each transmission period.

$$\begin{matrix}[ 5 ] & \\ exp \{ j {ϕ}_{1} ( 1 ) \} cp ( t ) , exp \{ j {ϕ}_{1} ( 2 ) \} cp ( t ) , ... , exp \{ j {ϕ}_{1} ( {N}_{c} ) \} cp ( t ) & ( Expression 5 )\end{matrix}$$

For example, second Doppler shifter 104 applies phase rotation Φ₂(m) to the radar transmission signal (for example, a chirp signal) input from radar transmission signal generator 101 for each transmission period Tr as shown in following Expression 6. The output of second Doppler shifter 104 is, for example, output from the second transmission antenna (Tx #2).

$$\begin{matrix}[ 6 ] & \\ exp \{ j {ϕ}_{2} ( 1 ) \} cp ( t ) , exp \{ j {ϕ}_{2} ( 2 ) \} cp ( t ) , ... , exp \{ j {ϕ}_{2} ( {N}_{c} ) \} cp ( t ) & ( Expression 6 )\end{matrix}$$

Similarly, for example, third Doppler shifter 104 applies phase rotation Φ₃(m) to the radar transmission signal (for example, a chirp signal) input from radar transmission signal generator 101 for each transmission period Tr as shown in following Expression 7. The output of third Doppler shifter 104 is, for example, output from the third transmission antenna (Tx #3).

$$\begin{matrix}[ 7 ] & \\ exp \{ j {ϕ}_{3} ( 1 ) \} cp ( t ) , exp \{ j {ϕ}_{3} ( 2 ) \} cp ( t ) , ... , exp \{ j {ϕ}_{3} ( {N}_{c} ) \} cp ( t ) & ( Expression 7 )\end{matrix}$$

The exemplary configuration for Doppler shift amounts has been described above.

Next, the exemplary operations of CFAR section 210 and Doppler demultiplexer 211 corresponding to the operation of aforementioned Doppler shifters 104 will be described.

### [Exemplary Operation of CFAR Section 210]

For example, CFAR section 210 may perform following exemplary operation 1 or exemplary operation 2 to receive the reflected wave signals for the radar transmission signals from radar transmitter 100.

The following describes an exemplary operation of CFAR section 210 in the case where a plurality of reception antennas of reception antenna section 202 each are an omnidirectional antenna (or antennas having substantially uniform directional characteristics within the viewing angle covered by transmission antennas with the plurality of different beam directions).

<Exemplary Operation 1 of CFAR section 210>

In exemplary operation 1, an exemplary operation of CFAR section 210 is described when the value of δ shown in Expression 3 is set to a positive integer in Doppler shifter 104.

In this case, the interval of Δfd or an integer multiple of the interval of Δfd is used for the Doppler shift amount intervals assigned to the Doppler multiplexed signals. Therefore, each of the Doppler-multiplexed signals can be detected as if it aliases at the intervals of Δfd in the outputs of Doppler analyzers 209 in the Doppler frequency domain. By using such characteristics, for example, the operation of CFAR section 210 can be simplified as follows.

For example, CFAR section 210 detects a Doppler peak by using a threshold to a power addition value obtained by adding together the reception powers of the reflected wave signals for respective ranges (for example, ranges of Δfd(q)) within the Doppler frequency range of the outputs of Doppler analyzers 209 subjected to the CFAR processing, the ranges serving as units of the intervals of the Doppler shift amounts applied respectively to the radar transmission signals.

For example, CFAR section 210 performs the CFAR processing on the outputs from Doppler analyzers 209 of first to Nath signal processors 206 by calculating power addition value PowerDDM(f_{b}, f_{sddm}) obtained by adding power values PowerqFT(f_{b}, fₛ), which is given by Expression 9, at the intervals of Δfd (for example, corresponding to N_{Δfd}) as shown in following Expression 8:

$$\begin{matrix}[ 8 ] & \\ PowerDDM ( {f}_{b} , {f}_{sddm} ) = {\sum }_{ndm = 1}^{{N}_{DM} + δ} PowerFT ( {f}_{b} , {f}_{sddm} + ( ndm - 1 ) \times {N}_{Δ {f}_{d} ( q )} ) & ( Expression 8 )\end{matrix}$$

$$\begin{matrix}[ 9 ] & \\ PowerFT ( {f}_{b} , {f}_{s} ) = {\sum }_{z = 1}^{{N}_{a}} {\vert {VFT}_{z} ( {f}_{b} , {f}_{s} ) \vert}^{2} & ( Expression 9 )\end{matrix}$$

Here, f_{sddm}=−N_{c}/2, . . . , −N_{c}/2+N_{Δfd}−1, where N_{Δfd} represents the number of Doppler frequency indices included in the interval of Δfd, and N_{Δfd}=round(Δfd/(1/(TᵣN_{c})). In addition, round(x) is an operator that rounds off real number x and outputs an integer value.

The operation in the CFAR processing may be based on the operation disclosed in NPL 2, for example, and detailed explanation of the exemplary operation is omitted.

Thus, since the Doppler frequency range subject to CFAR processing in CFAR section 210 can be narrowed from the full range of Doppler frequency index range fₛ (for example, the range of −N_{c}/2 to N_{c}/2−1) to the range of Δfd, the amount of computation for CFAR processing can be reduced to 1/(Nt+δ)=1/(N_{DM}+δ).

Then, CFAR section 210, for example, adaptively sets a threshold and outputs, to Doppler demultiplexer 211, distance index f_{b_cfar}, Doppler frequency index f_{sddm_cfar}, and reception power information (PowerFT(f_{b_cfar}, f_{sddm_cfar}+(ndm−1)×N_{Δfd})) that provide reception power greater than the threshold. Here, ndm is an integer from 1 to N_{DM}+δ.

### <Exemplary Operation 2 of CFAR Section 210>

In Exemplary Operation 2, an exemplary operation of CFAR section 210 in a case where the value of δ shown in Expression 3 is set to a real number that is not a positive integer in Doppler shifters 104 is described.

CFAR section 210 may, for example, calculate the power addition value of Expression 9 based on the outputs of Doppler analyzers 209 of first to Nath signal processors 206, and detect power peaks that match the Doppler shift intervals configured for a transmission signal for each distance index through adaptive threshold processing (CFAR processing).

Then, CFAR section 210, for example, adaptively sets a threshold and outputs, to Doppler demultiplexer 211, distance index f_{b_cfar}, Doppler frequency index f_{s_cfar}(ndm) at the power peak that matches the Doppler shift interval set for the radar transmission signal, and reception power information PowerFT(f_{b_cfar}, f_{s_cfar}(ndm)) of Doppler frequency index f_{s_cfar}(ndm) that provide reception power greater than the threshold. Here, ndm is an integer from 1 to N_{DM}+δ.

The exemplary operations of CFAR section 210 have been described above.

By way of example, below-described exemplary operations of Doppler demultiplexer 211 are described later in relation to a case where the output from Exemplary Operation 1 of CFAR section 210 is used, but the present disclosure is not limited to this, and the output from Exemplary Operation 2 of CFAR section 210 may also be used. When using the output from Exemplary Operation 2 of CFAR section 210, the difference is that Doppler frequency index f_{s_cfar}(ndm) is output instead of Doppler frequency index f_{sddm_cfar}+(ndm−1)×N_{Δfd} from Exemplary Operation 1 of CFAR section 210, but the other operations are similar and the same effects can be obtained.

### [Exemplary Operation of Doppler Demultiplexer 211]

Doppler demultiplexer 211 performs the following operations based on distance index f_{b_cfar}, Doppler frequency index f_{sddm_cfar}, and reception power information (PowerFT(f_{b_cfar}, f_{sddm_cfar}+(ndm−1)×N_{Δfd})) input from CFAR section 210, for example, when the value of δ shown in Expression 3 is set to a positive integer in Doppler shifters 104. Note that ndm is an integer from 1 to N_{DM}+δ.

The following describes an exemplary operation of Doppler demultiplexer 211 in the case where a plurality of reception antennas of reception antenna section 202 each are an omnidirectional antenna (or an antenna having substantially uniform directional characteristics within the viewing angle covered by transmission antennas with beam directions B1 and B2). An exemplary operation of Doppler demultiplexer 211 in the case where a plurality of reception antennas of reception antenna section 202 include reception antennas with different beam directions will be described below.

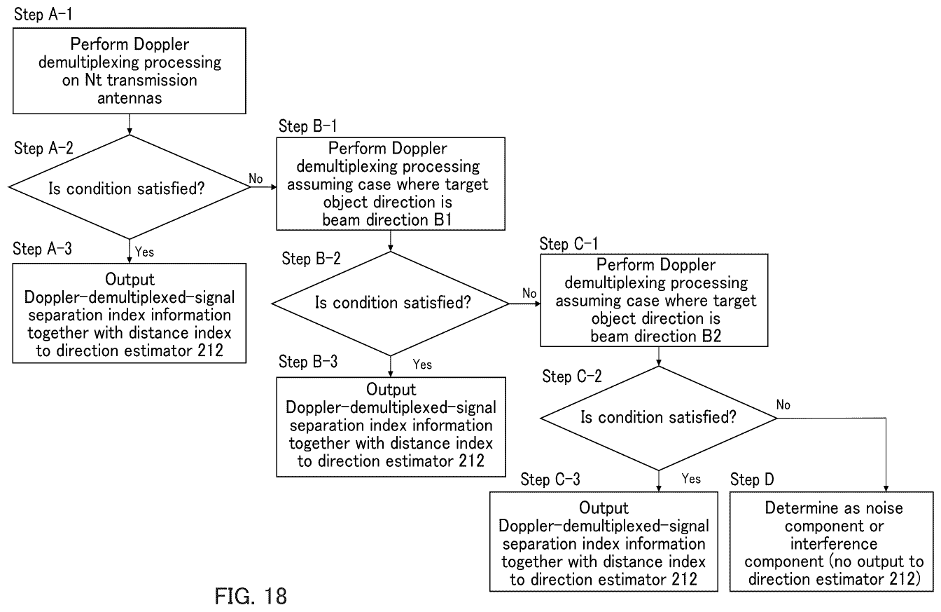

FIG. 18 is a flowchart showing an example of the separation operation of Doppler multiplexed signals in Doppler demultiplexer 211. It is assumed hereinafter that the Doppler velocity of the target object is within the range of −1/(2Tr)≤fd<1/(2Tr).

### <Step A-1>

Doppler demultiplexer 211 performs Doppler demultiplexing processing on Nt (=N_{DM}) Doppler multiplexed signals.

### <Step A-2>

In this case, for example, it is assumed that the N_{DM}+δ Doppler frequency indices (f_{sddm_cfar}+(ndm−1)×N_{Δfd}) for distance index f_{b_cfar} input from CFAR section 210 include N_{DM} Doppler multiplexed signals at uneven intervals.

Doppler demultiplexer 211, for example, compares the reception power (PowerFT(f_{b_cfar}, f_{sddm_cfar}+(ndm−1)×N_{Δfd})) for Doppler frequency indices (f_{sddm_cfar}+(ndm−1)×N_{Δfd}) (for example, where ndm is an integer from 1 to N_{DM}+δ), and determines whether the top N_{DM} Doppler frequency indices (f_{sddm_cfar}+(ndm−1)×N_{Δfd}) in terms of reception power match the Doppler shift intervals applied at the time of transmission (for example, this may be referred to as “N_{DM} Doppler shift interval matching determination”).

Further, Doppler demultiplexer 211, for example, determines whether there is a significant difference (or reception level ratio) between the reception levels of the top N_{DM} Doppler frequency indices in terms of reception power and the reception levels of other δ Doppler frequency indices different from the top N_{DM} Doppler frequency indices in terms of reception power (for example, whether the difference exceeds a threshold, or whether the ratio of reception levels exceeds a threshold) (referred to, for example, as “N_{DM} Doppler multiplexed signal reception level difference determination”).

Based on these determinations, Doppler demultiplexer 211, for example, decides the Doppler frequency and the transmission antenna corresponding to the Doppler multiplexed signals within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

For example, Doppler demultiplexer 211 determines whether conditions of both the N_{DM} Doppler shift interval matching determination and the N_{DM} Doppler multiplexed signal reception level difference determination (for example, the conditions of step A-2) are satisfied. For example, in the N_{DM} Doppler shift interval matching determination, when the top N_{DM} Doppler frequency indices (f_{sddm_cfar}+(ndm−1)×N_{Δfd}) of reception power are determined to match the Doppler shift intervals applied at transmission, and when in the N_{DM} Doppler multiplexed signal reception level difference determination, the reception level difference is determined to be equal to or greater than the threshold, the conditions of step A-2 are satisfied.

When the step A-2 condition is satisfied, Doppler demultiplexer 211 performs the step A-3 process, and when the step A-2 condition is not satisfied, the process of the step B-1 may be performed on the assumption that the target object direction is beam direction B1.

### <Step A-3>

For example, based on the relationship between the δ Doppler frequency indices for low reception levels among the Doppler frequency indices (f_{sddm_cfar}+(ndm−1)×N_{Δfd}) and the top N_{DM} Doppler frequency indices for high reception power, Doppler demultiplexer 211 associates Doppler shift amounts DOP₁, DOP₂, . . . , DOP_{N}t of the Nt transmitted Doppler multiplexed signals with the Doppler frequency indices, and outputs them as Doppler-multiplexed-signal separation index information DDM_RXindex(f_{b_cfar})−(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 outputs, for example, the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex(f_{b_cfar}). In this case, direction estimator 212 can perform a similar operation by generating Doppler-multiplexed-signal separation index information DDM_RXindex(f_{b_cfar}) based on the Doppler frequency of the target object input from Doppler demultiplexer 211 and the Doppler shift amounts applied to transmission antennas in Doppler shifters 104 of radar transmitter 100.

### <Step B-1>

Doppler demultiplexer 211 performs Doppler demultiplexing processing on N_{B1} Doppler multiplexed signals, assuming the case where the target object direction is beam direction B1.

### <Step B-2>

In this case, it is assumed that N_{B1} Doppler multiplexed signals from transmission antennas with beam direction B1 are included in the N_{DM}+δ Doppler frequency indices (f_{sddm_cfar}+(ndm−1)×N_{Δfd}) for distance index f_{b_cfar} input from CFAR section 210.

Doppler demultiplexer 211, for example, compares the reception power (PowerFT(f_{b_cfar}, f_{sddm_cfar}+(ndm−1)×N_{Δfd})) (for example, integers from ndm=1 to N_{DM}+δ) for the Doppler frequency indices (f_{sddm_cfar}+(ndm−1)×N_{Δfd}), to determine whether the top N_{B1} Doppler frequency indices f_{sddm_cfar}+(ndm−1)×N_{Δfd}) match the Doppler shift intervals applied to the transmission antennas with beam direction B1 at the time of transmission (for example, called “beam direction B1 Doppler shift interval matching determination”).

Further, Doppler demultiplexer 211, for example, determines whether there is a significant difference (or reception level ratio) between the reception levels of the top N_{B1} Doppler frequency indices of reception power and of other Doppler frequency indices (N_{DM}+δ−N_{B1}) that are different from the top N_{B1} Doppler frequency indices (for example, whether the difference exceeds a threshold, or the reception level ratio exceeds a threshold) (for example, called “beam direction B1 Doppler multiplexed signal reception level difference determination”).

Doppler demultiplexer 211, for example, determines the Doppler frequency and transmission antenna corresponding to the Doppler multiplexed signals within the range of −1/(2Tr)≤fd<1/(2Tr) based on these determinations.

Note that since the exemplary operation of Doppler demultiplexer 211, which separates Doppler multiplexed signals at uneven intervals, is disclosed in PTL 7, for example, the detailed description of its operation is omitted here.

For example, Doppler demultiplexer 211 determines whether conditions of both the beam direction B1 Doppler shift interval matching determination and the beam direction B1 Doppler multiplexed signal reception level difference determination (for example, the conditions of Step B-2) are satisfied. For example, in the beam direction B1 Doppler shift interval matching determination, when the top N_{B1} Doppler frequency indices (f_{sddm_cfar}+(ndm−1)×N_{Δfd}) of reception power are determined to match the Doppler shift intervals applied to transmission antennas with beam direction B1 during transmission, and when in the beam direction B1 Doppler multiplexed signal reception level difference determination, the reception level difference is determined to be equal to or greater than the threshold, the conditions of Step B-2 are satisfied.

When the conditions of Step B-2 are satisfied, Doppler demultiplexer 211 may proceed with the process of Step B-3; whereas when the conditions of Step B-2 are not satisfied, Doppler demultiplexer 211 may proceed with the process of Step C-1, assuming the case where the target object direction is beam direction B2.

Note that, when N_{B1}=1, the beam direction B1 Doppler shift interval matching determination process does not have to be performed.

### <Step B-3>

For example, based on the relationship between the N_{DM}+δ−N_{B1} Doppler frequency indices for low reception levels among the Doppler frequency indices (f_{sddm_cfar}+(ndm−1)×N_{Δfd}) and the top N_{B1} Doppler frequency indices for high reception power, Doppler demultiplexer 211 associates Doppler shift amounts DOP₁, DOP₂, . . . , DOP_{N}t of the Nt transmitted Doppler multiplexed signals with the Doppler frequency indices, and outputs them as Doppler-multiplexed-signal separation index information DDM_RXindex__{B1}(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 output, for example, the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex__{B1}(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex__{B1}(f_{b_cfar}). In this case, direction estimator 212 can perform a similar operation by generating Doppler-multiplexed-signal separation index information DDM_RXindex_B1(f_{b_cfar}) based on the Doppler frequency of the target object input from Doppler demultiplexer 211 and the Doppler shift amounts applied to transmission antennas in Doppler shifters 104 of radar transmitter 100.

Alternatively, Doppler demultiplexer 211 may associate the Doppler shift amounts of the Doppler multiplexed signals from N_{B1} transmission antennas with direction B1 (among the Nt transmission antennas) with the Doppler frequency indices, and output the beam direction B1 separation index information of the Doppler multiplexed signals as DDM_Rxindex__{B1}(f_{b_cfar}) along with distance indices f_{b_cfar} to direction estimator 212.

### <Step C-1>

Assuming the case where the target object direction is beam direction B2, Doppler demultiplexer 211 performs Doppler demultiplexing processing for N_{B2} Doppler multiplexed signals.

### <Step C-2>

In this case, for example, it is assumed that the N_{DM}+δ Doppler frequency indices (f_{sddm_cfar}+(ndm−1)×N_{Δfd}) for distance index f_{b_cfar} input from CFAR section 210 include N_{B2} Doppler multiplexed signals from the transmission antennas with beam direction B2.

Doppler demultiplexer 211, for example, compares the reception power (PowerFT(f_{b_cfar}, f_{sddm_cfar}+(ndm−1)×N_{Δfd})) (for example, integers from ndm=1 to N_{DM}+δ) for the Doppler frequency indices (f_{sddm_cfar}+(ndm−1)×N_{Δfd}), to determine whether the top N_{B2} Doppler frequency indices f_{sddm_cfar}+(ndm−1)×N_{Δfd}) of reception power match the Doppler shift intervals applied to the transmission antenna with beam direction B2 at the time of transmission (for example, called “beam direction B2 Doppler shift interval matching determination”).

Further, Doppler demultiplexer 211, for example, determines whether there is a significant difference (or reception level ratio) between the reception levels of the top N_{B2} Doppler frequency indices of reception power and of other Doppler frequency indices (N_{DM}+δ−N_{B2}) that are different from the top N_{B2} Doppler frequency indices (for example, whether the difference exceeds a threshold, or the reception level ratio exceeds a threshold) (for example, called “beam direction B2 Doppler multiplexed signal reception level difference determination”).

Based on these determinations, Doppler demultiplexer 211, for example, decides the Doppler frequency and the transmission antenna within the range of −1/(2Tr)≤fd<1/(2Tr).

Note that the exemplary operation of Doppler demultiplexer 211 for separating Doppler multiplexed signals at uneven intervals is disclosed in PTL 7, for example, so the detailed description of its operation is omitted here.

For example, Doppler demultiplexer 211 determines whether conditions of both the beam direction B2 Doppler shift interval matching determination and the beam direction B2 Doppler multiplexed signal reception level difference determination (for example, the conditions of Step C-2) are satisfied. For example, in the beam direction B2 Doppler shift interval matching determination, when the top N_{B2} Doppler frequency indices (f_{sddm_cfar}+(ndm−1)×N_{Δfd}) of reception power are determined to match the Doppler shift intervals applied to transmission antennas with beam direction B2 during transmission, and when in the beam direction B2 Doppler multiplexed signal reception level difference determination, the reception level difference is determined to be equal to or greater than the threshold, the conditions of Step C-2 are satisfied.

When the conditions of Step C-2 are satisfied, Doppler demultiplexer 211 may proceed with the processing of Step C-3. Further, when the conditions of Step C-2 are not satisfied, Doppler demultiplexer 211 may determine that the reception signal is a noise component or an interference component and does not have to perform any output to direction estimator 212 (step D).

Note that when N_{B2}=1, the beam direction B2 Doppler shift interval matching determination process does not have to be performed.

### <Step C-3>

For example, based on the relationship between the N_{DM}+δ−N_{B2} Doppler frequency indices for low reception levels among the Doppler frequency indices (f_{sddm_cfar}+(ndm−1)×N_{Δfd}) and the top N_{B2} Doppler frequency indices for high reception power, Doppler demultiplexer 211 associates Doppler shift amounts DOP₁, DOP₂, . . . , DOP_{N}t of the Nt transmitted Doppler multiplexed signals with the Doppler frequency indices, and outputs them as Doppler-multiplexed-signal separation index information DDM_RXindex__{B2}(f_{b_cfar})=(f_{demul_Tx #1}, . . . , f_{demul_Tx #NDM}) along with distance indices f_{b_cfar} to direction estimator 212.

Here, f_{demul_Tx #n} indicates the Doppler frequency index of the reflected wave signal from the radar transmission signal transmitted by the nth transmission antenna (Tx #n).

Further, Doppler demultiplexer 211 outputs, for example, the outputs of Doppler analyzers 209 corresponding to these distances and Doppler separation indices to direction estimator 212.

It should be noted that the Doppler shift amounts applied to transmission antennas of transmission antenna section 105 are known in Doppler shifters 104 of radar transmitter 100. Therefore, the difference between the Doppler frequency indicated by Doppler-multiplexed-signal separation index information DDM_RXindex__{B2}(f_{b_cfar}) and the Doppler shift amounts applied to transmission antennas in radar transmitter 100 becomes the Doppler frequency of the target object. Therefore, Doppler demultiplexer 211 may output to direction estimator 212 the Doppler frequency of the target object estimated within the range of −1/(2Tr)≤fd<1/(2Tr) instead of separation index information DDM_RXindex__{B2}(f_{b_cfar}). In this case, direction estimator 212 can perform a similar operation by generating Doppler-multiplexed-signal separation index information DDM_RXindex__{B2}(f_{b_cfar}) based on the Doppler frequency of the target object input from Doppler demultiplexer 211 and the Doppler shift amounts applied to transmission antennas in Doppler shifters 104 of radar transmitter 100.

Further, Doppler demultiplexer 211 may associate the Doppler shift amounts of the Doppler multiplexed signals from the N_{B2} transmission antennas with beam direction B2 among the Nt transmission antennas, with the Doppler frequency indices, and output the beam direction B2 separation index information of the Doppler multiplexed signals as DDM_Rxindex__{B2}(f_{b_cfar}) along with distance indices f_{b_cfar} to direction estimator 212.

The exemplary operations of Doppler demultiplexer 211 have been described above.

Further, when there are a plurality of distance indices f_{b_cfar}, a plurality of Doppler frequency indices f_{sddm_cfar}, and a plurality of pieces of reception power information (PowerFT(f_{b_cfar}, f_{sddm_cfar}+(ndm−1)×N_{Δfd})) input from CFAR section 210, Doppler demultiplexer 211 may perform the aforementioned Doppler demultiplexing operation multiple times for each of distance index, Doppler frequency index, and reception power information.

Further, in the exemplary operations of Doppler demultiplexer 211 described above, the case of the multi-beam number NB=2 has been described, but the multi-beam number NB is not limited thereto, for example, NB may be 3 or more. For example, when multi-beam number NB is 3, Doppler demultiplexer 211 may continue to perform Doppler demultiplexing processing for a beam direction different from beam directions B1 and B2 (or an overlapping beam range or a different beam, for example, beam direction B3) in step D (or between step C-2 and step D) in FIG. 18. This enables a similar Doppler demultiplexing operation even when the multi-beam number is further increased.

### [Exemplary Operation of Direction Estimator 212]

Next, an exemplary operation of direction estimator 212 illustrated in FIG. 7 will be described.

The following describes an exemplary operation of direction estimator 212 in the case where a plurality of reception antennas of reception antenna section 202 are the same omnidirectional antenna or antennas having substantially uniform directional characteristics within the viewing angle of reception antennas with the plurality of different beam directions.

Direction estimator 212, for example, performs direction estimation processing on a target object based on information input from Doppler demultiplexer 211 (for example, distance indices f_{b_cfar}, Doppler-multiplexed-signal separation index information (DDM_Rxindex(f_{b_cfar})−(f_{demul_Tx #1}, f_{demul_Tx #2}, . . . , f_{demul_Tx #Nt}) or DDM_Rxindex__{Bq}(f_{b_cfar})), and the outputs of Doppler analyzers 209 corresponding to these distances and Doppler separation indices. Here, for example, q=1 or 2.

Below, exemplary operations 1 and 2 of direction estimator 212 are described.

### <Exemplary Operation 1 of Direction Estimator 212>

For example, direction estimator 212 extracts the outputs of Doppler analyzers 209 based on distance indices f_{b_cfar} and Doppler-multiplexed-signal separation index information DDM_Rxindex(f_{b_cfar}), generates a virtual reception array correlation vector h(f_{b_cfar}, DDM_Rxindex(f_{b_cfar})) of direction estimator 212 as shown in following Expression 10, and performs direction estimation processing.

Here, when information input from Doppler demultiplexer 211 includes Doppler-multiplexed-signal separation index information DDM_Rxindex (f_{b_cfar})−(f_{demul_Tx #1}, f_{demul_Tx #2}, . . . , f_{demul_Tx #Nt}), the information includes Doppler separation information for Nt transmission antennas. Therefore, virtual reception array correlation vector h(f_{b_cfar}, DDM_Rxindex(f_{b_cfar})) of direction estimator 212 includes Nt×Na elements, which is the product of number Nt of transmission antennas and number Na of reception antennas, as shown in Expression 10. Direction estimator 212 uses virtual reception array correlation vector h(f_{b_cfar}, DDM_Rxindex(f_{b_cfar})) to perform direction estimation based on the phase difference between transmission and reception antennas for the reflected wave signal from the target object.

$$\begin{matrix}[ 10 ] & \\ h ( {f}_{b \_ cfar} , DDM\_Rxindex ( {f}_{b \_ cfar} ) ) = [ \begin{matrix}{h}_{cal [ 1 ]} {VFT}_{1} ( {f}_{b \_ cfar} , {f}_{demul \_ Tx \#1} ) \\ {h}_{cal [ 2 ]} {VFT}_{2} ( {f}_{b \_ cfar} , {f}_{demul \_ Tx \#1} ) \\ ⋮ \\ {h}_{cal [ {N}_{a} ]} {VFT}_{{N}_{a}} ( {f}_{b \_ cfar} , {f}_{demul \_ Tx \#1} ) \\ {h}_{cal [ {N}_{a} + 1 ]} {VFT}_{1} ( {f}_{b \_ cfar} , {f}_{demul \_ Tx \#2} ) \\ {h}_{cal [ {N}_{a} + 2 ]} {VFT}_{2} ( {f}_{b \_ cfar} , {f}_{demul \_ Tx \#2} ) \\ ⋮ \\ {h}_{cal [ 2 {N}_{a} ]} {VFT}_{{N}_{a}} ( {f}_{b \_ cfar} , {f}_{demul \_ Tx \#2} ) \\ ⋮ \\ {h}_{cal [ {N}_{a} ( {N}_{t} - 1 ) + 1 ]} {VFT}_{1} ( {f}_{b \_ cfar} , {f}_{demul \_ Tx {\# N}_{t}} ) \\ {h}_{cal [ {N}_{a} ( {N}_{t} - 1 ) + 2 ]} {VFT}_{2} ( {f}_{b \_ cfar} , {f}_{demul \_ Tx {\# N}_{t}} ) \\ ⋮ \\ {h}_{cal [ {N}_{a} {N}_{t} ]} {VFT}_{{N}_{a}} ( {f}_{b \_ cfar} , {f}_{demul \_ Tx {\# N}_{t}} )\end{matrix} ] & ( Expression 10 )\end{matrix}$$

In Expression 10, h_{cal[b]} is an array correction value that corrects for phase and amplitude deviations between transmission antennas and between reception antennas. Here, b is an integer from 1 to (Nt×Na).

Direction estimator 212, for example, uses virtual reception array correlation vector h(f_{b_cfar}, DDM_Rxindex(f_{b_cfar})) to calculate a spatial profile by varying the azimuth direction θu in the direction estimation evaluation function P_{H}(θᵤ, f_{b_cfar}, DDM_Rxindex(f_{b_cfar}) within a predetermined angle range.

Direction estimator 212 may extract a predetermined number of local maximum peaks of the calculated spatial profile in descending order and output the azimuth direction of the local maximum peaks as the direction-of-arrival estimation value (for example, as positioning output).

Note that there are various methods for direction estimation evaluation function value P_{H}(θᵤ, f_{b_cfar}, DDM_Rxindex(f_{b_cfar})) depending on the direction-of-arrival estimation algorithm. For example, an estimation method using an array antenna, as disclosed in NPL 3, may be used.

For example, when the number of virtual reception antennas is Nt×Na and arranged in a straight line at equal intervals dH, the beamformer method can be expressed as in Expression (11). In addition to the beamformer method, a technique such as Capon or MUSIC is also applicable.

$$\begin{matrix}[ 11 ] & \\ {P}_{H} ( {θ}_{u} , {f}_{b \_ cfar} , DDM\_Rxindex ( {f}_{b \_ cfar} ) ) = {a}^{H} ( {θ}_{u} ) h ( {f}_{b \_ cfar} , DDM\_Rxindex ( {f}_{b \_ cfar} ) ) & ( Expression 11 )\end{matrix}$$

In Expression 11, the superscript H is a Hermitian transpose operator. Further, in Expression 11, a(δᵤ) represents the direction vector of the virtual reception array with respect to the arrival wave in azimuth direction θᵤ at center frequency f_{c} of the radar transmission signal, and is a column vector with Nₜ×Na elements as expressed in Expression 12. In Expression 12, λ is the wavelength of the radar transmission signal (for example, a chirp signal) at center frequency f_{c}, where λ=C₀/f_{c}.

$$\begin{matrix}[ 12 ] & \\ a ( {θ}_{u} ) = [ \begin{matrix}1 \\ exp ( - j 2 π {d}_{H} sin {θ}_{u} / λ ) \\ ⋮ \\ exp ( - j 2 π ( {N}_{t} {N}_{a} - 1 ) {d}_{H} sin {θ}_{u} / λ )\end{matrix} ] & ( Expression 12 )\end{matrix}$$

Moreover, azimuth direction θᵤ is a vector that changes at a predetermined azimuth interval β₁ within the azimuth range where direction-of-arrival estimation is performed. For example, θᵤ may be set as follows:

$${θ}_{u} = {θ}_{min} + u {β}_{1} , where integer u is 0 to NU ; and$$

$$NU = floor [ ( θmax - θmin ) / {β}_{1} ] + 1.$$

Here, floor(x) is a function that returns the largest integer value not greater than real number x.

Further, although the example described above involves direction estimator 212 calculating the azimuth direction as the direction-of-arrival estimation value, the present disclosure is not limited thereto. It is also possible to estimate the direction of arrival in the elevation direction by using virtual reception antennas arranged in the elevation direction, or to estimate the direction of arrival in the azimuth and elevation directions by using virtual reception antennas arranged in the azimuth and elevation directions, such as in a rectangular grid pattern. For example, direction estimator 212 may calculate both the azimuth and elevation directions as direction-of-arrival estimation values for each of transmission antennas with different beam directions, and output them as positioning outputs.

Through the above operations, direction estimator 212 of radar apparatus 10 may, for example, output, as positioning outputs, the direction-of-arrival estimation values for distance index f_{b_cfar}, and Doppler-multiplexed-signal separation index information DDM_Rxindex(f_{b_cfar})=(f_{demul_Tx #1}, . . . , f_{demul_Tx #NDM}). Further, direction estimator 212 may further output, as the positioning outputs, distance index f_{b_cfar}, and Doppler-multiplexed-signal separation index information DDM_Rxindex(f_{b_cfar}).

Additionally, direction estimator 212 may output the Doppler frequency estimation value of a target object based on Doppler-multiplexed-signal separation index information DDM_Rxindex(f_{b_cfar}), for example.

Further, distance index f_{b_cfar} may be converted into distance information using Expression 1 and outputted.

When there are a plurality of information inputs from Doppler demultiplexer 211 (for example, distance index f_{b_cfar}, and Doppler-multiplexed-signal separation index information DDM_Rxindex(f_{b_cfar})=(f_{demul_Tx #1}, f_{demul_Tx #2}, . . . , f_{demul_Tx #Nt})), direction estimator 212 may calculate the direction-of-arrival estimation values in the same manner as the aforementioned processing for them and output the positioning results.

### <Exemplary Operation 2 of Direction Estimator 212>

For example, direction estimator 212 extracts the outputs of Doppler analyzer 209 based on the distance index f_{b_cfar} and the Doppler-multiplexed-signal separation index information DDM_Rxindex_Bq (f_{b_cfar}), generates a virtual reception array correlation vector h_{q}(f_{b_cfar}, DDM_Rxindex(f_{b_cfar}) of direction estimator 212, and performs direction estimation processing based on the reception signal corresponding to transmission antennas with beam direction Bq. Here, q=1 . . . , NB. For example, when the multi-beam number NB is 2, q=1 or 2. Hereinafter, the operation will be described when NB is 2, but the number is not limited thereto. Direction estimator 212 performs, for example, a direction estimation processing of beam direction Bq corresponding to q that matches the separation-index-information DDM_Rxindex_Bq (f_{b_cfar}) of the Doppler multiplexed signals.

For example, direction estimator 212 generates a Bq beam antenna virtual reception array correlation vector h_{Bq}(f_{b_cfar}, DDM_Rxindex_Bq(f_{b_cfar}) on the basis of Bq beam antenna extraction vector SP_{Bq} and virtual reception array correlation vector h(f_{b_cfar}, DDM_Rxindex_Bq (f_{b_cfar}) that extracts the reception signals corresponding to the transmission antennas with beam direction Bq in order to perform a direction estimation processing based on the reception signals corresponding to the radar transmit signals from transmission antennas with beam direction Bq. Where h_{Bq}(f_{b_cfar}, DDM_Rxindex_Bq (f_{b_cfar}) is a column vector with N_{Bq}×Na elements.

For example, when the transmission antennas with beam direction B1 are Tx #1 and Tx #3, the transmission antennas with beam direction B2 are Tx #2 and Tx #4, N_{B1}=2, N_{B2}=2, Nt=4, and number Na of reception antennas is 4, B1 beam antenna extraction vector SP_{B1} for extracting the reception signals corresponding to the transmission antennas with beam direction B1, and B2 beam antenna extraction vector SP_{B2} for extracting the reception signals corresponding to the transmission antennas with beam direction B2, may be represented as 16 (=Nt×Na)-th order column vectors as shown in following Expressions 13 and 14. Here, superscript T denotes vector transposition.

$$\begin{matrix}[ 13 ] & \\ {SP}_{B 1} = {[ 1 , 1 , 1 , 1 , 0 , 0 , 0 , 0 , 1 , 1 , 1 , 1 , 0 , 0 , 0 , 0 ]}^{T} & ( Expression 13 )\end{matrix}$$

$$\begin{matrix}[ 14 ] & \\ {SP}_{B 2} = {[ 0 , 0 , 0 , 0 , 1 , 1 , 1 , 1 , 0 , 0 , 0 , 0 , 1 , 1 , 1 , 1 ]}^{T} & ( Expression 14 )\end{matrix}$$

Direction estimator 212, for example, uses the element index whose element is 1 in B1 beam antenna extraction vector SP_{B1} to extract the element component of the element index from virtual reception array correlation vector h(f_{b_cfar}, DDM_Rxindex_B1(f_{b_cfar})), and generates a column vector in which the element components are arranged in ascending order of the element index as virtual reception array correlation vector h_{B1}(f_{b_cfar}, DDM_Rxindex_B1(f_{b_cfar})) of the B1 beam antenna. For example, B1 beam antenna extraction vector SP_{B1} shown in Expression 13 has elements that are 1 at the first to 4th and 9th to 12th element indices. In this case, direction estimator 212 extracts the element components in the order of the first to 4th and 9th to 12th element indices from virtual reception array correlation vector h(f_{b_cfar}, DDM_Rxindex_B1(f_{b_cfar})), and generates B1 beam antenna virtual reception array correlation vector h_{B1}(f_{b_cfar}, DDM_Rxindex_B1(f_{b_cfar})).

Similarly, direction estimator 212, for example, uses the element index whose element is 1 in B2 beam antenna extraction vector SP_{B2} to extract the element component from virtual reception array correlation vector h(f_{b_cfar}, DDM_Rxindex_B2(f_{b_cfar})) using the element index, and generates a column vector in which the element components of the element index are arranged in ascending order of the element index as virtual reception array correlation vector h_{B2}(f_{b_cfar}, DDM_Rxindex_B2(f_{b_cfar})) of the B2 beam antenna. For example, B2 beam antenna extraction vector SP_{B2} shown in Expression 14 has elements that are 1 at the 5th to 8th and 13th to 16th element indices. In this case, direction estimator 212 extracts the element components in the order of the 5th to 8th and 13th to 16th element indices from virtual reception array correlation vector h(f_{b_cfar}, DDM_Rxindex_B2(f_{b_cfar})), and generates B2 beam antenna virtual reception array correlation vector h_{B2}(f_{b_cfar}, DDM_Rxindex_B2(f_{b_cfar})).

For example, by using virtual reception array correlation vector h_{Bq}(f_{b_cfar}, DDM_Rxindex_Bq(f_{b_cfar})) of the Bq beam antenna, direction estimator 212 calculates the spatial profile for each Bq beam while varying azimuth direction θᵤ within a predetermined angle range in direction estimation evaluation function P_{H-LBq}(θᵤ, f_{b_cfar}, DDM_Rxindex_Bq(f_{b_cfar})). Here, q=1 and 2.

Direction estimator 212 may extract a predetermined number of local maximum peaks of the spatial profiles based on the calculated reception signal corresponding to the transmission antenna with beam direction Bq in descending order and output the azimuth direction of the local maximum peaks as the direction-of-arrival estimation value for the Bq beam (for example, as positioning output).

It should be noted that there are various methods with direction estimation evaluation function value P_{H-Bq}(θᵤ, f_{b_cfar}, DDM_Rxindex_Bq(f_{b_cfar})) depending on the direction-of-arrival estimation algorithm. For example, an estimation method using an array antenna disclosed in NPL 3 may be used.

In the example described above, an example has been described in which direction estimator 212 calculates the azimuth direction as the direction-of-arrival estimation value, but the configuration is not limited thereto. It is also possible to estimate the direction of arrival in the elevation direction by using virtual reception antennas arranged in the elevation direction, or to estimate the direction of arrival in the azimuth direction and the elevation direction by using virtual reception antennas arranged in the azimuth direction and the elevation direction, such as in a rectangular lattice. For example, direction estimator 212 may calculate the azimuth direction and the elevation direction as the estimated value of the direction-of-arrival estimation value as positioning outputs.

Through the above operations, direction estimator 212 of radar apparatus 10 may output as the positioning outputs for example, a direction-of-arrival estimation value for beam direction Bq based on distance index f_{b_cfar}, and a reception signal from a transmission antenna with beam direction Bq in Doppler-multiplexed-signal separation index information DDM_Rxindex_Bq(f_{b_cfar})=(f_{demul_Tx #1}, . . . , f_{demul_Tx #NDM}). Further, direction estimator 212 may further output distance index f_{b_cfar}, and Doppler-multiplexed-signal separation index information DDM_Rxindex_Bq(f_{b}_far) as the positioning outputs.

Additionally, direction estimator 212 may output the Doppler frequency estimation value of a target object based on Doppler-multiplexed-signal separation index information DDM_Rxindex_Bq(f_{b_cfar}), for example.

Further, distance index f_{b_cfar} may be converted into distance information using Expression 1 and output.

Further, when there are a plurality of information inputs from Doppler demultiplexer 211 (for example, distance index f_{b_cfar}, and Doppler-multiplexed-signal separation index information DDM_Rxindex_Bq(f_{b_cfar})=(f_{demul_Tx #1}, f_{demul_Tx #2}, f_{demul_Tx #Nt})), direction estimator 212 may calculate the direction-of-arrival estimation values in the same manner as the aforementioned processing for the inputs and output the positioning results.

Exemplary operations 1 and 2 of direction estimator 212 have been described above.

Next, an arrangement example of MIMO antennas, and an exemplary operation of direction estimator 212 when using the arrangement example of MIMO antennas will be described. In the following, a transmission antenna and a reception antenna in a MIMO radar are collectively referred to as a MIMO antenna.

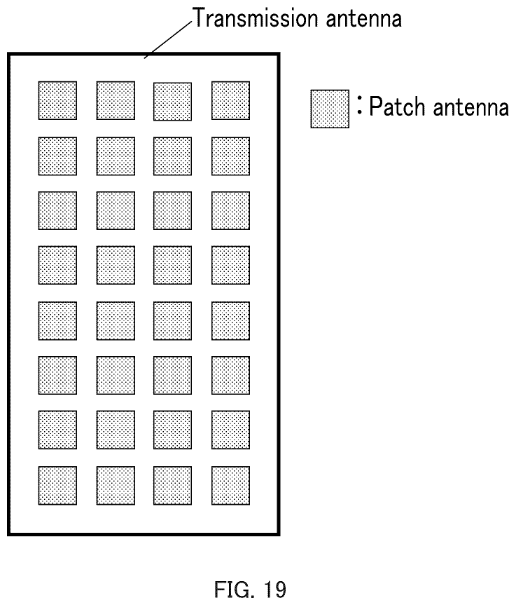

In the following description, each transmission antenna included in transmission antenna section 105, for example, as illustrated in FIG. 19, may be of a sub-array configuration in which a plurality of planar patch antennas are arranged in the longitudinal and lateral directions. In the example of FIG. 19, the transmission antenna consists of eight planar patch antennas longitudinally and four planar patch antennas laterally. For example, by changing the feeding potential phase for each patch antenna included in one transmission antenna, it is possible to form a beam pattern directed in a desired direction (element pattern of the transmission antenna). Further, for example, as the number of planar patch antennas in the horizontal (or vertical) direction forming one transmission antenna increases, directional beams in the horizontal (or vertical) direction can be formed sharply. One transmission antenna may consist of, for example, the number of planar patches to meet the desired beamwidth.

The configuration of one transmission antenna is not limited to the example illustrated in FIG. 19, the number of patch antennas constituting one transmission antenna (e.g., at least one of the total number, the number in the lateral direction, or the number in the longitudinal direction) is not limited to the number illustrated in FIG. 19. Further, the one transmission antenna is not limited to planar patch antennas, it may be a configuration in which patch antennas are arranged in either the longitudinal or lateral direction.

### Arrangement Example A

Arrangement example A is an arrangement example of MIMO antennas when one transmission antenna corresponds to each transmission beam. In arrangement example A, each transmission beam may be formed by a single transmission antenna.

In the following, as an example, the antenna arrangement of a MIMO radar with transmission antennas (number thereof being Nt=2) (e.g., Tx #1 and Tx #2) and reception antenna number Na being 3 (e.g., Rx #1, Rx #2, and Rx #3) will be described.

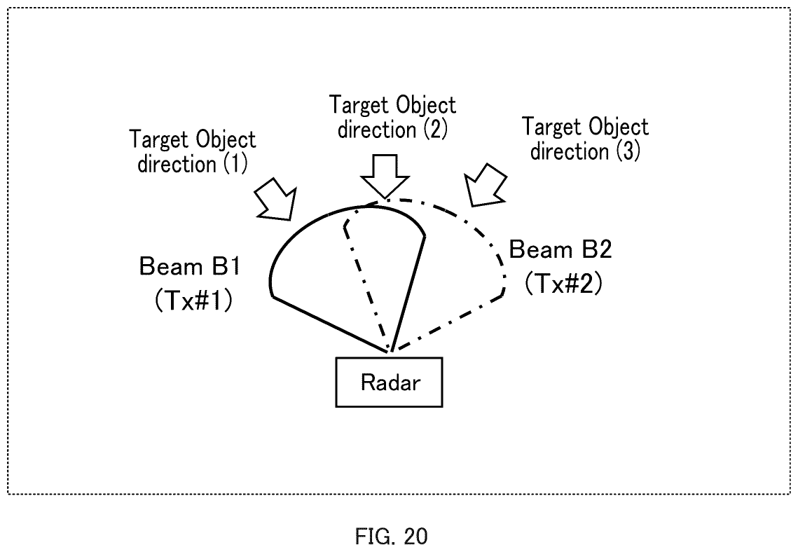

For example, as illustrated in FIG. 20, transmission antennas Tx #1 and Tx #2 have directional patterns that differ in transmission beam direction (or directional beam direction) from each other. In FIG. 20, Tx #1 has a directional pattern of beam direction B1 (beam B1), and Tx #2 has a directional pattern of beam direction B2 (beam B2). In arrangement example A, as illustrated in FIG. 20, the number of transmission antennas having each one of directional patterns in beam direction B1 and beam direction B2 is one, N_{B1}=1 and N_{B2}=1.

Further, in the following, the directivity of the reception antenna (e.g., Rx #1, Rx #2, or Rx #3) may be omnidirectional, or may have substantially uniform directional characteristics within the viewing angle of transmission antennas with a plurality of beam direction (e.g., Tx #1 and Tx #2).

For example, when number Nt of transmission antennas used for multiplexing transmission is 2, radar apparatus 10 transmits radar transmission signals using the Doppler multiplexed signals having a Doppler multiplexing number N_{DM} of 2 in Doppler shifter 104. In this case, for example, in the configuration for Doppler shift amounts described above, it is possible to apply the assignment of Doppler multiplexed signals of N_{B1}=1 and N_{B2}=1.

Further, for example, transmission antennas Tx #1 and Tx #2, and, from the arrangement of reception antennas Rx #1 to Rx #3, the arrangement of virtual reception antennas VA #1 to VA #6 (or, MIMO virtual antenna) is configured.

Here, the arrangement of the virtual reception antennas (virtual reception array), for example, may be expressed as Expression 15 below based on the positions of the transmission antennas constituting transmission antenna section 105 (e.g., the position of the feeding point) and the positions of the reception antennas constituting reception antenna section 202 (e.g., the position of the feeding point).

$$\begin{matrix}[ 15 ] & \\ \{ \begin{matrix}{X}_{V \_ \# b} = ( {X}_{T \_ \# [ ceil ( b / Na ) ]} - {X}_{T \_ \#1} ) + ( {X}_{R \_ \# [ mod ( b - 1 , Na ) + 1 ]} - {X}_{R \_ \#1} ) \\ {Y}_{V \_ \# b} = ( {Y}_{T \_ \# [ ceil ( b / Na ) ]} - {Y}_{T \_ \#1} ) + ( {Y}_{R \_ \# [ mod ( b - 1 , Na ) + 1 ]} - {Y}_{R \_ \#1} )\end{matrix} . & ( Expression 15 )\end{matrix}$$

Here, the position coordinates of a transmission antenna (e.g., Tx #n) constituting transmission antenna section 105 are expressed as (X_{T_#n}, Y_{T_#n}) (e.g., n=1 . . . , Nt), the position coordinates of a reception antenna (e.g., Rx #z) constituting reception antenna section 202 are expressed as (X_{R_#z}, Y_{R_#z}) (e.g., z=1 . . . , Na), and the position coordinates of a virtual antenna VA #b constituting the virtual reception array antenna are expressed as (X_{V_#b}, Y_{V_#b}) (e.g., b=1, . . . , Nt×Na).

In Expression 15, for example, VA #1 is expressed as the position reference (0, 0) of the virtual reception array.

Hereinafter, arrangement examples A-1, A-2 and A-3 of MIMO antennas will be described. The following is described as X_{T_#n} representing the horizontal position coordinates, and Y_{T_#n} representing the vertical position coordinates, but the configuration is not limited thereto.

### Arrangement Example A-1

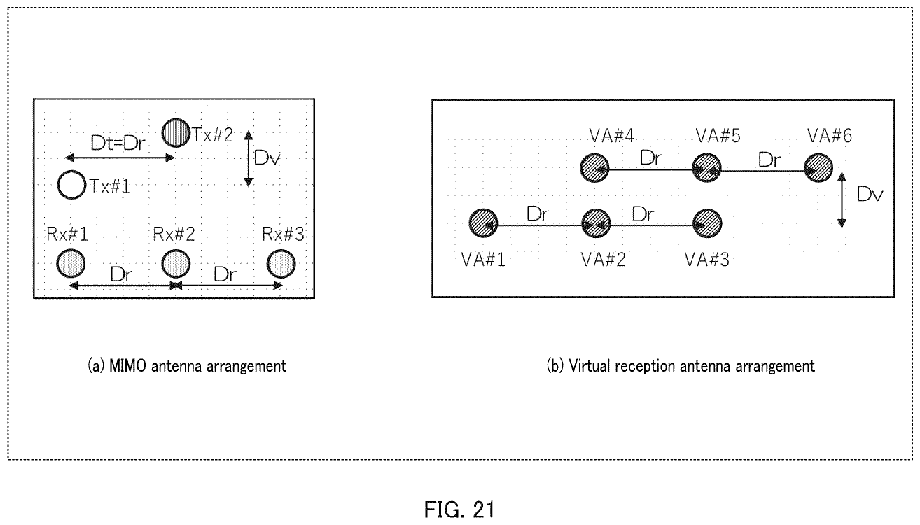

FIG. 21 shows an example of the antenna arrangement according to arrangement example A-1. Part (a) in FIG. 21 shows an arrangement example of MIMO antennas (Tx #1, Tx #2, and Rx #1 to Rx #3), and part (b) in FIG. 21 shows an arrangement example of the virtual reception antennas (VA #1 to VA #6) constituted by the MIMO antenna arrangement of part (a) in FIG. 21.

As illustrated at part (a) in FIG. 21, in arrangement example A-1, reception antennas Rx #1 to Rx #3 are arranged at interval Dr in the horizontal direction (lateral direction in FIG. 21). Further, in arrangement example A-1, transmission antennas Tx #1 and Tx #2 are arranged at interval Dr (Dt=Dr) in the horizontal direction, arranged at different positions in the vertical direction (longitudinal direction in FIG. 21) (e.g., interval D_{V}).

For example, in the case of the arrangement illustrated at part (a) in FIG. 21, namely (X_{T_#1}, Y_{T_#1})=(0,0) and (X_{T_#2}, Y_{T_#2})=(Dᵣ, D_{V}) of transmission antennas Tx #1 and Tx #2, and (X_{R_#1}, Y_{R_#1})=(ax,ay), (X_{R_#2}, Y_{R_#2})=(ax+Dᵣ, ay) and (X_{R_#3}, Y_{R_#3})=(ax+2Dᵣ, ay) of reception antennas Rx #1 to Rx #3, the position coordinates of virtual antennas VA #1 to VA #6 constituting the virtual reception antennas are calculated from Expression 15. Here, ax and ay are arbitrary constants.

For example, the position coordinates of virtual antennas VA #1 to VA #6 become (X_{V_#1}, Y_{V_#1})=(0,0), (X_{V_#2}, Y_{V_#2})=(Dᵣ, 0), (X_{V_#3}, Y_{V_#3})=(2Dᵣ, 0), (X_{V_#4}, Y_{V_#4})=(Dᵣ, D_{V}), (X_{V_#5}, Y_{V_#5})=(2Dᵣ, D_{V}), and (X_{V_#6}, Y_{V_#6})=(3Dᵣ, D_{V}) regardless of ax and ay, as illustrated at part (b) in FIG. 21.

For example, in exemplary operation 1 of direction estimator 212 described above, when the information inputs from Doppler demultiplexer 211 include Doppler-multiplexed-signal separation index information DDM_Rxindex (f_{b_cfar})=(f_{demul_Tx #1}, f_{demul_Tx #2}, . . . , f_{demul_Tx #Nt}), direction estimator 212 generates virtual reception array correlation vector h(f_{b_cfar}, DDM_Rxindex(f_{b_cfar}) shown in Expression 10 and performs the direction estimation processing.

Here, the reception signal by the bth virtual antenna VA #b is represented by the bth element of virtual reception array correlation vector h(f_{b_cfar}, DDM_Rxindex(f_{b_cfar}).

Doppler-multiplexed-signal separation index information DDM_Rxindex (f_{b_cfar}) input from Doppler demultiplexer 211 includes Doppler separation information for Nt transmission antennas. This is the case where the target object direction is, for example, target object direction (2) illustrated in FIG. 20, and the case where the target object direction corresponds to the area where the beam direction of transmission antennas Tx #1 and Tx #2 overlap. In this case, radar transmission signals from both transmission antennas Tx #1 and Tx #2 are reflected by a target object and received by reception antennas Rx #1 to Rx #3. Therefore, in this case, direction estimator 212 can perform direction estimation using the reception signals of virtual antennas VA #1 to VA #6 corresponding to both Tx #1 and Tx #2.

In the MIMO antenna arrangement of part (a) in FIG. 21, Tx #1 has directional characteristics of beam direction B1, and Tx #2 has directional characteristics of beam direction B2, corresponding to different beam directions from each other. In addition, as illustrated in FIG. 20, the beam directions of Tx #1 and Tx #2 overlap in an angle region within about the beam width. Here, since the arrangement of Tx #1 and Tx #2 is offset (offset value D_{V}) in the vertical direction as illustrated at part (a) in FIG. 21, when there is a target object in the overlapping area (for example, target object direction (2) illustrated in FIG. 20) in the beam directions of Tx #1 and Tx #2, the arrangement allows the angle measurement in the vertical direction in addition to the horizontal direction in direction estimator 212.

Further, in the arrangement of Tx #1 and Tx #2 illustrated at part (a) in FIG. 21, offset Dt in the horizontal direction is Dt=Dr. Thus, in the horizontal direction, Tx #1 and Tx #2 are arranged offset by element interval equal to element interval Dr of reception antennas Rx #1 to Rx #3, and therefore, the virtual reception antenna arrangement includes an arrangement such that the horizontal positions of a plurality of virtual antennas (e.g., VA #2 and VA #4, or VA #3 and VA #5) are the same, but the vertical positions thereof are different by Dv, as illustrated at part (b) in FIG. 21. By such an arrangement of virtual reception antennas, direction estimator 212, can easily perform angle measurement in the vertical direction, for example, based on the reception phase difference between two virtual antennas (e.g., VA #2 and VA #4, or VA #3 and VA #5) that have the same horizontal position.

In exemplary operation 1 of direction estimator 212, in FIG. 21, Dt and Dr, for example, may be set to one wavelength or more. In this case, as a result of the direction estimation processing in direction estimator 212, a grating lobe may be generated, and ambiguity may occur in the estimation in the horizontal direction. Direction estimator 212 can detect the true direction even when the grating lobe is generated because direction estimator 212 specifies that there is a target object in the direction of the overlapping area between beam direction B1 and beam direction B2 based on, for example, Doppler-multiplexed-signal separation index information DDM_Rxindex (f_{b_cfar}).

Further, in exemplary operation 2 of direction estimator 212 described above, when the information inputs from Doppler demultiplexer 211 includes Doppler-multiplexed-signal separation index information DDM_Rxindex_Bq (f_{b_cfar}), direction estimator 212 generates Bq beam antenna virtual reception array correlation vector h_{Bq}(f_{b_cfar}, DDM_Rxindex_Bq(f_{b_cfar}) based on the virtual reception array correlation vector h(f_{b_cfar}, DDM_Rxindex_Bq (f_{b_cfar}) and Bq beam antenna extraction vector SP_{Bq}, and performs the direction estimation processing.

Here, the reception signal by the bth virtual antenna VA #b is represented by the bth element of the virtual reception array correlation vector h(f_{b_cfar}, DDM_Rxindex(f_{b_cfar}).

Doppler-multiplexed-signal separation index information DDM_Rxindex_Bq (f_{b_cfar}) input from Doppler demultiplexer 211 also includes Doppler separation information for N_{Bq} beam direction Bq transmission antennas. This is the case where the target object direction is, for example, target object direction (1) illustrated in FIG. 20 (for example, in the case of beam direction B1) or target object direction (3) (for example, in the case of beam direction B2), and the case where the target object direction corresponds to the area in the beam direction of transmission antenna Tx #q. In this case, the radar transmission signals transmitted from transmission antenna Tx #q is reflected by a target object and received by the reception antennas Rx #1 to Rx #3.

Therefore, in this case, for example, in the case of q=1 (in the case where the target object direction is target object direction (1) illustrated in FIG. 20), direction estimator 212 can perform direction estimation using the reception signals of virtual antennas VA #1 to VA #3 corresponding to Tx #1. Further, for example, in the case of q=2 (in the case where the target object direction is target object direction (3) illustrated in FIG. 20), direction estimator 212 can perform direction estimation using the reception signals of virtual antennas VA #4 to VA #6 corresponding to Tx #2.

In exemplary operation 2 of direction estimator 212, in FIG. 21, Dr, for example, may be set to one wavelength or more. In this case, as a result of the direction estimation processing in direction estimator 212, a grating lobe may be generated, and ambiguity may occur in the estimation in the horizontal direction. Direction estimator 212 can detect the true direction even when the grating lobe is generated because direction estimator 212 specifies that there is a target object in the direction of beam direction B1 or beam direction B2 based on, for example, Doppler-multiplexed-signal separation index information DDM_Rxindex_Bq (f_{b_cfar}).

### Arrangement Example A-2

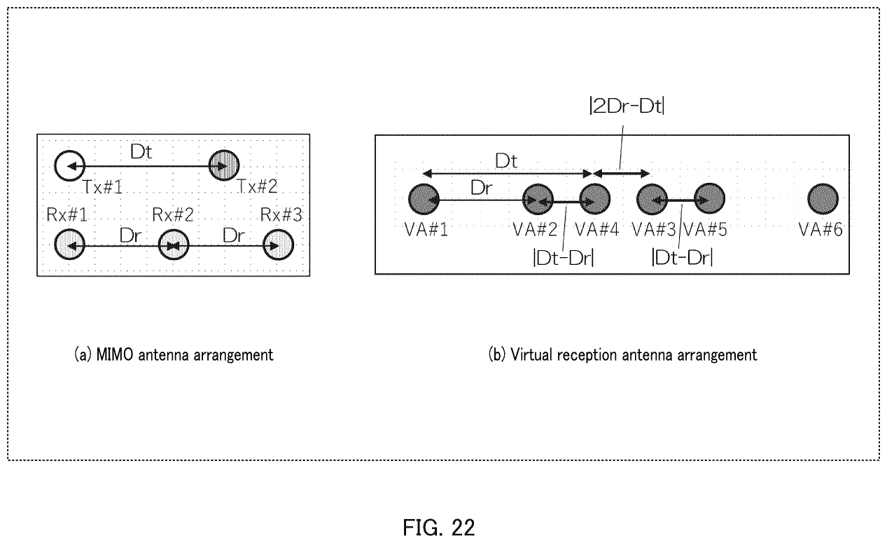

FIG. 22 shows an example of the antenna arrangement according to arrangement example A-2. Part (a) in FIG. 22 shows an arrangement example of MIMO antennas (Tx #1, Tx #2, and Rx #1 to Rx #3), and part (b) in FIG. 22 shows an arrangement example of the virtual reception antenna (VA #1 to VA #6) constituted by the MIMO antenna arrangement of part (a) in FIG. 22.

As illustrated in FIG. 22, in arrangement example A-2, the reception antennas Rx #1 to Rx #3 are arranged at interval Dr in the horizontal direction (lateral direction in FIG. 22). In addition, in arrangement example A-2, transmission antennas Tx #1 and Tx #2 are arranged at interval Dt in the vertical direction (longitudinally in FIG. 22) at the same position (e.g., without offsets). The difference between interval Dt and interval Dr may be a specified value (e.g., half wavelength) based on wavelength λ of the radar transmission signal.

For example, in the case of the arrangement illustrated at part (a) in FIG. 22, namely (X_{T_#1}, Y_{T_#1})=(0,0) and (X_{T_#2}, Y_{T_#2})=(Dₜ, 0) of transmission antennas Tx #1 and Tx #2, and (X_{R_#1}, Y_{R_#1})=(ax,ay), (X_{R_#2}, Y_{R_#2})=(ax+Dᵣ, ay) and (X_{R_#3}, Y_{R_#3})=(ax+2Dᵣ, ay) of reception antennas Rx #1 to Rx #3, the position coordinates of virtual antennas VA #1 to VA #6 constituting the virtual reception antennas are calculated from Expression 15. Here, ax and ay are arbitrary constants.

For example, the position coordinates of virtual antennas VA #1 to VA #6 become (X_{V_#1}, Y_{V_#1})=(0,0), (X_{V_#2}, Y_{V_#2})=(Dᵣ, 0), (X_{V_#3}, Y_{V_#3})=(2Dᵣ, 0), (X_{V_#4}, Y_{V_#4})=(Dₜ, 0), (X_{V_#5}, Y_{V_#5})=(Dₜ+Dᵣ, 0), and (X_{V_#6}, Y_{V_#6})=(Dₜ+2Dᵣ, 0) regardless of ax and ay, as illustrated at part (b) in FIG. 22.

For example, exemplary operation 1 of direction estimator 212 described above is a case where the target object direction is target object direction (2) illustrated in FIG. 20, and the case where the target object direction corresponds to the area where the beam directions of transmission antennas Tx #1 and Tx #2 overlap. In this case, radar transmission signals from both transmission antennas Tx #1 and Tx #2 are reflected by a target object and received by reception antennas Rx #1 to Rx #3. Therefore, in this case, direction estimator 212 can perform direction estimation using the reception signals of virtual antennas VA #1 to VA #6 corresponding to both Tx #1 and Tx #2.

In the MIMO antenna arrangement of part (a) in FIG. 22, Tx #1 has directional characteristics of beam direction B1 and Tx #2 has directional characteristics of beam direction B2, corresponding to different beam directions from each other. In addition, as illustrated in FIG. 20, the beam directions of Tx #1 and Tx #2 overlap with each other in an angle region within about the beam width. Here, since the arrangement of Tx #1 and Tx #2 is offset (offset value Dt) in the horizontal direction as illustrated at part (a) in FIG. 22, in the virtual reception antenna arrangement, the horizontal aperture length is enlarged as illustrated at part (b) in FIG. 22. Therefore, when there is a target object in the overlapping area in the beam directions of Tx #1 and Tx #2 (for example, target object direction (2) illustrated in FIG. 20), the angular resolution is improved in the direction estimation processing of direction estimator 212.

Further, at part (b) in FIG. 22, for example, the distance between virtual antennas VA #2 and VA #4 and the distance between virtual antennas VA #3 and VA #5 are Dt−Dr in the case of Dt>Dr and Dr−Dt in the case of Dr>Dt. For example, when the absolute value of the difference between transmission antenna interval Dt and the reception antenna interval Dr, |Dt−Dr|, is set to a half wavelength, radar apparatus 10 can suppress the grating lobe within a viewing angle in the range of 90°. For example, in the case of Dt=1.5, and Dr=1λ, |Dt−Dr| is 0.5λ.

Although a case where the difference between Dt and Dr, namely |Dt−Dr| (specified value), is set to half-wavelength (0.5λ) has been described, the configuration is not limited thereto. For example, |Dt−Dr| may be set to any value in the range of about 0.45λ to 0.8λ (e.g., any value in the range of 0.5 to 0.8 times the wavelength of the radar transmission signal).

For example, |Dt−Dr| may be set according to the viewing angle of radar apparatus 10 in the horizontal direction, which can suppress grating lobes within the viewing angle. For example, when the viewing angle in the horizontal direction is a wide viewing angle ranging from ±70 degrees to 90 degrees, |Dt−Dr| may be set to about 0.5λ. Alternatively, when the viewing angle in the horizontal direction is a narrow viewing angle ranging from ±20 degrees to ±40 degrees, |Dt−Dr| may be set as a wider interval, for example, about 0.7λ.

Dv in each of arrangement example A-2 and the other arrangement examples may be set to, for example, a value of about 0.45λ to 0.8λ (for example, any value ranging from 0.5 times to 0.8 times the wave length of the radar transmission signal). Dv may be set, for example, according to the viewing angle of radar apparatus 10 in the vertical direction. For example, when the viewing angle in the vertical direction is a wide viewing angle ranging from ±70 degrees to ±90 degrees, Dv may be set to about 0.5λ. Alternatively, when the viewing angle in the vertical direction is a narrow viewing angle ranging from ±20 degrees to ±40 degrees, Dv may be set as a wider interval, for example, about 0.7).

Here, λ represents the wavelength of the carrier frequency of a radar transmission signal. For example, when a chirp signal is used as the radar transmission signal, λ is the wavelength of the center frequency in the frequency sweep band of the chirp signal.

Further, exemplary operation 2 of direction estimator 212 described above is a case where the target object direction is, for example, target object direction (1) or target object direction (3) illustrated in FIG. 20, and the case where the target object direction corresponds to the area in the beam direction of transmission antenna Tx #q. In this case, the radar transmission signals transmitted from transmission antenna Tx #q is reflected by a target object and received by reception antennas Rx #1 to Rx #3.

Therefore, in this case, for example, in the case of q=1 (in the case where the target object direction is target object direction (1) illustrated in FIG. 20), direction estimator 212 can perform direction estimation using the reception signals of virtual antennas VA #1 to VA #3 corresponding to Tx #1. Further, for example, in the case of q=2 (in the case where the target object direction is target object direction (3) illustrated in FIG. 20), direction estimator 212 can perform direction estimation using the reception signals of virtual antennas VA #4 to VA #6 corresponding to Tx #2. In the case of exemplary operation 2 of direction estimator 212 in arrangement example A-2, the arrangement is the same as that of arrangement example A-1, and the same effect as arrangement example A-1 can be obtained.

### Arrangement Example A-3

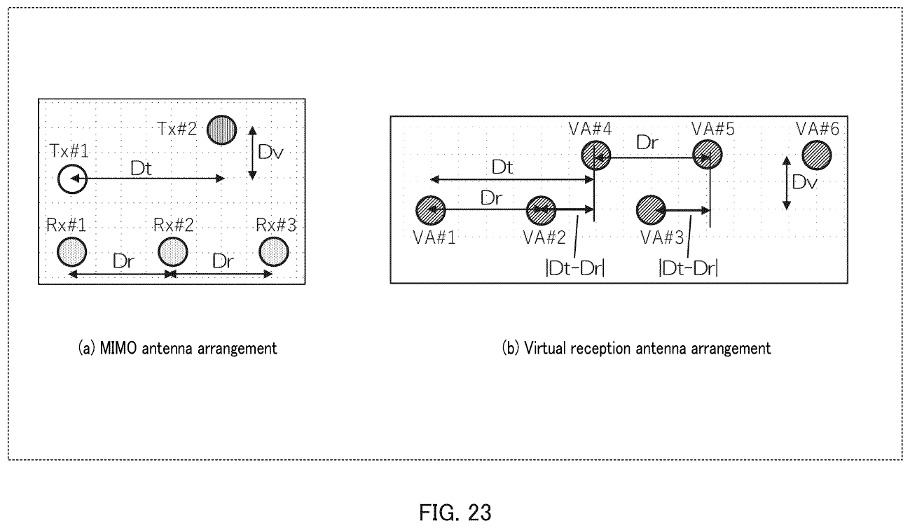

FIG. 23 shows an example of the antenna arrangement according to arrangement example A-3. Part (a) in FIG. 23 shows an arrangement example of MIMO antennas (Tx #1, Tx #2, and Rx #1 to Rx #3), and part (b) in FIG. 23 shows an arrangement example of the virtual reception antenna (VA #1 to VA #6) constituted by the MIMO antenna arrangement of part (a) in FIG. 23.

As illustrated in FIG. 23, in arrangement example A-3, reception antennas Rx #1 to Rx #3 are arranged at interval Dr in the horizontal direction (lateral direction in FIG. FIG. 23). In addition, in arrangement example A-3, transmission antennas Tx #1 and Tx #2 are arranged at interval Dt in the horizontal direction, arranged at different positions (e.g., with offset Dv) in the vertical direction (longitudinal direction in FIG. 23). The differences between interval Dt and interval Dr may be a specified value (e.g., half wavelength) based on wavelength λ of the radar transmission signal.

For example, in the case of the arrangement illustrated at part (a) in FIG. 23, namely the arrangement (X_{T_#1}, Y_{T_#1})=(0,0) and (X_{T_#2}, Y_{T_#2})=(Dₜ, Dᵥ) of transmission antennas Tx #1 and Tx #2, and (X_{R_#1}, Y_{R_#1})=(ax,ay), (X_{R_#2}, Y_{R_#2})=(ax+Dᵣ, ay) and (X_{R_#3}, Y_{R_#3})=(ax+2Dᵣ, ay) of reception antennas Rx #1 to Rx #3, the position coordinates of virtual antennas VA #1 to VA #6 constituting the virtual reception antennas are calculated from Expression 15. Here, ax and ay are arbitrary constants.

For example, the position coordinates of virtual antennas VA #1 to VA #6 become (X_{V_#1}, Y_{V_#1})=(0,0), (X_{V_#2}, Y_{V_#2})=(Dᵣ, 0), (X_{V_#3}, Y_{V_#3})=(2Dᵣ, 0), (X_{V_#4}, Y_{V_#4})=(Dₜ, Dᵥ), (X_{V_#5}, Y_{V_#5})=(Dₜ+Dᵣ, Dᵥ), and (X_{V_#6}, Y_{V_#6})=(Dₜ+2Dᵣ, Dᵥ) regardless of ax and ay, as illustrated at part (b) in FIG. 23.

For example, exemplary operation 1 of direction estimator 212 described above is a case where the target object direction is target object direction (2) illustrated in FIG. 20, and the case where the target object direction corresponds to the area where the beam directions of transmission antennas Tx #1 and Tx #2 overlap. In this case, radar transmission signals from both transmission antennas Tx #1 and Tx #2 are reflected by a target object and received by reception antennas Rx #1 to Rx #3. Therefore, in this case, direction estimator 212 can perform direction estimation using the reception signals of virtual antennas VA #1 to VA #6 corresponding to both Tx #1 and Tx #2.

In the MIMO antenna arrangement of part (a) in FIG. 23, Tx #1 has directional characteristics of beam direction B1, and Tx #2 has directional characteristics of beam direction B2, corresponding to different beam directions from each other. In addition, as illustrated in FIG. 20, the beam directions of Tx #1 and Tx #2 overlap in angle region within about the beam width. Here, since the arrangement of Tx #1 and Tx #2 is offset (offset value D_{V}) in the vertical direction as illustrated at part (a) in FIG. 23 in a similar manner to arrangement example A-1, when there is a target object in the overlapping area (for example, target object direction (2) illustrated in FIG. 20) in the beam directions of Tx #1 and Tx #2, the arrangement allows the angle measurement in the vertical direction in addition to the horizontal direction in direction estimator 212.

Further, as illustrated at part (a) in FIG. 23, the arrangement of Tx #1 and Tx #2 is offset (offset value Dt) in the horizontal direction in the same manner as in arrangement example A-2, and therefore, the horizontal aperture length is enlarged in the virtual reception antenna arrangement as illustrated at part (b) in FIG. 23. Therefore, when there is a target object in the overlapping area in the beam directions of Tx #1 and Tx #2 (for example, target object direction (2) illustrated in FIG. 20), the angular resolution is improved in the direction estimation processing of direction estimator 212.

Further, at part (b) in FIG. 23, for example, the distance between virtual antennas VA #2 and VA #4, and the distance between virtual antennas VA #3 and VA #5 are Dt−Dr in the case of Dt>Dr and Dr−Dt in the case of Dr>Dt. For example, when the absolute value of the difference between transmission antenna interval Dt and the reception antenna interval Dr, |Dt−Dr|, is set to a half wavelength, radar apparatus 10 can suppress the grating lobe within a viewing angle in the range of 90°. For example, in the case of Dt=1.5, and Dr=, |Dt−Dr| is 0.5a. For example, when the viewing angle at the angle of measurement detected by radar apparatus 10 is narrower than ±90°, radar apparatus 10 can suppress the grating lobe within the viewing angle by setting the |Dt−Dr| to a wavelength of about 0.5 to 0.8.

Further, exemplary operation 2 of direction estimator 212 described above is a case where the target object direction is, for example, target object direction (1) or target object direction (3) illustrated in FIG. 20, and the case where the target object direction corresponds to the area in the beam direction of transmission antenna Tx #q. In this case, the radar transmission signals transmitted from transmission antenna Tx #q is reflected by a target object and received by reception antennas Rx #1 to Rx #3.

Therefore, in this case, for example, in the case of q=1 (in the case where the target object direction is target object direction (1) illustrated in FIG. 20), direction estimator 212 can perform direction estimation using the reception signals of virtual antennas VA #1 to VA #3 corresponding to Tx #1. Further, for example, in the case of q=2 (in the case where the target object direction is target object direction (3) illustrated in FIG. 20), direction estimator 212 can perform direction estimation using the reception signals of virtual antennas VA #4 to VA #6 corresponding to Tx #2. In the case of exemplary operation 2 of direction estimator 212 in arrangement example A-3, the arrangement is the same as that of arrangement example A-1, and the same effect as arrangement example A-1 can be obtained.

Arrangement example A has been described above.

### Arrangement Example B

Arrangement Example B is an arrangement example of MIMO antennas when two or more transmission antennas corresponds to each transmission beam. In arrangement example B, each transmission beam may be formed by two or more transmission antennas.

In the following, as an example, the antenna arrangement of a MIMO radar with transmission antenna number Nt being 4 (e.g., Tx #1, Tx #2, Tx #3, and Tx #4) reception antenna number Na being 3 (e.g., Rx #1, Rx #2, and Rx #3) will be described.

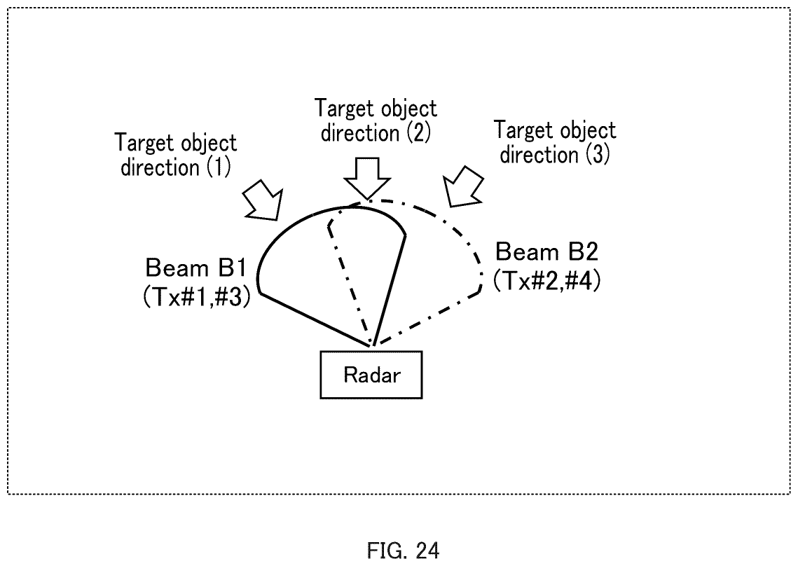

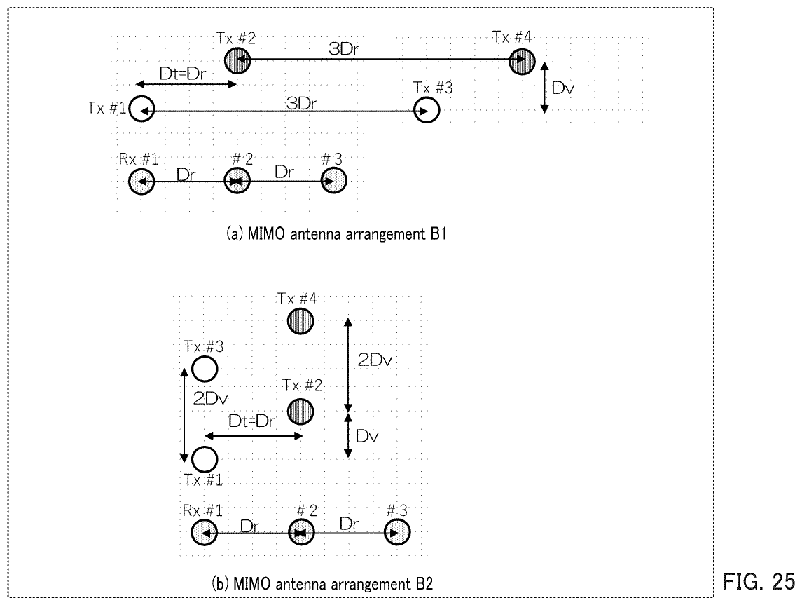

For example, as illustrated in FIG. 24, transmission antennas Tx #1 and Tx #3 have a directional pattern that differs in transmission beam direction (or directional beam direction) from transmission antennas Tx #2 and Tx #4. In FIG. 25, Tx #1 and Tx #3 have a directional pattern of beam direction B1 (beam B1), and Tx #2 and Tx #4 have a directional pattern of beam direction B2 (beam B2). In arrangement example B, as illustrated in FIG. 24, the number of transmission antennas having each one of directional patterns in beam direction B1 and beam direction B2 is two, N_{B1}=2 and N_{B2}=2.

Further, in the following, the directivity of the reception antenna (e.g., Rx #1, Rx #2, or Rx #3) may be omnidirectional, or may have substantially uniform directional characteristics within the viewing angle of transmission antennas with a plurality of beam direction (e.g., Tx #1 to Tx #4).

For example, when number Nt of transmission antennas used for multiplexing transmission is 4, radar apparatus 10 transmits radar transmission signals using the Doppler multiplexed signals having a Doppler multiplexing number N_{DM} of 4 in Doppler shifter 104. In this case, for example, in the configuration for Doppler shift amounts described above, it is possible to apply the assignment of Doppler multiplexed signals of N_{B1}=2 and N_{B2}=2.

Further, for example, from the arrangement of transmission antennas Tx #1 to Tx #4 and reception antennas Rx #1 to Rx #3, the arrangement of virtual reception antennas VA #1 to VA #12 (or, MIMO virtual antennas) is configured (not shown).

In arrangement example B, based on the MIMO antenna arrangement example of arrangement example A, the transmission antennas for each transmission beam may further be disposed at offset positions in the horizontal direction or the vertical direction, or may further be disposed at offset positions in both the horizontal direction and the vertical direction (e.g., offset in the diagonal direction).

FIG. 25 shows an arrangement example of MIMO antennas (Tx #1 to Tx #4 and Rx #1 to Rx #3) according to arrangement example B.

Part (a) in FIG. 25 shows an example arrangement in which the transmission antennas (e.g., Tx #3 and Tx #4) are horizontally added and expanded in each of the transmission beams (e.g., beam directions B1 and B2) based on the MIMO antenna arrangement of arrangement example A-1 (e.g., part (a) in FIG. 21).

Further, part (b) in FIG. 25 shows an example arrangement in which the transmission antennas (e.g., Tx #3 and Tx #4) are vertically added and expanded in each of the transmission beams (e.g., beam directions B1 and B2) based on the MIMO antenna arrangement of arrangement example A-1 (e.g., part (a) in FIG. 21).

For example, in parts (a) and (b) in FIG. 25, the arrangement of transmission antennas Tx #1 and Tx #2 and reception antennas Rx #1 to Rx #3 is the same as the MIMO antenna arrangement of FIG. 21.

At part (a) in FIG. 25, with respect to transmission antenna Tx #1, transmission antenna Tx #3 is disposed offset in the horizontal direction by a distance (e.g., 3Dr) greater than the horizontal aperture length of the reception antenna (e.g., 2Dr). Similarly, at part (a) in FIG. 25, with respect to transmission antenna Tx #2, transmission antenna Tx #4 is disposed offset in the horizontal direction by a distance (e.g., 3Dr) greater than the horizontal aperture length of the reception antenna (e.g., 2Dr).

In the arrangement as shown part (a) in FIG. 25, the aperture length of the virtual reception antenna (not shown) is enlarged, and thus the horizontal angular resolution in radar apparatus 10 is improved.

Further, at part (b) in FIG. 25, with respect to transmission antenna Tx #1, transmission antenna Tx #3 is disposed offset in the vertical direction by 2Dv. Similarly, at part (b) in FIG. 25, with respect to transmission antenna Tx #2, transmission antenna Tx #4 is disposed offset in the vertical direction by 2Dv.

By the arrangement as part (b) in FIG. 25, the aperture length of a virtual reception antenna is enlarged in the vertical direction, and therefore, for example, in exemplary operation 1 of direction estimator 212, the angular resolution of the vertical direction is improved. Further, by the arrangement as illustrated at part (b) in FIG. 25, for example, in exemplary operation 2 of direction estimator 212, even when the target object direction is target object direction (1) illustrated in FIG. 24, the arrangement of Tx #1 and Tx #3 is vertically offset, and therefore, direction estimator 212 can measure the angle in the vertical direction in addition to the horizontal direction. Similarly, the arrangement of Tx #2 and Tx #4 is vertically offset even when the target object direction is target object direction (3) illustrated in FIG. 24, direction estimator 212 can measure the angle in the vertical direction in addition to the horizontal direction.

The beam directions and the arrangement of the transmission antennas are not limited to the example illustrated in FIGS. 24 and 25. For example, the arrangement of Tx #2 and Tx #3 at part (a) in FIG. 25 may be switched, the arrangement of Tx #2 and Tx #3 at part (b) in FIG. 25 may be switched.

Further, the number of transmission antennas in each beam direction is not limited to two, and among the plurality of different beam directions, the number of transmission antennas in at least one beam direction may be three or more.

Arrangement example B has been described above.

Arrangement example A and arrangement example B describe the arrangement in which reception antennas (Rx #1 to Rx #3) are disposed in the same vertical position, and are offset by equal intervals of Dr in the horizontal direction, but the arrangement of the reception antennas is not limited thereto. For example, in the horizontal arrangement of the reception antennas, the intervals between the reception antennas may be uneven.

Further, for example, all of the positions of the reception antennas in the vertical direction do not have to be at the same position, and some of the reception antennas may be offset in the vertical direction. For example, the arrangement of reception antennas Rx #1 to Rx #3 may be set as (X_{R_#1}, Y_{R_#1})=(ax,ay), (X_{R_#2}, Y_{R_#2})=(ax+Dᵣ, ay), and (X_{R_#3}, Y_{R_#3})=(ax+2Dᵣ, ay+Dv_offset). In this case, Rx #3 is disposed vertically at an offset (or different position) from the vertical positions of Rx #1 and #2 by Dv_offset. In this way, by arranging the reception antennas so that all of the vertical positions are not at the same position but some of the reception antenna are offset vertically, even in exemplary operation 2 of direction estimator 212, direction estimator 212 can measure the angle in the vertical direction in addition to the horizontal direction.

Further, for example, all of the positions of the reception antennas in the vertical direction do not have to be at the same position, and some of the reception antennas may be offset in the vertical direction and further may be arranged at the same positions as that of the horizontal positions of the other reception antennas. For example, the arrangement of reception antennas Rx #1 to Rx #3 may be set as (X_{R_#1}, Y_{R_#1})=(ax,ay), (X_{R_#2}, Y_{R_#2})=(ax+Dᵣ, ay), and (X_{R_#3}, Y_{R_#3})=(ax+Dᵣ, ay+Dv_offset). In this case, Rx #3 is disposed vertically offset (Dv_offset) relative to the vertical position of Rx #1 and #2, and disposed at the same position as the horizontal position of Rx #2 in the horizontal direction.

In this way, by arranging the reception antennas so that not all of the positions of the reception antennas in the vertical direction are at the same position, and arranging some of the reception antennas are offset in the vertical direction and further at the same position as that of the horizontal positions of the other reception antennas, for example, even in exemplary operation 2 of direction estimator 212, direction estimator 212 can measure the angle in the vertical direction in addition to the horizontal direction.

Here, ax and ay are any constants, and Dv_offset may be set to, for example, a value of about 0.45λ to 0.8λ (for example, any value ranging from 0.5 times to 0.8 times the wave length of the radar transmission signal). Dv_offset may be set according to, for example, a viewing angle of radar apparatus 10 in the vertical direction. For example, when the viewing angle in the vertical direction is a wide viewing angle in a range of about 70 degrees to ±90 degrees, Dv_offset may be set to about 0.5λ. Alternatively, when the viewing angle in the vertical direction is a narrow viewing angle of about the range of ±20 degrees to ±40 degrees, Dv_offset may be set as a wider interval, for example, about 0.7). In this way, by arranging the reception antennas so that not all of the positions of the reception antennas in the vertical direction are at the same position, and some of the reception antennas are offset in the vertical direction, for example, even in exemplary operation 2 of direction estimator 212, direction estimator 212 can measure the angle in the vertical direction in addition to the horizontal direction. Further, for example, the number of reception antennas is not limited to three, but may be two, or four or more.

The MIMO antenna arrangements described in arrangement example A and arrangement example B are examples, and the arrangement is not limited to the examples. For example, with respect to the MIMO antenna arrangements described in arrangement example A and arrangement example B, other antennas (at least one of the transmission antenna or the reception antenna) may be configured to be further arranged. In addition, the antenna arrangement may be such that the horizontal direction and the vertical direction are switched in arrangement example A and arrangement example B. Further, the interval between the transmission antennas described in arrangement example A and arrangement example B may be applied to the interval between the reception antennas, and the interval between the reception antennas described in arrangement example A and arrangement example B may be applied to the interval between the transmission antennas.

Moreover, a MIMO antenna arrangement from the combination of arrangement example A and arrangement example B may be used. For example, a transmission antenna (one antenna) corresponding to one of a plurality of different beam directions may be based on arrangement example A, and transmission antennas (two or more antennas) corresponding to the other of the plurality of different beam directions may be based on arrangement example B.

Direction estimator 212 can perform the direction estimating processing corresponding to the fact that the separation operation of Doppler demultiplexer 211 differs according to the target object direction in the multi-beam transmission by the above-described operation.

For example, when Doppler demultiplexer 211 can separate the Doppler multiplexed signals from all the transmission antennas (for example, when target object direction (2)), direction estimator 212 can improve angle measurement accuracy and angle measurement resolution by performing direction estimation using the reception signals of Nt×Na virtual reception antennas.

Further, for example, when Doppler demultiplexer 211 can separate the Doppler multiplexed signals from the transmission antennas with beam direction Bq (e.g., when target object direction (1) or (3)), direction estimator 212 can improve angle measurement accuracy and angle measurement resolution by performing direction estimation using the reception signals of N_{Bq}×Na virtual reception antennas.

The exemplary operations of direction estimator 212 have been described above.

As described above, in the present embodiment, radar apparatus 10 assigns different Doppler multiplexed signals (for example, patterns of different Doppler shift amounts) between the multi-beams that satisfy at least Condition 1 in Doppler shifter 104 in the multi-beam transmission MIMO radar using uneven interval Doppler multiplexing. Thus, even when the reception level difference between the reflected waves corresponding to the transmission antennas having different directional characteristics is large, radar apparatus 10 can determine the transmission antenna in Doppler demultiplexer 211, enabling Doppler demultiplexing. Therefore, according to the present embodiment, it is possible to suppress the deterioration of the target object detection performance or the deterioration of the erroneous estimation of the Doppler frequency or the measurement angle performance.

Further, for example, in the assignment of Doppler multiplexed signals in Doppler shifters 104, when Conditions 1 and 2 described above are satisfied, even when the reception level difference between the reflected waves corresponding to the transmission antenna having different directional characteristics is large, the detectable Doppler frequency range fd becomes in the range of −1/(2Tr)≤fd<1/(2Tr) in radar apparatus 10, and thus the range can be expanded to a Doppler frequency range the same as when using one transmission antenna.

Further, in radar apparatus 10 according to the present embodiment, Doppler demultiplexing can be performed without using the beam direction determining processing using the reception antenna having directivity (or the directional receiving processing using the reception array antenna) as the multi-beam transmission and reception MIMO radar configuration, so that the reception processing computation quantity can be reduced.

Further, for example, when the reception antennas having the different beam directions are used as the multi-beam transmission and reception MIMO radar configuration, since the number of reception antennas available at the time of angle measurement may be reduced depending on the target object direction, the angle measuring accuracy or the angle measurement resolution of radar apparatus 10 may be reduced. In the present embodiment, for example, since Doppler demultiplexing is possible regardless of the target object direction without using a reception antenna having directivity, a decrease in the angle measurement accuracy and angle measurement resolution can be suppressed.

Therefore, according to the present embodiment, it is possible to improve the detecting performance of a multi-beam transmission MIMO radar using uneven interval Doppler multiplexing transmission.

### (Variation 1)

Variation 1 describes the case of a multi-beam transmission in which the number of transmission antennas corresponding to each of the different beam directions is one (e.g., when N_{B1}=N_{B2}=1 and when Nt=2).

For example, Doppler shifter 104 may apply phase rotations Φₙ (m) to any one of the plurality of transmission antennas for generating a plurality of Doppler multiplexed signals. For example, the number of Doppler shift amounts assigned to any one of the plurality of transmission antennas may be set to be more than one.

In the following, for transmission antenna (N_{Bq}=1) with beam direction Bq, the number of Doppler multiplexed signals generated in Doppler shifters 104 is referred to as “Doppler multiplexed signal number N_{DOP(Bq)}.” Here, q=1 or 2. By way of example, in exemplary configuration 1 of the Doppler shift amounts, the number N_{B2} of transmission antennas with beam direction B2 is 1, and the number N_{DOP(B2)} of Doppler multiplexed signals is 1.

For example, by satisfying item (4) of Condition 1 below, it is possible to obtain the effect according to item (2) of Condition 1.

### <Condition 1>

(4) The number of Doppler multiplexed signals differs for each beam direction (N_{DOP(B1)}≠N_{DOP(B2)}, provided when N_{B1}=N_{B2}=1).

For example, the number N_{DOP(B1)} of Doppler multiplexed signals (or the number of assigned Doppler shift amounts) generated for transmission antennas with beam direction B1 may be different from the number N_{DOP(B2)} of Doppler multiplexed signals (or the number of assigned Doppler shift amounts) generated for transmission antennas with beam direction B2. By the setting of item (4) in Condition 1, even in the case of the number of transmission antennas Nₜ being 2 and Doppler multiplexing number N_{DDM} being 2, and even when the reception level difference between the reflected waves corresponding to the transmission antennas of different beam directions is large, Doppler demultiplexing is possible as in the above-described embodiment.

Hereinafter, exemplary configurations of the Doppler shift amount in Doppler shifter 104 are described.

### <Exemplary Configuration 5 of Doppler Shift Amount>

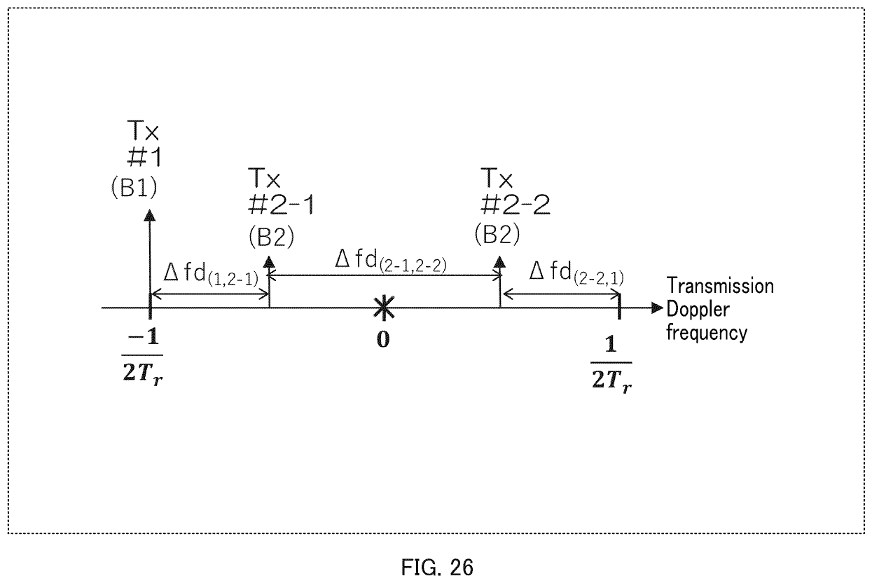

FIG. 26 shows an exemplary configuration of a pattern of Doppler shift amounts for the transmission Doppler frequency in the case of the number of transmission antennas being Nt=2, N_{B1}=1, and N_{B2}=1. In FIG. 26, Tx #1 is a transmission antenna with beam direction B1 (e.g., a transmission antenna forming transmission beam B1) and Tx #2 is a transmission antenna with beam direction B2 (e.g., a transmission antenna forming transmission beam B2).

In exemplary configuration 5 of the Doppler shift amounts as illustrated in FIG. 26, the basic unit of the Doppler shift interval in Doppler shifter 104 is set as Δfd=1/(Tr×(N_{DM}+δ))=1/(4Tr), and δ=1, but the value of δ is not limited thereto, and may be a positive integer or a positive real number.

In the example illustrated in FIG. 26, the number of Doppler multiplexed signals generated by Doppler shifters 104 is N_{DOP(B1)}=1 for transmission antennas Tx #1 of N_{B1}=1 with beam direction B1, and the number of Doppler multiplexed signals generated by Doppler shifters 104 is N_{DOP(B2)}=2 for transmission antennas Tx #2 of N_{B2}=1 with beam direction B2.

In the example illustrated in FIG. 26, the first to second Doppler shifters 104 (or Doppler shifters 104-1 to 104-2) may perform the following operations.

To apply Doppler shift amount DOP₁=−1/(2Tr) to, for example, first transmission antenna Tx #1, first Doppler shifter 104 applies phase rotation Φ₁(m)=2πDOP₁×(m−1) Tr=−π(m−1) for each transmission period Tr of the chirped signal and outputs the chirp signal.

Second Doppler shifter 104, for example, generates two Doppler multiplexed signals for second transmit-antenna Tx #2. In the example of FIG. 26, second Doppler shifter 104 applies Doppler shift amount DOP₂₋₁=−1/(4Tr) and Doppler shift amount DOP₂₋₂=1/(4Tr). To apply two Doppler shift amounts DOP₂₋₁ and DOP₂₋₂ to second transmission antenna Tx #2, second Doppler shifter 104 applies phase rotation Φ₂ (m)=phseq[mod(m,4)+1] for each transmission period Tr of the chirped signal and outputs the chirp signal.

Here, phseq[ps] represents psth element of PhaseSeq=[0, 0, π, π]. For example, phseq[1]=phseq[2]=0 and phseq[3]=phase[4]=×π. In addition, mod(x,y) is a remainder calculation function that represents the remainder when x is divided by y. Incidentally, since two Doppler multiplexed signals are generated for transmission antenna Tx #2, the power is divided by the Doppler shift amount DOP₂₋₁ and Doppler shift amount DOP₂₋₂.

Hereinafter, Doppler shift amount intervals applied to Tx #n1 and Tx #n2 are denoted as the Doppler shift intervals “Δfd_{(n1, n2)}.”

Further, as illustrated in FIG. 26, Tx #2 to which the Doppler shift amount DOP₂₋₁ is applied is denoted as “Tx #2-1,” Tx #2 to which the Doppler shift amount DOP₂₋₂ is applied is denoted as “Tx #2-2.”

In FIG. 26, the Doppler shift amount intervals (Doppler shift intervals) applied to transmission antennas Tx #1 and Tx #2 (e.g., Tx #2-1 and Tx #2-2) is Δfd_{(1, 2-1)}=Δfd, Δfd_{(2-1, 2-2)}=2Δfd, and Δfd_{(2-2, 1)}=Δfd. Therefore, in FIG. 26, the intervals of the Doppler shift amounts applied to transmission antennas (number thereof being Nt=2) are not all the same but include uneven intervals (for example, (Δfd_{(1, 2-1)}=Δfd_{(2-2, 1)}≠Δfd_{(2-1, 2-2)}), resulting in uneven interval Doppler multiplexing transmission (uneven interval DDM transmission).

Further, in FIG. 26, the N_{B1} number of transmission antennas with beam direction B1 among the transmission antennas is 1 and the number N_{DOP(B1)} of Doppler multiplexed signals 1, and therefore, the transmission antenna with beam direction B1 is not in a relationship that allows Doppler multiplexing transmission.

Further, in FIG. 26, the number of transmission antennas with beam direction B2 among the transmission antennas is N_{B2}=1 and the number of Doppler multiplexed signals N_{DOP(B2)}=2. Further, in FIG. 26, the Doppler shift amount interval between transmission antennas Tx #2-1 and Tx #2-2 with beam direction B2 is Δfd_{(2-1, 2-2)}=Δfd_{(2-2, 2-1)}=2Δfd. Therefore, the Doppler shift amount intervals applied to transmission antennas with beam direction B2 are all the same, resulting in even interval Doppler multiplexing transmission (even interval DDM transmission).

Therefore, the example illustrated in FIG. 26 is an exemplary configuration of a pattern of Doppler shift amounts not satisfying Condition 2.

Further, the example illustrated in FIG. 26 shows N_{DOP(B1)}≠N_{DOP(B2)}, and N_{B1}=N_{B2}=1, and thus the example illustrated in FIG. 26 is an exemplary configuration of a pattern of Doppler shift amounts satisfying (4) of Condition 1.

For example, when the target object direction is beam direction B1 and the target object direction is beam direction B2, radar apparatus 10 receives different Doppler multiplexed signals (for example, Doppler multiplexed signals satisfying item (4) of Condition 1) depending on the target object direction in the same manner as in exemplary configuration 1. Therefore, radar apparatus 10 can determine whether a decrease in the reception level of the reception signal corresponding to the transmission antenna with beam direction B1 has occurred or whether a decrease in the reception level of the reception signal corresponding to the transmission antenna with beam direction B2 has occurred, based on the detected peak of the Doppler frequency (for example, the number of peaks), in Doppler demultiplexer 211.

In addition, for example, the transmission antenna with beam direction B1 is one antenna transmission (N_{B1}=1) and the number N_{DOP(B1)} of Doppler multiplexed signals is 1. Therefore, for example, when it is determined from the discrimination result of Doppler demultiplexer 211 that the reception signal is a reception signal corresponding to a transmission antenna with beam direction B1, radar apparatus 10 does not have to perform the separation processing of the Doppler multiplexed signal for the reception signal in beam direction B1. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

Further, for example, the Doppler multiplexed signals transmitted from the transmission antenna with beam direction B2 have Doppler multiplexed signal number N_{DOP(B2)}=2, and are subjected to Doppler multiplexing transmission using Doppler shift intervals that does not satisfy Condition 2. Therefore, for example, when the reception signals have been determined to be corresponding to transmission antennas with beam direction B2 from the discrimination result of Doppler demultiplexer 211, radar apparatus 10 can separate the Doppler multiplexed signals using the known separation operation of Doppler multiplexed signals. In addition, radar apparatus 10 can determine the Doppler frequency fd of the target object within the range of −1/(4Tr)≤fd<1/(4Tr), and obtain an output in which the transmission antennas for the respective Doppler demultiplexer signals are associated.

In addition, for example, when the target object direction is an intermediate direction between beam direction B1 and beam direction B2, and the target object direction is in the direction of an overlapping area (for example, in the case of target object direction (2) illustrated in FIG. 13) where the beam widths of both beams (each of which is about 3 dB or 6 dB of the beam) overlap with each other, the reception level of the reception signal corresponding to Tx #1 with beam direction B1 approximately the same as the reception level of the reception signal corresponding to Tx #2 with beam direction B2. Therefore, the signals transmitted from Nt transmission antennas including the transmission antennas with respective beam direction B1 and beam direction B2 are subjected to Doppler multiplexing transmission using Doppler shift intervals resulting in uneven interval Doppler multiplexing. Therefore, radar apparatus 10 can separate the Doppler multiplexed signals on the basis of the known separation operation of Doppler multiplexed signals. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

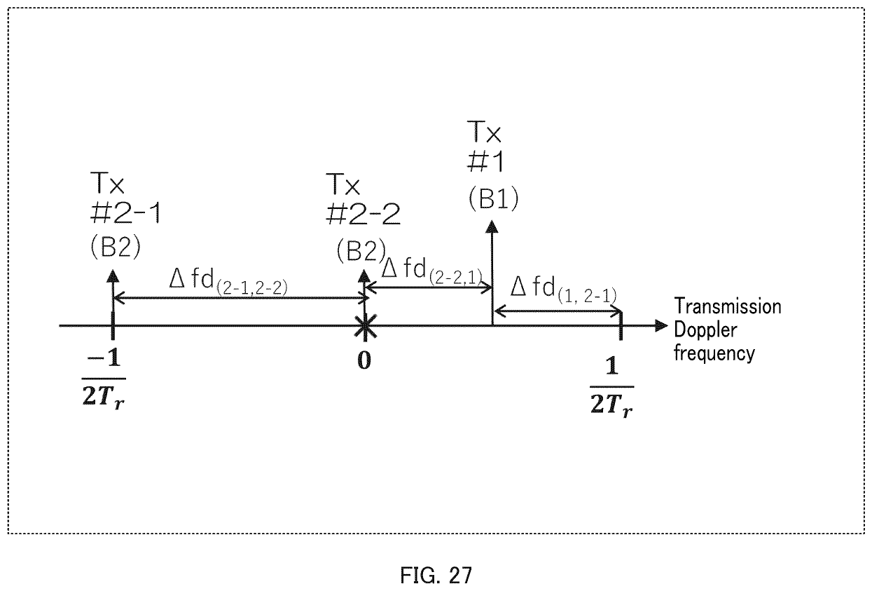

The example of generating two Doppler multiplexed signals for one transmission antenna is not limited to the example illustrated in FIG. 26. For example, it is possible to generate a plurality of Doppler multiplexed signal in the exemplary configuration illustrated in FIG. 27 in the same manner as in FIG. 26.

In the example illustrated in FIG. 27 the first to second Doppler shifters 104 (or Doppler shifters 104-1 to 104-2) may perform the following operations.

To apply Doppler shift amount DOP₁=1/(4Tr), first Doppler shifter 104 applies, for example, phase rotation Φ₁(m)=2πDOP₁×(m−1) Tr=π(m−1)/2 to first transmission antenna Tx #1 for each transmission period Tr of the chirped signal and outputs the chirp signal.

Second Doppler shifter 104, for example, generates two Doppler multiplexed signals for second transmit-antenna Tx #2. In the example of FIG. 27, second Doppler shifter 104 applies Doppler shift amounts DOP₂₋₁=−1/(2Tr) and Doppler shift amount DOP₂₋₂=0. To apply two Doppler shift amounts DOP₂₋₁ and DOP₂₋₂, second Doppler shifter 104 applies phase rotation phase rotation Φ₂ (m)=phseq[mod(m,4)+1] to second transmission antenna Tx #2 for each transmission period Tr of the chirped signal and outputs the chirp signal.

Here, phseq[ps] represents psth element of PhaseSeq=[0, π/2, 0, π/2]. For example, phseq[1]=phseq[3]=0 and phseq[2]=phase[4]=π/2. In addition, mod(x,y) is a remainder calculation function that represents the remainder when x is divided by y. Incidentally, since two Doppler multiplexed signals are generated for transmission antenna Tx #2, the power is divided by the Doppler shift amount DOP₂₋₁ and Doppler shift amount DOP₂₋₂.

Incidentally, the example of generating two Doppler multiplexed signals is not limited to the example described above. For example, it is possible to generate two Doppler multiplexed signals by using PhaseSeq=[0, −π/2, 0, −π/2], [π, −π/2, π, −π/2] or [π, π/2, π, π/2].

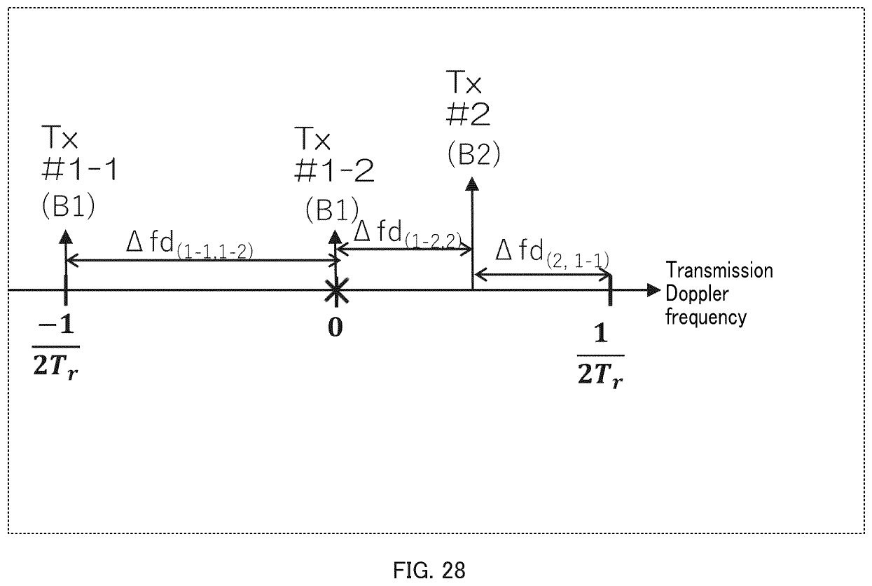

Further, for example, Doppler shifter 104 may assign a fixed amount of Doppler shift to a transmission antenna or may assign a variable amount of Doppler shift to a transmission antenna depending on the transmission period. For example, Doppler shifter 104 may perform assignment of the Doppler shift amount illustrated in FIG. 27 in an odd-numbered transmission period and may perform assignment of the Doppler shift amount illustrated in FIG. 28 in an even-numbered transmission period.

In the exemplary configuration of the Doppler shift amounts illustrated in FIG. 28, the assignment of the Doppler shift amounts for beam direction B1 and the assignment of the Doppler shift amounts for beam direction B2 in the configuration of the Doppler shift amounts illustrated in FIG. 27 are switched.

In such a case, radar apparatus 10 may perform processing (e.g., VFFT1) of Doppler analyzer 209 using the chirp signal of an odd-numbered transmission period and processing (e.g., VFFT2) of Doppler analyzer 209 using the chirp signal of an even-numbered transmission period. Radar apparatus 10 may, for example, detect the phase difference between FFT peaks from to VFFT1 and VFFT2 to determine whether there is aliasing in the Doppler range [±1/(4Tr)].

### (Variation 2)

In the above embodiment has been described for the multi-beam number NB=2, the multi-beam number NB may be 3 or more. In Variation 2, the multi-beam number NB>2 will be described.

In the case of multi-beam number NB>2, Doppler shifter 104 may apply Conditions 1a and 2a, which will be described below, instead of the above-described Conditions 1 and 2, and output the signals by applying a predetermined phase rotation Φₙ(m) that applies different Doppler shift amounts for respective transmitting antennas. Thus, even when the reception power level between the reception signals (reflected waves) corresponding to the transmission antennas of different beam directions is significantly different, radar apparatus 10 can separate the Doppler multiplexed signals, reducing degradation in positioning performance and radar detection capability, in the same manner as in the above-described embodiment.

Hereinafter, Condition 1a and Condition 2a regarding the Doppler shift amount applied by Doppler shifters 104 when multi-beam number NB>2 will be described below.

Radar apparatus 10 may, for example, be a multi-beam transmission MIMO radar using Nt transmission antennas Tx #1 to Tx #Nt including transmission antennas with different beam directions, and may perform uneven interval Doppler multiplexing transmission using Nt transmission antennas Tx #1 to Tx #Nt. For example, Doppler shifter 104 may apply Doppler shifts which has uneven interval for Nt transmission antennas.

In addition, radar apparatus 10 may simultaneously perform multiplexing transmission of the radar transmission signals from Nt transmission antennas Tx #1 to Tx #Nt, for example, using Doppler multiplexing transmission that satisfies the following Condition 1a.

Here, number N_{Bq} of transmission antennas with each beam direction Bq is set to be 1 or more. In addition, the Doppler multiplexing number Nt≥2NB−1 is used, and Doppler multiplexing number N_{DDM}≥2NB−1 is used. In the following description, number N_{q} of transmitted antennas with each beam direction Bq is also described as a N_{B(q)} (e.g., N_{Bq}=N_{B(q)})).

For example, number Nt of transmission antennas is the smallest case when Nt=2NB−1, and among the transmission antennas with each beam direction Bq, the number of transmission antennas in one beam direction is one, and the number of transmission antennas in the other beam direction is two.

In addition, the sum of the numbers of transmission antennas of respective beam directions Bq is Nt. Radar apparatus 10 may, for example, assign one Doppler multiplexed signal to one transmission antenna. In this case, Doppler multiplexing number N_{DDM} is equal to Nt.

<Condition 1a>

N_{B(q)} Doppler multiplexed signals assigned to N_{B(q)} transmission antennas with qth beam direction B(q) satisfies one of the following conditions. Here, q=1 . . . , NB.

(1) Among the Doppler multiplexed signals assigned to transmission antennas in the beam directions with the same Doppler multiplexing number, different Doppler intervals are included (1-i), or when the Doppler multiplexing number is 3 or more, the same Doppler intervals are included, but the orders of the Doppler shift intervals are different (for example, the order of the Doppler shift intervals corresponding to respective beam directions do not coincide with each other even when one of them is cyclically shifted on the Doppler frequency axis) (1-ii).

(2) The Doppler multiplexes between all beam directions are different.

For example, a case where beam direction B(a), B(b) and B(c) among NB multi-beams have the same Doppler multiplexing number (for example, in the case of N_{B(a)}=N_{B(b)}=N_{B(c)}, provided when N_{B(a)}≥2, N_{B(b)}≥2, and N_{B(c)}≥2) will be described. Where a, b, c are each an integral number from 1 to NB and represent the beam directions having the same Doppler multiplexing number.

In this case, when different Doppler intervals are included between Doppler multiplexed signals assigned to beam direction B(a) and Doppler multiplexed signals assigned to beam direction B(b), between Doppler multiplexed signals assigned to beam direction B(b) and Doppler multiplexed signals assigned to beam direction B(c), and between Doppler multiplexed signals assigned to beam direction B(c) and Doppler multiplexed signals assigned to beam direction B(a), item (1-i) of Condition 1a is satisfied. Further, for example, when the Doppler multiplexing number is 3 or more, the Doppler intervals assigned to beam directions B(a), B(b), and B(c) are the same, and the order of the Doppler shift intervals is different (e.g., when the order of the Doppler shift intervals corresponding to respective beam directions do not coincide with each other even when one of B(a), B(b), and B(c) cyclically shifted in the Doppler frequency domain, item (1-ii) of Condition 1a is satisfied.

In addition, for example, when the Doppler multiplexing numbers (N_{B(1)}, N_{B(2)} . . . , N_{B(NB)}) assigned to transmission antennas with NB multi-beams, namely beam directions B(1), B(2) . . . , B(NB), are all different from each other, item (2) of Condition 1a is satisfied.

In addition, radar apparatus 10 may simultaneously perform multiplexing transmission of the radar transmission signals from Nt transmission antennas Tx #1 to Tx #Nt, for example, using Doppler multiplexing transmission that satisfies the following Condition 2a.

<Condition 2a>

For N_{B(q)} transmission antennas in beam direction Bq, Doppler multiplexed signals are assigned to the transmission antenna in beam directions Bq such that uneven interval Doppler multiplexing (in the case of N_{Bq}≥2) is achieved.

By satisfying Condition 2a, the detectable Doppler frequency range fd in radar apparatus 10 is in the range of −1/(2Tr)≤fd<1/(2Tr) and can be expanded beyond the Doppler detection range −1/(2 Nt Tr)≤fd<1/(2 Nt Tr), namely in the case of even interval Doppler multiplexing.

Even when Condition 1a is satisfied but Condition 2a is not satisfied, the detectable Doppler frequency range fd in radar apparatus 10 can be expanded beyond the Doppler detection range of −1/(2 Nt Tr)≤fd<1/(2 Nt Tr), namely in the case of even interval Doppler multiplexing.

Condition 1a and Condition 2a are also conditions of a case where there is no beam with overlapping viewing angles (i.e., field of view: FOV) between beam directions. When there are beams with overlapping viewing angles between beam directions, the following Condition 1b and Condition 2b may be applied, including Doppler multiplexed signals (hereinafter referred to as “Doppler multiplexed signal in overlapping beam direction”) assigned to the transmission antennas with a beam direction where viewing angles overlap (hereinafter referred to as “overlapping beam direction”).

For example, when the viewing angles of beam direction B(1) and beam direction B(2) overlap, Doppler multiplexed signals in the overlapping beam direction mean Doppler multiplexed signals assigned to respective beam direction B(1) and beam direction B(2), and the Doppler multiplexing number becomes N_{B(1)}+N_{B(2)}.

<Condition 1b>

N_{B(q)} Doppler multiplexed signals assigned to N_{B(q)} transmission antennas with qth beam direction B(q) satisfies one of the following conditions. Here, q=1 . . . , NB.

(1) Among the Doppler multiplexed signals assigned to transmission antennas in the beam directions or the overlapping beam directions with the same Doppler multiplexing number, different Doppler intervals are included (1-i), or when the Doppler multiplexing number is 3 or more, the same Doppler intervals are included, but the orders of the Doppler shift intervals are different (for example, the order of the Doppler shift intervals corresponding to respective beam directions or the overlapping beam directions do not coincide with each other even when one of them is cyclically shifted on the Doppler frequency axis) (1-ii).

(2) The Doppler multiplexes between all beam directions or between the overlapping beam directions are different.

<Condition 2b>

Doppler multiplexed signals are assigned such that uneven interval Doppler multiplexing (in the case of N_{Bq}; 2) by transmission antennas in beam direction Bq or in the overlapping beam direction is achieved.

By satisfying Condition 2b, the detectable Doppler frequency range fd in radar apparatus 10 is in the range of −1/(2Tr)≤fd<1/(2Tr). In addition, even when Condition 1b is satisfied but Condition 2b is not satisfied, the detectable Doppler frequency range fd in radar apparatus 10 can be expanded beyond the Doppler detection range of −1/(2 Nt Tr)≤fd<1/(2 Nt Tr), namely in the case of even interval Doppler multiplexing

Hereinafter, as an example, an exemplary operation when NB=3 will be described.

### Exemplary Operation 1

In exemplary operation 1, an exemplary operation in which NB=3 and there is no overlapping beam direction will be described.

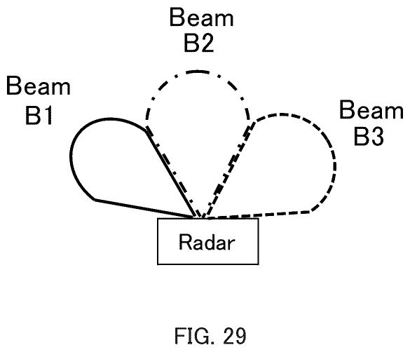

FIG. 29 shows an exemplary beam pattern of beam directions B1, B2, and B3 when the multi-beam number NB is 3 and there is no overlapping beam direction. As illustrated in FIG. 29, when there are no overlapping portions in the beam pattern (or when there are small overlapping portions), Condition 1a and Condition 2a may be applied.

For example, when the target object direction is one of beam direction B1, beam direction B2, and beam direction B3 in FIG. 29, radar apparatus 10 can determine in Doppler demultiplexer 211 whether the decrease is from a decrease in the reception level of reception signals corresponding to transmission antennas with beam direction B1, from a decrease in the reception level of reception signals corresponding to transmission antennas with beam direction B2, or from a decrease in the reception level of reception signals corresponding to transmission antennas with beam direction B3, as the assignment of the Doppler multiplexed signals by Doppler shifters 104 satisfies Condition 1a.

Further, for example, as the assignment of Doppler multiplexed signals by Doppler shifter 104 satisfies Condition 2a, Doppler multiplexed signals transmitted from transmission antennas with beam direction B1 (or B2 or B3) are subjected to Doppler multiplexing transmission using Doppler shift intervals resulting in uneven interval Doppler multiplexing.

Therefore, for example, when reception signals are determined to be the reception signals corresponding to transmission antennas with beam direction B1 (or B2 or B3) from the discrimination result of Doppler demultiplexer 211, radar apparatus 10 can separate the Doppler multiplexed signals using the known separation operation of Doppler multiplexed signals. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

### Exemplary Operation 2

In exemplary operation 2, an exemplary operation in which NB=3 and there is an overlapping beam direction will be described.

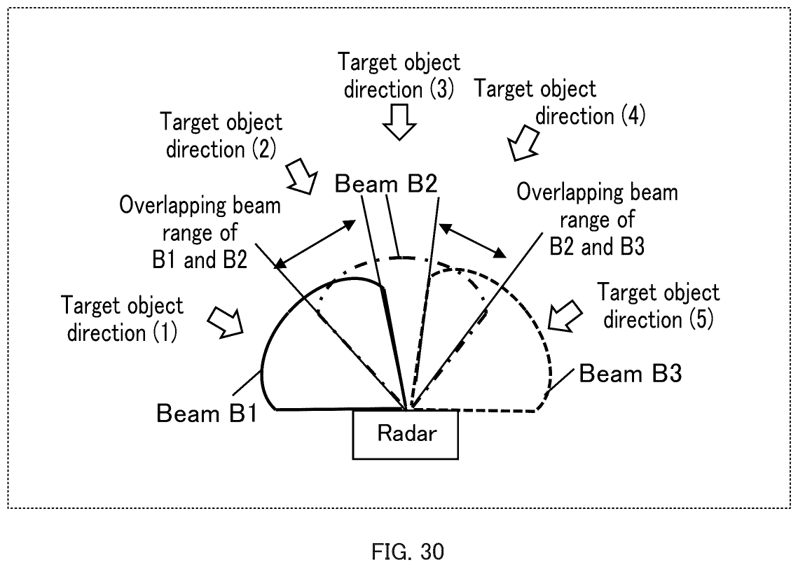

FIG. 30 shows an exemplary beam pattern of beam directions B1, B2, and B3 when the multi-beam number NB is 3 and there is overlapping beam directions. As illustrated in FIG. 30, when there are overlapping portions in the beam pattern (or when there are large overlapping portions), Condition 1b and Condition 2b may be applied.

For example, in FIG. 30, when the target object direction is one of beam direction B1, beam direction B2, and beam direction B3 (any one of target object directions (1), (3), and (5) illustrated in FIG. 30) that is different from the overlapping beam ranges, radar apparatus 10 can determine in Doppler demultiplexer 211 whether reception signals are reception signals corresponding to transmission antennas with beam direction B1, reception signals corresponding to transmission antennas with beam direction B2, or reception signals corresponding to transmission antennas with beam direction B3, as the assignment of the Doppler multiplexed signals by Doppler shifters 104 satisfies Condition 1b.

Further, for example, when the target object direction is within the overlapping beam range in FIG. 30 (in the case of target object direction (2) or (4) illustrated in FIG. 30), radar apparatus 10 can determine in Doppler demultiplexer 211 whether reception signals are reception signals corresponding to transmission antennas with beam directions B1 and B2, or reception signals corresponding to transmission antennas with beam directions B2 and B3, as the assignment of the Doppler multiplexed signals by Doppler shifters 104 satisfies Condition 1b.

Further, for example, as the assignment of Doppler multiplexed signals by Doppler shifter 104 satisfies Condition 2b, Doppler multiplexed signals transmitted from transmission antennas with beam direction B1 (or B2 or B3) are subjected to Doppler multiplexing transmission using Doppler shift intervals resulting in uneven interval Doppler multiplexing. Therefore, for example, when reception signals are determined to be the reception signals corresponding to the transmission antennas with beam direction B1 (or B2 or B3) from the discrimination result of Doppler demultiplexer 211, radar apparatus 10 can separate the Doppler multiplexed signals using the known separation operation of Doppler multiplexed signals. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

Further, for example, as the assignment of Doppler multiplexed signals by Doppler shifter 104 satisfies Condition 2b, Doppler multiplexed signals transmitted from transmission antennas with beam directions B1 and B2 (or, beam directions B2 and B3) are subjected to Doppler multiplexing transmission using Doppler shift intervals resulting in uneven interval Doppler multiplexing. Therefore, for example, when reception signals are determined to be the reception signals corresponding to the transmission antennas with beam directions B1 and B2 (or beam directions B2 and B3) from the discrimination result of Doppler demultiplexer 211, radar apparatus 10 can separate the Doppler multiplexed signals using the known separation operation of Doppler multiplexed signals. Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

### (Variation 3)

In the above embodiment and Variations, as illustrated in FIGS. 13, 20, 24, 29 and 30, the cases where the beam directions of the multi-beams are different from each other has been described, the settings of the multi-beams (e.g., beam direction and beam width) are not limited to the above examples.

For example, beams constituting the multi-beam may differ in at least one of abeam direction or a beam width. In addition, multi-beam number NB≥2 may be used.

Hereinafter, an exemplary configuration of a multi-beam will be described.

### <Exemplary Configuration 1 of Multi-Beam>

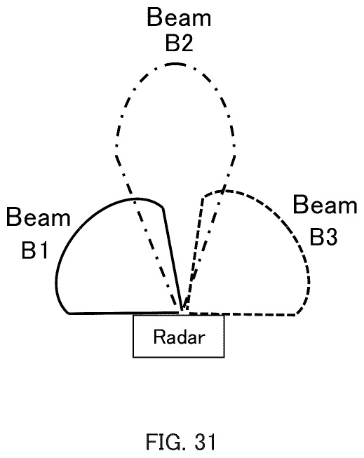

In exemplary configuration 1, for example, in a multi-beam (e.g., beam directions B1, B2 and B3), the beam directions may be different from each other, and the beam widths may be different from each other, as illustrated in FIG. 31. In multi-beams (e.g., beam directions B1, B2 and B3), the beam directions may be different from each other in the horizontal direction (or horizontal plane), and the beam widths may be different from each other in the horizontal direction (or horizontal plane). In addition, the beam directions may be different from each other in the horizontal direction (or horizontal plane) and different from each other in the vertical direction (or vertical plane).

### <Exemplary Configuration 2 of Multi-Beam>

In the above embodiment, as illustrated in FIG. 13, an example in which the beam direction differs in the horizontal direction (or horizontal plane) has been described, but the configuration is not limited thereto.

In exemplary configuration 2, for example, the beam directions may be different from each other in the vertical direction (or vertical plane).

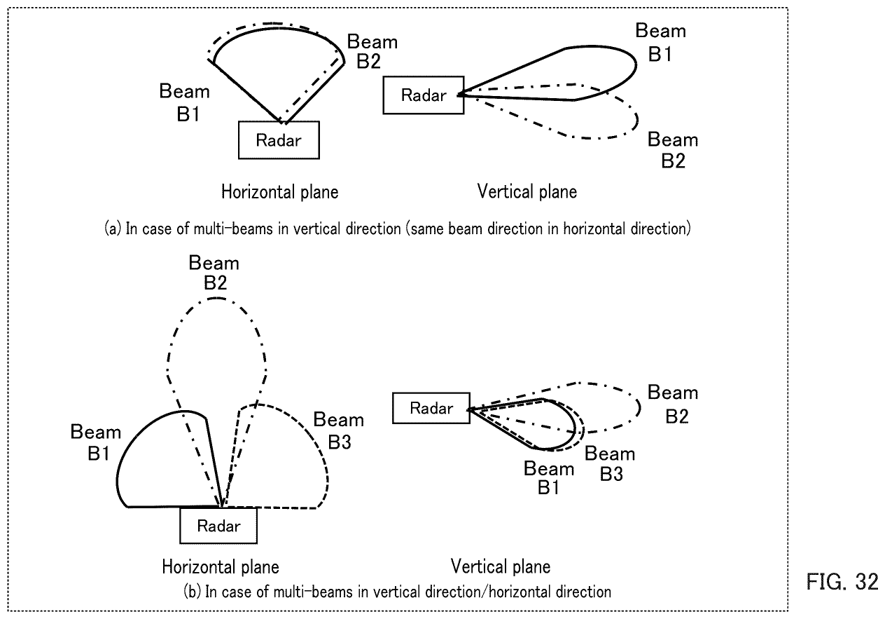

For example, in a multi-beam (e.g., beam directions B1 and B2), the beam directions may be substantially the same in the horizontal direction (or horizontal plane) and different from each other in the vertical direction (or vertical plane), as illustrated at part (a) in FIG. 32.

Further, for example, in a multi-beam (e.g., beam directions B1, B2, and B3), the beam directions may differ from each other both in the horizontal direction (or horizontal plane) and in the vertical direction (or vertical plane), as illustrated at part (b) in FIG. 32.

### <Exemplary Configuration 3 of Multi-Beam>

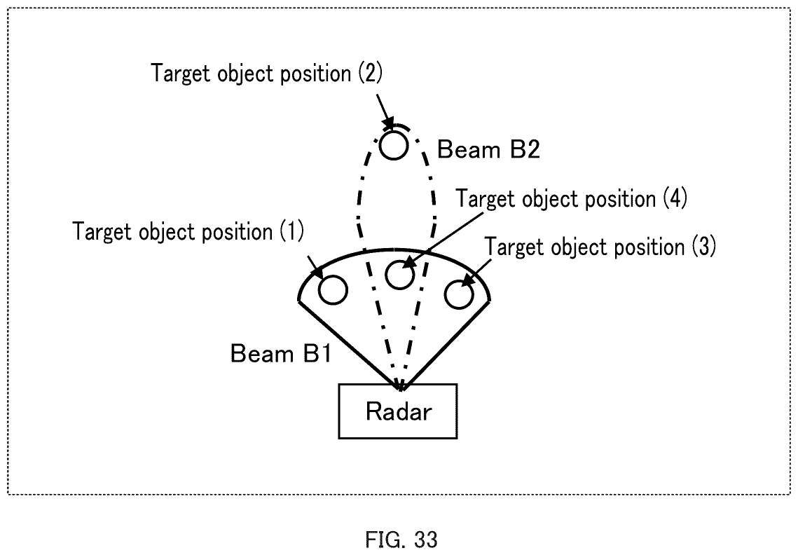

In exemplary configuration 3, for example, in a multi-beam (e.g., beam directions B1 and B2), the beam directions may be the same, and the beam widths may be different from each other, as illustrated in FIG. 33. In multi-beams (e.g., beam directions B1 and B2), the beam directions may be the same in the horizontal (or horizontal plane), and the beam widths may be different from each other in the vertical direction (or vertical plane). In addition, in a multi-beam (e.g., beam directions B1 and B2), the beam directions may be the same in the vertical (or vertical plane), and the beam widths may be different from each other in the vertical direction (or vertical plane).

In the exemplary configuration 3, for example, by replacing the phrase “transmission antennas with different beam directions” described in the above embodiment with the phrase “transmission antennas with different beam widths” (hereinafter, referred to as “beams are different”), the configuration thereof can be applied in the same manner as in the above embodiment.

Hereinafter, as an example, an exemplary operation of radar apparatus 10 in the case where the beam directions are the same and the beam widths are different will be described using exemplary configuration 1 of the Doppler shift amount. The configuration of the Doppler shift amount is not limited to exemplary configuration 1, and radar apparatus 10 can operate in the same manner even when other exemplary configurations of the Doppler shift amounts are used, and the same effects as those of the above embodiment can be obtained.

For example, the case of Nt=3 transmission antennas (e.g., Tx #1, Tx #2, and Tx #3) and N_{B1}=2 and N_{B2}=1, the above-described exemplary configuration 1 of Doppler shift amounts is applied. For example, Tx #1 and Tx #2 are transmission antennas with beam width B1 (e.g., beam B1) illustrated in FIG. 33, Tx #3 is a transmission antenna with the beam width B2 (e.g., beam B2) illustrated in FIG. 33. FIG. 33 shows an example in which the beam width of the beam B1 is wider than the beam width of the beam B2. Here, the beam widths of beam B1 and beam B2 may be horizontal (or horizontal plane), or vertical (or vertical plane), or both horizontal (or horizontal plane) and vertical (or vertical plane), and similar effects can be obtained.

In addition, in radar apparatus 10, the reception antenna may be an omnidirectional antenna (or an antenna having substantially uniform directional characteristics within the viewing angle covered by both the transmission antenna with beam B1 and the transmission antenna with beam B2).

For example, when a target object position is target object position (1) or target object position (3) illustrated in FIG. 33, since the target object position is within the beam width and the viewing angle of beam B1, the reception levels of the reception signals of the reflected waves from the target object corresponding to Tx #1 and Tx #2 with beam B1 become relatively high. On the other hand, since target object position (1) and target object position (3) are outside the beam width and the viewing angle of beam B2, the radiation direction of the radar transmission wave transmitted from Tx #3 with beam B2 does not coincide with the directions of target object positions (1) and (3), and target object position (1) and target object position (3) correspond to the null direction of transmission antenna Tx #3 with beam B2. Therefore, the reception level of the reception signal corresponding to Tx #3 in radar apparatus 10 becomes lower than the reception level of the reception signals corresponding to Tx #1 and Tx #2. For example, the reception level of the reception signal corresponding to Tx #3 may differ significantly from the reception levels of the reception signals corresponding to Tx #1 and Tx #2, and depending on the beam directional characteristics in the null direction of Tx #3, the reception level may become, for example, 10 dB or more lower. In such a case, the reception signals received by radar apparatus 10 become the reception signals illustrated at part (a) in FIG. 12.

Further, for example, when a target object position is in an area where the viewing angles of both beam B1 and beam B2 overlap (for example, the target object position is at a short distance) as in target object position (4) illustrated in FIG. 33, radar apparatus 10 receives reflected waves corresponding to radar transmission waves transmitted from Tx #1 and Tx #2 with beam B1 and a reflected wave corresponding to a radar transmission wave transmitted from Tx #3 with beam B2. In this case, the reception signals received by radar apparatus 10 may become, for example, the reception signals as illustrated at part (b) in FIG. 12. Alternatively, for example, when the directional gain of beam B2 is higher than beam B1 by about 10 dB or more, the reception signals received by radar apparatus 10 may become, for example, the reception signals as illustrated at part (c) in FIG. 12.

Further, for example, when a target object position is within the viewing angle of beam B2 as in target object position (2) and is outside the viewing angle of beam B1, as illustrated in FIG. 33 (for example, the target object position is at a far distance), the reception level of a reflected wave corresponding to a radar transmission wave transmitted from Tx #3 with beam B2 becomes relatively high. On the other hand, since the directional gain of beam B1 is smaller than the directional gain of beam B2, the reception level of reflected waves corresponding to radar transmission waves transmitted from Tx #1 and Tx #2 with beam B1 are lower than the reception level of the reception signal corresponding to Tx #3. For example, the reception level of the reception signals corresponding to Tx #1 and Tx #2 is greatly different from the reception level of the reception signal corresponding to Tx #3, and may become, for example, 10 dB or more lower depending on the beam directional characteristics of Tx #1 and Tx #2. In such a case, the reception signals received by radar apparatus 10 become the reception signals illustrated at part (c) in FIG. 12.

For example, as illustrated at part (b) in FIG. 12, when radar apparatus 10 receives reception signals corresponding to the transmission antennas of the respective beams at approximately the same reception level, the signals transmitted from Nt transmission antennas including the transmission antennas with respective beam B1 and beam B2 are subjected to Doppler multiplexing transmission using Doppler shift intervals resulting in uneven interval Doppler multiplexing. Therefore, radar apparatus 10 can separate the Doppler multiplexed signals on the basis of the known separation operation of Doppler multiplexed signals.

Further, as illustrated at part (a) in FIG. 12 and part (c) in FIG. 12, when radar apparatus 10 receives a reflected wave from either beam B1 or beam B2 (when the reception level difference is large), radar apparatus 10 receives different Doppler multiplexed signals (for example, Doppler multiplexed signals satisfying Condition 1) depending on the target object position. Therefore, radar apparatus 10 can determine whether a decrease in the reception level of the reception signal corresponding to the transmission antenna with beam B1 has occurred or whether a decrease in the reception level of the reception signal corresponding to the transmission antenna with beam B2 has occurred, in Doppler demultiplexer 211.

For example, Doppler multiplexed signals transmitted from the transmission antenna with beam B1 are subjected to Doppler multiplexing transmission using Doppler shift intervals resulting in uneven interval Doppler multiplexing. Therefore, for example, when the reception signals are determined to be corresponding to transmission antennas with beam B1 from the discrimination result of Doppler demultiplexer 211, radar apparatus 10 can separate the Doppler multiplexed signals using the known separation operation of Doppler multiplexed signals.

Further, for example, the transmission antenna with beam B2 is one antenna transmission. Therefore, for example, when it is determined from the discrimination result of Doppler demultiplexer 211 that the reception signal is the reception signal corresponding to the transmission antenna with beam B2, radar apparatus 10 does not have to perform the separation processing of the Doppler multiplexed signal for the reception signal in beam B2.

Through such operation of Doppler demultiplexer 211, radar apparatus 10 can determine Doppler frequency fd of the target object within the range of −1/(2Tr)≤fd<1/(2Tr), and obtain an output in which each Doppler multiplexed signal is associated with its corresponding transmission antenna.

The embodiments of the present disclosure have been described above.

### Other Embodiments

In a radar apparatus according to an exemplary embodiment of the present disclosure, the radar transmitter and the radar receiver may be individually arranged in physically separate locations from each other. In addition, in the radar receiver according an exemplary embodiment of the present disclosure, the direction estimator and any other component may be individually arranged in physically separate locations from one another.

Further, the numerical values of parameters used in an exemplary embodiment of the present disclosure, such as number Nt of transmission antennas, number Na of reception antennas, Doppler multiplexing number N_{DM}, number NB of beams in a multi-beam, number N_{Bq} of transmission antennas in a beam direction, the Doppler shift amount, and the Doppler shift interval, are examples, and are not limited to those values. In addition, some of the transmission antennas provided in a radar apparatus may be used as Nt transmission antennas.

Further, a MIMO antenna arrangement example used in an exemplary embodiment of the present disclosure (e.g., arrangement example A and arrangement example B) has been described as transmitting radar transmission signals from a plurality of transmission antennas using Doppler multiplexing transmission, but the configuration is not limited thereto. For example, the arrangement can also be applied when transmitting radar transmission signals from a plurality of transmission antennas using time-division multiplexing transmission or code multiplexing transmission, and the effects from the disclosed MIMO antenna arrangement can also be obtained in such a case.

A radar apparatus according to an exemplary embodiment of the present disclosure includes, for example, a central processing unit (CPU), a storage medium such as a read only memory (ROM) that stores a control program, and a work memory such as a random access memory (RAM), which are not illustrated. In this case, the functions of the sections described above are implemented by the CPU executing the control program. However, the hardware configuration of the radar apparatus is not limited to that in this example. For example, the functional sections of the radar apparatus may be implemented as an integrated circuit (IC). Each functional section may be formed as an individual chip, or some or all of them may be formed into a single chip.

Various embodiments have been described with reference to the drawings hereinabove. Obviously, the present disclosure is not limited to these examples. Obviously, a person skilled in the art would arrive at variations and modification examples within a scope described in claims, and it is understood that these variations and modifications are within the technical scope of the present disclosure. Each constituent element of the above-mentioned embodiments may be combined optionally without departing from the spirit of the disclosure.

The expression “section” used in the above-described embodiments may be replaced with another expression such as “circuit (circuitry),” “assembly,” “device,” “unit,” or “module.”

The above embodiments have been described with an example of a configuration using hardware, but the present disclosure can be realized by software in cooperation with hardware.

Each functional block used in the description of each embodiment described above is typically realized by an LSI, which is an integrated circuit. The integrated circuit controls each functional block used in the description of the above embodiments and may include an input terminal and an output terminal. The LSI may be individually formed as chips, or one chip may be formed so as to include a part or all of the functional blocks. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a Field Programmable Gate Array (FPGA) that can be programmed after the manufacture of the LSI or a reconfigurable processor in which the connections and the settings of circuit cells disposed inside the LSI can be reconfigured may be used.

When future integrated circuit technology replaces LSIs as a result of the advancement of semiconductor technology or other derivative technology, the functional blocks could be integrated using the future integrated circuit technology. Biotechnology can also be applied.

### Summary of Present Disclosure

A radar apparatus according to one exemplary embodiment of the present disclosure includes: a plurality of transmission antennas including a first transmission antenna forming a first beam and a second transmission antenna forming a second beam different from the first beam; and transmission circuitry, which, in operation, performs multiplexing transmission of a transmission signal from the plurality of transmission antennas, the transmission signal being a signal to which a phase rotation corresponding to a Doppler shift amount assigned to each of the plurality of transmission antennas has been applied. In the radar apparatus, a Doppler shift interval by the plurality of transmission antennas is uneven on a Doppler frequency axis, and a first pattern of the Doppler shift amount assigned to the first transmission antenna is different from a second pattern of the Doppler shift amount assigned to the second transmission antenna.

In one exemplary embodiment of the present disclosure, the first pattern and the second pattern relate to the Doppler shift interval; a Doppler multiplexing number by the first transmission antenna and a Doppler multiplexing number by the second transmission antenna are identical to each other; and at least one of a plurality of the Doppler shift intervals by the first transmission antenna is different from the Doppler shift interval by the second transmission antenna.

In one exemplary embodiment of the present disclosure, the first pattern and the second pattern relate to the number of transmission antennas; and the number of the first transmission antennas is different from the number of the second transmission antennas.

In one exemplary embodiment of the present disclosure, the first pattern and the second pattern relate to a Doppler multiplexing number; and the Doppler multiplexing number by the first transmission antenna is different from the Doppler multiplexing number by the second transmission antenna.

In one exemplary embodiment of the present disclosure, the first pattern and the second pattern relate to an order of intervals of a plurality of the Doppler shift amounts; a Doppler multiplexing number by the first transmission antenna and a Doppler multiplexing number by the second transmission antenna are identical to each other; a plurality of first Doppler shift intervals by the first transmission antenna, and a plurality of second Doppler shift intervals by the second transmission antenna are identical to each other; and an order of the plurality of first Doppler shift intervals on the Doppler frequency axis is different from an order of the plurality of second Doppler shift intervals on the Doppler frequency axis.

In one exemplary embodiment of the present disclosure, the Doppler shift interval by the first transmission antenna is uneven on the Doppler frequency axis.

In one exemplary embodiment of the present disclosure, the Doppler shift interval by the second transmission antenna is uneven on the Doppler frequency axis.

In one exemplary embodiment of the present disclosure, the radar apparatus further includes: a plurality of reception antennas that receive a reflected wave signal resulted from the transmission signal being reflected by a target; and reception circuitry, which, in operation, performs direction estimation of the target using the reflected wave signal.

In one exemplary embodiment of the present disclosure, the radar apparatus further includes: a plurality of reception antennas arranged at a first interval in a first direction, in which the first transmission antenna and the second transmission antenna are arranged at the first interval in the first direction, and are arranged at different positions in a second direction orthogonal to the first direction.

In one exemplary embodiment of the present disclosure, the radar apparatus further includes: a plurality of reception antennas arranged at a first interval in a first direction, in which the first transmission antenna and the second transmission antenna are arranged at a second interval in the first direction, and a difference between the first interval and the second interval is a specified value based on a wavelength of the transmission signal.

In one exemplary embodiment of the present disclosure, the specified value is a value in a range of from 0.45 times to 0.8 times the wavelength.

In one exemplary embodiment of the present disclosure, the first transmission antenna and the second transmission antenna are arranged at identical positions in a second direction orthogonal to the first direction.

In one exemplary embodiment of the present disclosure, the first transmission antenna and the second transmission antenna are arranged at different positions in a second direction orthogonal to the first direction.

In one exemplary embodiment of the present disclosure, among the plurality of reception antennas, a first reception antenna and a second reception antenna are arranged at different positions in the second direction.

In one exemplary embodiment of the present disclosure, the number of the first transmission antennas is one, and the number of the second transmission antennas is one; and the number of Doppler shift amounts assigned to the first transmission antenna is different from the number of Doppler shift amounts assigned to the second transmission antenna.

In one exemplary embodiment of the present disclosure, the number of the Doppler shift amounts assigned to the first transmission antenna and the number of the Doppler shift amounts assigned to the second transmission antenna are switched for each transmission period of the transmission signal.

In one exemplary embodiment of the present disclosure, the first beam and the second beam are different in at least one of a beam direction or a beam width.

The disclosure of Japanese Patent Application No. 2022-138273, filed on Aug. 31, 2022, including the specification, drawings and abstract, is incorporated herein by reference in its entirety.

### INDUSTRIAL APPLICABILITY

The present disclosure is suitable as a radar apparatus for wide-angle range sensing.

### REFERENCE SIGNS LIST

10 Radar apparatus
100 Radar transmitter
101 Radar transmission signal generator
102 Modulation signal generator
103 VCO
104 Doppler shifter
105 Transmission antenna section
200 Radar receiver
201 Antenna system processor
202 Reception antenna section
203 Reception radio
204 Mixer
205 LPF
206 Signal processor
207 AD converter
208 Beat frequency analyzer
209 Doppler analyzer
210 CFAR section
211 Doppler demultiplexer
212 Direction estimator

1. A radar apparatus comprising:
a plurality of transmission antennas including a first transmission antenna forming a first beam and a second transmission antenna forming a second beam different from the first beam; and
transmission circuitry, which, in operation, performs multiplexing transmission of a transmission signal from the plurality of transmission antennas, the transmission signal being a signal to which a phase rotation corresponding to a Doppler shift amount assigned to each of the plurality of transmission antennas has been applied,
wherein
a Doppler shift interval by the plurality of transmission antennas is uneven on a Doppler frequency axis, and
a first pattern of the Doppler shift amount assigned to the first transmission antenna is different from a second pattern of the Doppler shift amount assigned to the second transmission antenna.

2. The radar apparatus according to claim 1, wherein:
the first pattern and the second pattern relate to the Doppler shift interval;
a Doppler multiplexing number by the first transmission antenna and a Doppler multiplexing number by the second transmission antenna are identical to each other; and
at least one of a plurality of the Doppler shift intervals by the first transmission antenna is different from the Doppler shift interval by the second transmission antenna.

3. The radar apparatus according to claim 1, wherein:
the first pattern and the second pattern relate to the number of transmission antennas; and
the number of the first transmission antennas is different from the number of the second transmission antennas.

4. The radar apparatus according to claim 1, wherein:
the first pattern and the second pattern relate to a Doppler multiplexing number; and
the Doppler multiplexing number by the first transmission antenna is different from the Doppler multiplexing number by the second transmission antenna.

5. The radar apparatus according to claim 1, wherein:
the first pattern and the second pattern relate to an order of intervals of a plurality of the Doppler shift amounts;
a Doppler multiplexing number by the first transmission antenna and a Doppler multiplexing number by the second transmission antenna are identical to each other;
a plurality of first Doppler shift intervals by the first transmission antenna, and a plurality of second Doppler shift intervals by the second transmission antenna are identical to each other; and
an order of the plurality of first Doppler shift intervals on the Doppler frequency axis is different from an order of the plurality of second Doppler shift intervals on the Doppler frequency axis.

6. The radar apparatus according to claim 1, wherein
the Doppler shift interval by the first transmission antenna is uneven on the Doppler frequency axis.

7. The radar apparatus according to claim 1, wherein
the Doppler shift interval by the second transmission antenna is uneven on the Doppler frequency axis.

8. The radar apparatus according to claim 1, further comprising:
a plurality of reception antennas that receives a reflected wave signal resulted from the transmission signal being reflected by a target; and
reception circuitry, which, in operation, performs direction estimation of the target using the reflected wave signal.

9. The radar apparatus according to claim 1, further comprising:
a plurality of reception antennas arranged at a first interval in a first direction, wherein
the first transmission antenna and the second transmission antenna are arranged at the first interval in the first direction, and are arranged at different positions in a second direction orthogonal to the first direction.

10. The radar apparatus according to claim 1, further comprising:
a plurality of reception antennas arranged at a first interval in a first direction, wherein
the first transmission antenna and the second transmission antenna are arranged at a second interval in the first direction, and
a difference between the first interval and the second interval is a specified value based on a wavelength of the transmission signal.

11. The radar apparatus according to claim 10, wherein
the specified value is a value in a range of from 0.45 times to 0.8 times the wavelength.

12. The radar apparatus according to claim 10, wherein
the first transmission antenna and the second transmission antenna are arranged at identical positions in a second direction orthogonal to the first direction.

13. The radar apparatus according to claim 10, wherein
the first transmission antenna and the second transmission antenna are arranged at different positions in a second direction orthogonal to the first direction.

14. The radar apparatus according to claim 9 or 10, wherein
among the plurality of reception antennas, a first reception antenna and a second reception antenna are arranged at different positions in a second direction orthogonal to the first direction.

15. The radar apparatus according to claim 1, wherein:
the number of the first transmission antennas is one, and the number of the second transmission antennas is one; and
the number of Doppler shift amounts assigned to the first transmission antenna is different from the number of Doppler shift amounts assigned to the second transmission antenna.

16. The radar apparatus according to claim 13, wherein
the number of the Doppler shift amounts assigned to the first transmission antenna and the number of the Doppler shift amounts assigned to the second transmission antenna are switched for each transmission period of the transmission signal.

17. The radar apparatus according to claim 1, wherein
the first beam and the second beam are different in at least one of a beam direction or a beam width.

18. A radar signal generating apparatus, comprising:
signal generation circuitry, which, in operation, generates a transmission signal; and
transmission circuitry, which, in operation,
applies, to the transmission signal, a phase rotation corresponding to a Doppler shift amount assigned to each of a plurality of transmission antennas that include a first transmission antenna forming a first beam and a second transmission antenna forming a second beam different from the first beam, and
performs, from the plurality of transmission antennas, multiplexing transmission of the transmission signal to which the phase rotation is applied,
wherein
a Doppler shift interval by the plurality of transmission antennas is uneven on a Doppler frequency axis, and
a first pattern of the Doppler shift amount assigned to the first transmission antenna is different from a second pattern of the Doppler shift amount assigned to the second transmission antenna.

19. A radar signal generating method, comprising:
generating a transmission signal;
applying, to the transmission signal, a phase rotation corresponding to a Doppler shift amount assigned to each of a plurality of transmission antennas that include a first transmission antenna forming a first beam and a second transmission antenna forming a second beam different from the first beam; and
performing, from the plurality of transmission antennas, multiplexing transmission of the transmission signal to which the phase rotation is applied,
wherein
a Doppler shift interval by the plurality of transmission antennas is uneven on a Doppler frequency axis, and
a first pattern of the Doppler shift amount assigned to the first transmission antenna is different from a second pattern of the Doppler shift amount assigned to the second transmission antenna.
